(19) United States
(12) Patent Application Publication
(10) Pub. No.: US 2008/0082959 A1
(43) Pub. Date: Apr. 3, 2008

(54) Data processing system and method

(75) Inventor: Matthew Fowler, London (GB)

Correspondence Address: WOLF GREENFIELD & SACKS, P.C., 600 ATLANTIC AVENUE, BOSTON, MA, 02210-2206, US

(73) Assignee: New Technology/enterprise Limited, London (GB)

(21) Appl. No.: 11/788,824

(22) Filed: Apr. 20, 2007

Related U.S. Application Data
(63) Continuation-in-part of application No. PCT/GB04/04478, filed on Oct. 22, 2004.

(30) Foreign Application Priority Data
Oct. 22, 2004 (GB) 004478

(51) Int. Cl. G06F 9/44

(52) U.S. Cl. 717/104

(57) ABSTRACT

Aspects of a model development and code generation system and method are described. One aspect of the system generates program code for implementing a software system specified by specification data, which may represent a model of a system designed by a user. The system includes an input component adapted to receive the specification data, a processing component adapted to generate further specification data in dependence on the received specification data and a code generator adapted to generate the program code from the specification data and the further specification data. The code generator may use templates and controls to generate program code and the further specification data may be generated based on a meta-model developed by the user. Processing the specification data to produce further specification data and generating code based on the original specification data and the further specification data may facilitate the development of systems, particularly complex systems, implemented in computer code and reduce the manual coding required to generate the system.

The present invention relates to the field of data processing and, in particular, to the field of code generation driven by a model or specification.

Since the first days of software development, attempts have been made to automate the process of writing and developing code to implement software designed at a higher level.

Tools have been created to automate the generation of computer code for software applications from models, but these tools are often capable of generating only a small percentage of the code necessary to implement the application and a software developer is then required to review the code generated and add additional code to implement the full application.

For more complex systems, a large number of development steps may be required to be implemented by a number of different specialists between the initial system modelling step and the final coding step. This provides scope for differences in interpretation of the original model and the intermediary steps to lead to errors in the code developed.

In addition, whether the code is written entirely manually or whether small sections of code are generated automatically, it is difficult to convert a coded application or system from one programming language to another and to technically upgrade the system or change to a different implementation. In such situations, it is often necessary to recode the whole system from the original system design.

The present invention aims to alleviate some of the problems outlined above.

Accordingly, in a first aspect of the invention, there is provided a code generation system for generating program code for implementing a software system specified by specification data, comprising: an input component adapted to receive the specification data; a processing component adapted to generate further specification data in dependence on the received specification data; and a code generator adapted to generate the program code from the specification data and the further specification data.

This can enable the specification data and the specification it represents to be enhanced before code generation is performed, for example by way of adding default features to the specification data. The complexity of the initial specification data, and the work involved in creating it, may also thereby be reduced.

The code generated may comprise code for implementing all or part of a software system or program. The code may comprise executable code or may comprise a wide range of other types of code, for example HTML code to implement a web application or XMI code to enable the specification data to be represented in a predetermined format, for example in a graphical format.

The input component is preferably adapted to generate a system model of the software system from the specification data, the code generator being adapted to generate the program code from the system model. This can provide improved efficiency and flexibility. The processing component is preferably adapted to output the further specification data, and the input component is preferably adapted to receive the further specification data output by the processing component, and to modify the system model in dependence on the further specification data. Preferably, the further specification data is generated in dependence on the system model. This can provide an iterative or recursive process whereby a basic system model is first created from the specification data, and further specification data is then generated from the system model to be fed back into the system and thereby produce an enhanced system model. Processing of the enhanced system model can in turn lead to the generation of more specification data to further augment the specification and the system model.

Code generation driven by models or specifications may also be known as a Model-Driven Architecture (MDA) or Model-Driven Development (MDD) approach, or a domain-specific language approach, generative programming or architecture driven development approach. A further advantage of embodiments of aspects of the system described herein may be that the system provides the ability to build software factories and provides examples.

Preferably, the system is adapted to store a plurality of patterns each defining specification data representing elements that may be added to the system model, and the processing component is preferably adapted to generate the further specification data by processing at least one of the stored patterns.

Hence a pattern may produce output that is interpreted as further specification data. In this way, enhancements to the system model can be defined externally to the system, which can make them easier create, change and maintain. The code generated from a given specification (as defined by the specification data) can thereby be changed by changing some or all of the stored patterns or by substituting them for other patterns. Multiple sets of patterns may be provided for different purposes (for example, for different target programming languages or platforms), and by selecting a given set of patterns, the code generation system may produce different code adapted to the selected purpose. The same specification can thus produce different output code depending on the patterns used. A more flexible, (target) platform-independent and/or efficient code generation system can thereby be provided, and the task of providing the specification data can be simplified. The patterns are preferably implemented as Velocity templates or scripts.

Preferably, the system is adapted to process a pattern including pre-defined specification data and one or more placeholders for variable specification data, in which case the system is preferably further adapted to substitute the or each placeholder with data derived from either or both of: the system model and predefined configuration data. This can enable the further specification data produced by applying a pattern to be varied in dependence on the context in which the pattern is being applied. More powerful, expressive, and/or flexible patterns can thereby be provided, which can in turn enhance the flexibility and efficiency of the entire system and simplify the specification task.

The system is preferably adapted to process a first pattern that includes information specifying a second pattern by processing the first pattern to generate first specification data, and then processing the second pattern to generate second specification data. In this way, complex patterns can be broken down into stages, making patterns easier to define and maintain. This more modular approach to patterns can also enable re-use of patterns. Preferably, the processing component is adapted to include in the first specification data information specifying the second pattern, the input component being adapted to receive the first specification data and modify the system model in dependence on the first specification data and to include in the system model information specifying the second pattern, the processing component being further adapted to subsequently process the second pattern specified in the system model to generate the second specification data. In this way, an efficient mechanism can be provided for linking from one pattern to the next.

Specification data produced by patterns may include definitions of elements to be added to the system model and/or processing instructions. Hence the specification data or output produced by some patterns may not include elements to be added into the system model directly, but may comprise only processing instructions, for example a processing instruction which calls another pattern. This may have a format such as $this.setNextPattern( ) and may effectively enable one pattern to call another pattern without producing any additional elements.

The input component is preferably adapted to generate the system model in the form of an object hierarchy, with objects in the object hierarchy representing elements of the system model specified in the specification data, the processing component preferably being adapted to process the objects in the object hierarchy and, for a given object, select a stored pattern associated with the object and process the pattern to generate further specification data relating to the object. Instead of an object hierarchy, the system model may simply be represented as a collection or as some other structure of objects.

Elements specified in the specification data may, for example, be system modelling concepts or programming constructs or abstractions of either. Examples of system modelling concepts that may be represented by elements in the specification data include entities, relationships between entities, methods and attributes of entities and the like, screens or parts of screens in a user interface, and may be based on a modelling language such as UML (Unified Modelling Language), XML Schema or any other machine-readable representation. Examples of programming constructs that may be represented by elements include classes, data fields, methods and the like, and may be based on programming languages such as Java, C++ or C#. The objects in the system model preferably model the elements specified in the specification data, and hence model the concepts or constructs so specified.

The elements may be specified in the specification data in a hierarchical structure. For example, the specification data may specify an entity that contains several attributes and methods. The system model preferably reflects the structure of the specification data—in this example, the system model might comprise an object representing the entity, which contains or is associated with further objects representing the attributes and methods. Preferably, for each type of element appearing in the specification data, an object class is provided, and an instance of the corresponding object class is used to model an element of a given type. A system model can thereby be provided which can be processed efficiently.

By selecting patterns associated with an object to generate further specification data relating to that object, the enhancement of the specification data can be controlled at a finer level of detail, which can afford greater flexibility in how patterns affect the development of the system model.

Preferably, the processing component is adapted to select the pattern in dependence on the type or class of the given object. In this way, patterns may be provided which apply to particular element or object types or classes and which define specification enhancements of general applicability to those types or classes. In this way, the task of specifying the software system (that is, producing the specification data) can be simplified, since information which is generally true of elements of a particular type need not be explicitly specified for elements of that type but can be added automatically by way of patterns.

Preferably, the given object is an instance of a class in a class hierarchy, and the processing component is preferably adapted to select one of: a pattern associated with the object class, and a pattern associated with a superclass of the object class. This can provide increased flexibility.

In one embodiment, the system may be further adapted to receive, for a given object class, configuration information defining a further object class having associated patterns for use in connection with the given object class, and selecting a pattern associated with the further object class. Hence the patterns used for a particular object class may be associated with a different object class and may be referenced, for example in a configuration or properties file, such as a template.properties file, as discussed in more detail below.

The processing component is preferably adapted to select a pattern associated with the object class in preference to a pattern associated with a superclass of the object class, and to select a pattern associated with a lower-level superclass of the object class in preference to a pattern associated with a higher-level superclass of the object class. In this way, an override mechanism for patterns may be provided, whereby, for a given object class, a pattern may be specified which will be applied to objects of all subclasses of that class, unless a subclass is itself associated with a pattern, which is then used instead. Alternatively, an inheritance mechanism may be provided whereby the system applies patterns associated with superclasses of a given object class in addition to any associated with the given object class itself. In this case, an override option could nevertheless additionally be specified where required. In either case, a more efficient system can thus be provided.

As used above in relation to object classes, the terms high-level and low-level are to be understood in the sense that higher-level classes are superclasses and lower-level classes are subclasses. However, in relation to the meta-model structure described herein, the terms high and low refer to levels of abstraction. The lowest level meta-model layer, the base model, defines the highest-level classes in the class hierarchy defined by the meta-model from which other classes are derived. Generally speaking, the terms ‘high-level’ and ‘low-level’ should be interpreted as appropriate in the context.

Alternatively or in addition, the given object may comprise an attribute specifying a pattern, and the processing component is preferably adapted to select the pattern in dependence on the attribute. In this way, instead of or in addition to any patterns applied as a result of the class of an object, a specifically selected pattern may be applied. The input component is preferably adapted to receive specification data specifying an element of the system model and a pattern associated with the element, and the processing component is preferably adapted to generate the given object including the attribute in dependence on said specification data. This can provide a simple mechanism by which patterns which are to be applied to an element/object of the system model can be directly specified in the specification data. This can enhance the flexibility of the system.

The system is preferably adapted to process a pattern specifying one or more elements that are to be added to the system model and to add objects representing those elements to the object hierarchy. As described above, this is preferably achieved by outputting the further specification data specifying the elements to be added, and processing the further specification data to add the objects representing those elements to the object hierarchy. The system model can thereby be enhanced. The pattern may, for example, specify elements which are necessary or useful in the implementation of an object to which the pattern is being applied. As an example, if the specification specifies an entity having an attribute, a pattern may be provided which adds to that entity methods for reading and setting the value of that attribute. In practice, as described above, the processing component would preferably process the object in the system model representing the entity, identify the pattern associated with the entity, and generate further specification data specifying the additional methods. Then, when the further specification data is read in, objects would then be added to the system model representing the additional methods. As a result, the system model would then contain the object representing the entity, which would contain further objects representing the attribute (specified in the original specification data) and the new methods (specified in the pattern). The pattern application procedure may, in fact, be recursive—if these new objects themselves have associated patterns these would then also be applied.

Advantageously, the system may be adapted to process a pattern including location information specifying the location in the object hierarchy at which a new object is to be added, and to add the new object at the specified location. This can enable more expressive and powerful patterns to be provided. The location information preferably specifies an object in the object hierarchy, and the system is preferably adapted to add the new object as a child object of the specified object. In this way, a pattern can specify an arbitrary location within the system model at which new elements specified in the pattern are to be added. For example, where the system model comprises two entities which communicate with each other, the addition of the first entity may automatically trigger, by way of a pattern, the addition of methods to the second entity to enable such communication without those methods needing to be explicitly specified for the second entity.

Alternatively, the location information may specify the object in the object hierarchy relatively to the location of an object being processed, preferably by specifying either the object being processed or the parent object of the object being processed. In this way, a pattern may in a simple manner cause the addition of child or sibling objects to the object of the system model to which the pattern is being applied (that is, which is currently being processed). For example, the addition of an entity to the system model may automatically trigger (by way of a pattern) the addition of a method required for that entity (such as a constructor), and the addition of a specific attribute to an entity may trigger (by way of a pattern) the addition of a further attribute to the same entity. In the first case, the method is added as a child object of the object being processed (the entity); in the second case, the further attribute is being added as a sibling object of the object being processed (the attribute).

Preferably, the system is adapted to store a plurality of patterns associated with a given object type or class, the processing component being adapted to process an object of the given object type or class by processing each of the plurality of patterns associated with the given object type or class in a pre-determined order. This can provide increased flexibility, and allow for increased modularity of patterns. The system may be adapted to perform a validation step on objects of the system model, in which case the processing component is preferably adapted to process a first pattern associated with a given object before validation of the object and to process a second pattern associated with the object after validation of the object. In this way, patterns can be provided for the purpose of ensuring that the initial system model or its objects are put into a state in which validation can be successfully carried out. The main patterns can then be applied after validation (assuming validation is successful). This can enable more effective validation whilst maintaining the advantage of the use of patterns in reducing the complexity of the specification data and the specification task.

The system may be adapted to process a pattern comprising program code, the input component preferably being adapted to add the program code to the system model, and the generating component preferably being adapted to include the program code in the generated program code. This can allow specific functionality which is not produced by the code generator to be added directly to the specification data for inclusion in the generated code, and can reduce the need for manual modification of the generated code.

Preferably, stored patterns comprise parameterisable specification data and generate, for given elements in a system model, additional elements useful in the implementation of the system model. For example, for an entity incorporating a number of attributes, patterns may provide for the generation of corresponding data view or data modification screens in which those attributes can be viewed or changed by a user of the software system, and may add elements necessary for interfacing a database in which the attribute data is stored. Such data view or modification screens or other elements would themselves be represented as objects in the system model, from which the system code is ultimately generated.

In some uses, stored patterns may define default lower-level implementations of higher-level abstractions. These implementations may be with respect to a specific target platform. For example, a high-level abstract concept of an entity represented in the specification data may produce, by way of associated patterns, a group of elements in the system model relating to the implementation of that entity in, say, a J2EE (Java 2 Enterprise Edition) or Microsoft .NET™ program environment.

The system is preferably adapted to receive the specification data representing a specification of the software system (that is, the software system for which code is being generated), apply a plurality of patterns to the specification to produce an enhanced specification, and to generate the program code from the enhanced specification.

The input component is preferably adapted to receive the specification data in an XML-encoded format, and the processing component is adapted to generate the further specification data in an XML-encoded format. By using XML to encode the specification data, the hierarchical structure of the system model can be more easily represented, and processing of the specification data can be more efficient.

The patterns may be specified in a scripting, text processing or template language, and produce specification data, preferably in XML-encoded format, when processed. Preferably, patterns use the Velocity template language.

In accordance with a further aspect of the invention, there is provided a code generation system for generating program code for implementing a software system specified by specification data, comprising: a meta-model processor adapted to receive a meta-model specification defining types of elements which may be specified in the specification data and to generate a meta-model representing said types of elements in dependence on the meta-model specification; a specification processor adapted to process the specification data in dependence on the meta-model and to generate a system model of the software system from the specification data in accordance with the meta-model; and a code generator adapted to generate the program code from the system model.

In this way, a more flexible code generation system can be provided. Different kinds of program code can be generated by changing the meta-model used (as specified by the meta-model specification and associated patterns and templates), for example for different programming languages or target platforms/environments. In some examples, different code may be generated based on the same specification data by changing the meta-model specification.

The meta-model specification preferably defines a class hierarchy of object classes which may be used in generating the system model, and the specification processor is preferably adapted to generate the system model in the form of a plurality of objects in accordance with the defined class hierarchy. This can enable more expressive and flexible meta-model specifications and specification data.

Alternatively or in addition, the meta-model specification may define groups of patterns and/or templates, which may be associated with the objects or with the system model.

Preferably, the meta-model processor is adapted to receive a plurality of meta-model specifications each defining a portion of a complete class hierarchy to be used in generating the system model, at least some of the plurality of meta-model specifications preferably being interrelated by way of class inheritance relationships between classes defined in them, the meta-model processor preferably further being adapted to construct the complete class hierarchy from the plurality of interrelated meta-model specifications. In this way, greater modularity can be provided and the meta-model specifications can be created, modified and maintained more easily. Additionally, individual portions of the class hierarchy can be easily replaced by replacing the meta-model specification relating to that portion with a different meta-model specification.

Preferably, the system further comprises a plurality of stored meta-model specifications, and input means for receiving a selection of one or more of the plurality of stored meta-model specifications to be used by the system. In this way, the system may be more easily configured by simply selecting a number of pre-defined meta-model specifications for the system to use, and changes to the meta-model can be effected more easily.

A given meta-model specification is preferably associated with processing information relating to the generation of the system model and/or the generation of program code. Different meta-model specifications may be associated with different processing information, so that the generation of the system model and/or program code may be further modified in dependence on the selection of meta-model specifications. This may make it easier to adapt the system for generating code for different programming languages or execution environments. The processing information may include patterns, templates, configuration files and/or controls.

Preferably, the meta-model used in the generation of the system model has a plurality of layers each having distinct modelling functions, each layer being represented by at least one stored meta-model specification; and wherein the stored meta-model specifications comprise, for at least one such layer, a plurality of alternative meta-model specifications which are usable interchangeably in specifying that layer of the complete meta-model which is to be used by the system. In this way, the user of the system can be provided with a choice of different implementations of a given meta-model layer by which to influence the generation of the program code. For example, a language layer of the meta-model may model programming language constructs. A conceptual layer may model more abstract concepts (such as higher-level UML modelling concepts), and there may be inheritance relationships between the classes defined in the language layer and those of the conceptual layer. The specification data may specify the system in terms of the abstract layer (in which terms a system designer might typically model a system to be built). By selecting a specific language layer for the meta-model (such as a Java or C# layer), and combining the selected language layer with the abstract layer to produce the meta-model, a system model can then be created suitable for generation of code in the relevant language without requiring the specification data to be changed. Individual layers can preferably be exchanged without affecting relationships between layers. As another example, one layer may represent a target environment for the generated code (such as J2EE or .NET), and by selecting the appropriate implementation of that layer for the required target environment, the code generation system can be configured to generate code for that environment.

In this way, a more flexible and adaptable code generation system may be provided, which can also be more independent of target language, target platform and/or target environment.

For the above reasons, the interchangeably usable meta-model specifications may define classes having equivalent modelling functions or representing equivalent modelling concepts with non-equivalent class implementations. The interchangeable meta-model specifications are therefore preferably able to plug into the same slot in the framework of the meta-model, for example if inheritance is used in a higher meta-model the lower interchangeable meta-models should provide the base classes required.

Preferably, the interchangeably usable meta-model specifications are each associated with respective different processing information relating to the generation of the system model and/or the generation of program code. In this way, the generation of the system model and/or the program code can be further influenced by the selection of specific meta-model layers. The processing information may comprise a pattern associated with a given class, the pattern defining one or more elements to be added to the system model; the specification processor preferably being adapted to add the defined elements to the system model in response to the creation of an object of the given class within the system model. Since different patterns may be associated with different meta-model specifications, the selection of patterns can be influenced by selecting different meta-model specifications, potentially resulting in a different system model, and hence different program code, being produced from the same specification data. This can further enhance target platform/language independence while reducing the complexity of the specification data and the specification task, which can be independent of the target platform/language. Patterns are preferably used as described above.

Alternatively or in addition, the processing information may comprise a code generation template associated with a given class, the template defining code to be generated for an object of the given class; the code generator being adapted to generate the defined code in response to identifying an object of the given class in the system model. Again, the adaptability of the system to different target platforms, environments and languages can thereby be enhanced. For example, different code generation templates can be provided for different target languages. By specifying a specific target language layer for inclusion in the meta-model, associated target language templates can then be automatically selected. A template may comprise a script or template that may be run to produce all or part of an output file. The template may be implemented in a template or scripting language such as the Velocity template language.

The term ‘rendering’ may be used to refer to a pattern or a template or may be used to refer to a particular group of patterns and templates to implement a particular embodiment of a system, for example ‘The J2EE rendering’ may refer to all of the patterns, templates and component.properties used to implement a J2EE system.

The meta-model processor is preferably adapted to generate a hierarchy of class definitions in an object-oriented programming language in dependence on the meta-model specification. The object-oriented programming language may be Java or a Java-related language. The specification processor may be executed in a Java runtime environment, and may be adapted to generate the system model by creating, in dependence on the specification data, Java objects in accordance with the Java class hierarchy generated by the meta-model processor. In this way, the system model may be implemented more efficiently.

The meta-model specification(s) is (are) preferably in an XML-encoded format. This can make them easier to maintain and more efficient to process.

Preferably, the system is adapted to store first and second meta-model specifications relating respectively to first and second target programming languages, and to generate the program code in the first target programming language if the system is operated using the first meta-model specification and to generate the program code in the second target programming language if the system is operated using the second meta-model specification. In this way, the same specification data may be used to produce generated code in different programming languages (for example, Java or C#). Alternatively or in addition, the system may be adapted to store first and second meta-model specifications relating respectively to first and second target execution environments, and to generate the program code in a form suitable for the first target execution environment if the system is operated using the first meta-model specification and to generate the program code in a form suitable for the second target execution environment if the system is operated using the second meta-model specification. This can enable the same specification (as represented by the specification data) to be used to produce system implementations for multiple target environments/platforms (such as J2EE or .NET), or can allow the target platform/environment of a system to be changed more easily.

In a further aspect of the invention, there is provided a code generation system for generating program code for use in implementing a software system specified by specification data, the system comprising: an input component for receiving specification data for the software system; means (for example storage) for storing a plurality of templates, wherein the templates define sections of program code; means (for example storage) for storing a plurality of code generation controls, wherein the controls each comprise generate-time executable code routines external to the templates and the specification data and wherein at least some of the templates include references to controls; a code generation component for applying selected templates to elements of the specification data to generate corresponding sections of generated program code based on the templates; means (for example a processing component) for executing controls selected based on the references in the templates and incorporating the output from the controls into the program code.

Advantageously, providing controls that are executable at generate time may increase the richness and complexity of program code that may be generated. Using controls external to the templates may further allow a user to change standard features applied to many templates via controls without changing each template individually, as described in more detail below. The output from the control may be incorporated directly into the program code, for example as program code or as a variable, or may be incorporated indirectly, for example by affecting the further processing of the program code.

In a preferred embodiment, the system further comprises means (for example storage) for storing a plurality of patterns, wherein the patterns each define specification data representing elements that may be added to a model of the specification data, wherein the plurality of controls are external to the patterns and wherein at least some of the patterns include references to controls; means (for example a pattern processor) for selectively applying patterns to the specification data to generate further specification data; and means (for example a processing component) for executing controls selected based on the references in the patterns and incorporating the output of the controls into the specification data.

Hence both patterns and templates may reference controls to be executed.

In a preferred embodiment, the controls may be executed within the execution environment of the code generation component.

Preferably, the system may further comprise means for accessing data from the specification data to input variables and/or values into the program code. The specification data may be accessed by either the templates or the controls.

The plurality of controls may be arranged into a plurality of alternatively selectable control sets and the control may be selected in dependence on the selected control set. Hence a particular predefined set of controls may be used by the system.

In a preferred embodiment, the specification data may be represented as a system model comprising a plurality of objects, the objects being based on a selected class hierarchy, and the control executed may be selected based on the selected class hierarchy or on at least one object in the selected class hierarchy. This may allow the specification data to determine the controls used and hence the program code generated, for example the program code may be generated in a language defined by the specification data and the interaction of objects may be determined by the specification data.

It is noted that the plurality of objects in the system model may comprise one or more object hierarchies. In some cases, there may be additional sections of specification, which may not be rendered, but which may be added into the main tree outside of the scope of the controlling meta-model stack. The additional specification may include information that is relevant to more than one specification, so may be reused for a number of specifications.

Further preferably, the class hierarchy may have multiple independently selectable layers and the control may be selected based on the selected layers.

Controls may be associated with different layers in the class hierarchy and controls associated with lower-level layers in the class hierarchy are preferably selected in preference to controls associated with higher-level layers. In the present embodiment, there is no direct relationship between objects representing the specification and controls.

In a preferred embodiment, the selected class hierarchy comprises a layered meta-model for the specification data, wherein controls are associated with different layers of the meta-model and wherein controls associated with higher-level layers of the meta-model are selected in preference to controls associated with lower-level layers. Controls associated with higher-level layers of the meta-model preferably only override controls associated with the lower-level layers if the controls have the same name and are of the same type.

Preferably, the program code is generated in a specified language and the control is selected based on the specified language. For example, the system model may specify that the program code is to be written in the Java language, so Java controls may be used to generate output for the Java program code.

The control may generate a section of program code for incorporation into the program code of the software system.

Alternatively or additionally, the control may generate a value for a variable for incorporation into the program code of the software system. For example, the value may be calculated by the control, which may obtain input variables from external or internal sources, for example, the control may obtain input from a user.

In one embodiment, the output from one control may comprise an input for a further control. Hence the output of a first control may not be incorporated directly into the program code but may be used in a further control or in a further template. In addition, the output of a control may be used to determine whether further processing should be undertaken. For example, the output of a control may be incorporated into the program code by using the output to determine whether a further control or template should be applied.

At least one control may comprise a language control to generate a section of program code in a language defined by the specification data for the system. Hence a control may be used to input the correct command into the program code depending on whether the program code is being generated in Java or C#.

At least one control may comprise a logging or tracing control to generate a section of program code to perform logging and/or tracing for the software system. Using a control to generate a logging and/or tracing system may be advantageous since the control can be changed easily to change the logging system for all subsequent sections of program code generated. This may be more efficient and reliable than working through each template to change the logging system for each template individually. The logging or tracing generated by the controls preferably comprises logging or tracing code for execution at run-time.

At least one control may comprise a datatype control to control internal and/or external conversions of data and/or formatting of data. This may enable data to be converted or formatted correctly, for example depending on the language used for the program code.

At least one control may comprise a database control to generate program code to control the interface between the program code and a database. The control used may depend on both the program code and the type of database used and may advantageously enable any type of program code to interface with any type of database. In addition, an interface may be generated between new types of program code and databases by implementing new controls.

At least one control may comprise a user interface control to generate program code relating to a user interface, in particular program code to generate a user interface for the software system. The control used may obtain input from a user to enable a user to define aspects of the user interface at generate time.

The system may further comprise means for obtaining input from a user during execution of a control. Preferably, at least part of the control is written in a programming language, preferably the Java programming language. A programming language such as Java may be used to implement lower-level details of controls with rigour and speed.

Additionally or alternatively, at least part of the control may be written in a scripting, text processing or template language, preferably the Velocity template language. A language such as Velocity may be used to implement higher-level aspects of the controls quickly and with flexibility.

In a preferred embodiment, at least some of the controls contain both sections written in a programming language, such as Java, and sections written in a scripting, text processing or template language, such as Velocity. Hence the advantages of each of the languages may be combined to enable controls to be written both rigorously and quickly.

In a preferred embodiment, the system further comprises means for storing configuration data and means adapted to generate code in accordance with the configuration data.

In one embodiment, the controls may be used to adapt names in the program code to a predefined naming convention.

In an alternative, preferred, embodiment names in the program code may be adapted to a predefined naming convention based on configuration data and/or specification data. For example, based on data in the model created using the specification data or based on information in a configuration.properties file.

In a preferred embodiment, the system further comprises means for adding tracing comments into the generated program code to indicate the origin of sections of the program code. The tracing comments are preferably generated directly by the code generation system independently of the patterns and templates and may be used to identify which pattern or template was the source of the generated text.

Preferably, the format of the tracing comment is determined by the type of the program code generated. This may ensure that the comments are non-executable in the generated code.

In a preferred embodiment, the system further comprises means for translating non-executable comments in the specification data or system model into comments in the generated program code based on the type of program code generated. Hence comments input by the system designer, or automatically generated in the system model, may be carried forward into the generated code, which may assist with later debugging or interpretation of the code.

Preferably, the system further comprises means for merging the generated program code with existing program code in the output file. The existing program code may comprise code previously generated by the system or code written manually.

Preferably, the system further comprises means for recognising a unique identifier associated with each element of the generated code. That is, bodies of classes or methods, or each design element, may have an associated a unique identifier ‘UID’. This may enable a design element to be tracked even if the name and signature changes. UIDs may be inserted as comments into the generated code.

The system may further comprise means for updating generated code by updating sections of the code identified using at least one unique identifier. Hence sections of code with predetermined UIDs may be comprised of a portion generated automatically from templates as determined by the specification and a portion that has been added manually by a user, the former portion being overwritten when the specification and/or the rendering changes, the latter not being overwritten but being retained in an updated version of the code, overall in such a way as to create a complete and correct section of code.

In a preferred embodiment, indentation of at least some of the text in the generated program code is determined by indentation commands in the template or pattern. This may allow the layout of the generated program code to be implemented in a way that makes the code easily readable.

Preferably, the indentation commands are interpreted in accordance with configuration data. Hence the effect of the indentation commands may be changed by configuration and the same code generated on different machines or by different users may have different layouts.

In a further aspect of the invention, there is provided a code generation system for generating program code for implementing a software system specified by specification data, comprising: means (for example an input component) for receiving the specification data, the specification data defining elements of the software system and specifying, for each element, an element type; and means (for example an input component) for receiving substitution instructions specifying for given element types used in the specification data, replacement element types to be used in generating the program code; and wherein the system is adapted to generate, for a given element defined in the specification data, program code in dependence on the element type specified for the given element or, in preference thereto, in dependence on a replacement element type specified for that element type in such a substitution instruction. This can allow code generated from the specification data to be more easily adapted to a specific purpose or a target environment. For example, the specification data may define a system model of the software system in terms of abstract concepts, which can be replaced with more implementation-specific concepts before code is generated.

The system is preferably adapted to generate a system model of the software system from the specification data, the system model comprising a plurality of objects each representing respective elements defined in the specification data, each object having an object type or class selected in dependence on the element type specified for the corresponding element in the specification data or, in preference thereto, in dependence on a replacement element type specified for that element type in such a substitution instruction; the system being further adapted to generate the program code from the system model. In this way, a more efficient code generation system may be provided. The specification data is preferably encoded in an XML format, the element type for an element being specified by way of an XML tag; a substitution instruction preferably specifies a tag and a corresponding replacement tag; and the system is preferably adapted to replace tags in the specification data with corresponding replacement tags in dependence on the received substitution instructions, and to generate the program code from the modified specification data. In this way, replacement of element types can be achieved more efficiently.

In a preferred embodiment, the system is adapted to generate program code which is directly executable on a processor.

In an alternative embodiment, wherein the system is adapted to generate program code which is directly executable in a virtual machine, preferably a Java virtual machine.

Preferably, the system is adapted to generate code in an object-oriented programming language and/or in a form suitable for an object-oriented execution environment. The system is preferably adapted to generate source code, preferably one of: Java source code, C# source code or C++ source code. The system may be adapted to invoke a compiler or build utility to compile the generated program code. Alternatively or in addition, the system may be adapted to generate one or more build scripts or files for a build utility (for example, “Make” files for the Unix Make utility or build files for the “Ant” utility) for building the system from the source code. The system may typically generate a plurality of source code files, and may be adapted to store these, and/or any compiled program code, in relevant directories of a directory structure.

In a preferred embodiment, the system further comprises means for generating at least one of:
HTML code for use in generating a web page or interface;
code for use in generating a user interface;
meta-data relating to the specification data;
text output relating to the specification data, preferably a manual, user guide or description of the system;
further specification data in a different format to the original specification data;
mathematical or statistical data relating to the specification data;
compiled code for use in implementing a software program or system;
code to enable a program or system to interface with a database;
an XML or XMI encoding of the specification data.

In a further aspect of the invention, there is provided a method for generating program code for implementing a software system specified by specification data, comprising: receiving the specification data; generating further specification data in dependence on the received specification data; and generating the program code from the specification data and the further specification data.

In a further aspect of the invention, there is provided a method for generating program code for implementing a software system specified by specification data, comprising: receiving a meta-model specification defining types of elements which may be specified in the specification data; generating a meta-model representing said types of elements in dependence on the meta-model specification; processing the specification data in dependence on the meta-model; generating a system model of the software system from the specification data in accordance with the meta-model; and generating the program code from the system model.

In a further aspect of the invention, there is provided a method for generating program code for implementing a software system, comprising: receiving specification data for the software system; storing a plurality of templates, wherein the templates define sections of program code; storing a plurality of code generation controls, wherein the controls each comprise generate-time executable code routines external to the templates and the specification data and wherein at least some of the templates include references to controls; applying selected templates to elements of the specification data to generate corresponding sections of generated program code based on the templates; executing controls selected based on the references in the templates and incorporating the output from the controls into the program code.

In a further aspect of the invention, there is provided a method for generating program code for implementing a software system specified by specification data, comprising: receiving the specification data, the specification data defining elements of the software system and specifying, for each element, an element type; receiving substitution instructions specifying for given element types used in the specification data, replacement element types to be used in generating the program code; and generating, for a given element defined in the specification data, program code in dependence on the element type specified for the given element or, in preference thereto, in dependence on a replacement element type specified for that element type in such a substitution instruction.

The method aspects described above preferably further comprise method steps corresponding to the processing performed by the code generation system as described in various aspects above.

According to a further aspect, there is provided a model processing system for translating data in an input format representing a model of a software system into an output format, comprising:
a plurality of stored patterns defining model enhancements
a plurality of stored output templates defining transformations of model components into the output format
a model processor adapted to receive model data in the input format, the model data defining the model, and to generate a representation of the model from the model data;
a pattern processor adapted to select one or more patterns from the stored patterns in dependence on the model representation and process the model enhancements defined in the selected patterns to produce an enhanced model representation;
a template processor adapted to select one or more output templates from the stored output templates in dependence on the enhanced model representation, and to process the selected output templates to produce data in the output format representing the enhanced model.

Preferably, the pattern processor is adapted to output data in the input format representing the model enhancements defined by the selected patterns, the model processor being adapted to receive the data output by the pattern processor, and to modify the model representation in dependence on the data.

In a preferred embodiment, the model data defines a hierarchical structure of model components, the patterns define additional components which may be added to the model representation, the system being adapted to select patterns in dependence on the model components.

Preferably, each component has a component type or class, the pattern processor being adapted to select a pattern for a given component in dependence on the component type or class.

In one embodiment, the output format is source code for use in implementing a component.

In an alternative embodiment, the output format is an XML or XMI encoding of the enhanced model.

In alternative embodiments, the output format comprises at least one of:
HTML code for use in generating a web page or interface;
code for use in generating a user interface;
meta-data relating to the specification data;
text output relating to the specification data, preferably a manual, user guide or description of the system;
further specification data in a different format to the original specification data;
mathematical or statistical data relating to the specification data;
compiled code for use in implementing a software program or system;
code to enable a program or system to interface with a database.

According to a further aspect, there is provided a model processing system for enhancing a model comprising a hierarchy of model components, the system comprising:
means for storing a plurality of patterns each defining one or more model components that may be added to the model;
a specification processor adapted to receive specification data, the specification data specifying the hierarchy of model components, and to generate the model from the specification data;
a pattern processor adapted to process the model components and, in dependence on a given model component, select a pattern associated with the given component, and output further specification data specifying the additional model components defined in the pattern.

Preferably, the specification processor is adapted to receive the further specification data and to add the additional model components specified in the further specification data to the model.

Preferably, the pattern is selected in dependence on the class of the component.

Preferably, the pattern is selected in dependence on an attribute of the component specifying the pattern.

According to further aspects, there may be provided methods corresponding to the preceding two system aspects.

In a further aspect, the invention provides a method of generating output data based on templates, the templates including data and template processing commands, the template processing commands being expressed in a template language, the method comprising: processing a template in a processing context comprising one or more objects to generate output data for the template, the template including a method invocation command referencing one of the objects and a template method; and in response to the method invocation command, accessing the referenced template method, the method being expressed using the template language, and executing the template method in relation to the referenced object. In this way, templates can be coded more efficiently. Processing of templates preferably involves modifying and/or augmenting data in the template in accordance with the template processing commands to produce the output data. The template data and output data are typically text data. Thus, templates typically comprise text data and text processing commands, and output text is generated from the text data and text processing commands. The output of the template method is preferably incorporated into the output data generated for the template.

The method preferably comprises selecting one of a plurality of corresponding methods based on the type or class of the referenced object. The method reference preferably comprises a method name, and accessing the referenced template method preferably comprises selecting the template method from one of a plurality of corresponding methods having the method name in dependence on the referenced object or in dependence on a type or class of the referenced object or other data associated with the referenced object. In this way, overriding of method definitions may be supported. A facility may be provided to access an overridden version of a method from an overriding version of the method (see “$super” in the detailed description below).

The method may also comprise resolving an implicit reference in the method to an object for which the method is being executed to the referenced object (see “$self”, “$this” in the detailed description below). This can allow the method to access data and properties of the referenced object.

By providing these various object-oriented features in a template language, greater flexibility can be provided and the expressiveness of the template language can be enhanced.

To provide greater control, the method preferably comprises, in response to a return command in the template method, ending execution of the method. Output generated by the template prior to the return command may be discarded. The return command preferably specifies a return value or expression which evaluates to a return value, the method comprising substituting the return value in the template at the point at which the template method was invoked, and continuing processing of the template using the substituted return value. The method invocation command preferably forms part of an expression in the template, the method then preferably comprising evaluating the expression using the substituted return value. The return value is preferably not text data (and may, for example, be a numerical or Boolean value). Thus, though the templates and template methods expressed using the template language preferably by default generate a text output stream, by use of the return command other types of values may be returned from a method and used in further processing. The invention also provides independently a template processor or template processing method capable of processing a return command as set out above.

The template language is preferably the Velocity template language (or a language derived from or similar thereto). Extension of this language with the method features and return command set out above can provide enhanced flexibility and efficiency in the coding of templates.

The templates are preferably used in the context of a code generation system (or other model-based data transformation system) as described herein (and may be JeeWiz patterns or templates as described in more detail later). Accordingly, the method preferably further comprises generating code for a software system based on specification data by a process including: generating a model of the software system based on the specification data, the model comprising a plurality of objects representing elements of the software system; processing, for a given object, a template to generate code for the element of the software system which the given object represents; and wherein the processing context for the template comprises one or more of the plurality of objects, preferably at least the given object.

In a further aspect, the invention provides a template processor for processing templates to generate output data based on the templates, the templates including data and template processing commands, the template processing commands being expressed in a template language, the template processor being adapted to process a template in a processing context comprising one or more objects to generate output data for the template, the template including a method invocation command referencing one of the objects and a template method; and in response to the method invocation command, to access the referenced template method, the method being expressed in the template language, and to execute the template method in relation to the referenced object. The invention also provides a code or other data generation or transformation system as set out above including such a template processor.

The invention also provides a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

The invention also provides a signal embodying a computer program for carrying out any of the methods described herein and/or for embodying any of the apparatus features described herein, a method of transmitting such a signal, and a computer product having an operating system which supports a computer program for carrying out any of the methods described herein and/or for embodying any of the apparatus features described herein.

The invention extends to methods and/or apparatus substantially as herein described with reference to the accompanying drawings.

Any feature in one aspect of the invention may be applied to other aspects of the invention, in any appropriate combination. In particular, method aspects may be applied to apparatus aspects, and vice versa.

Furthermore, features implemented in hardware may generally be implemented in software, and vice versa. Any reference to software and hardware features herein should be construed accordingly.

Aspects of the system will now be described in more detail with reference to the drawings in which:

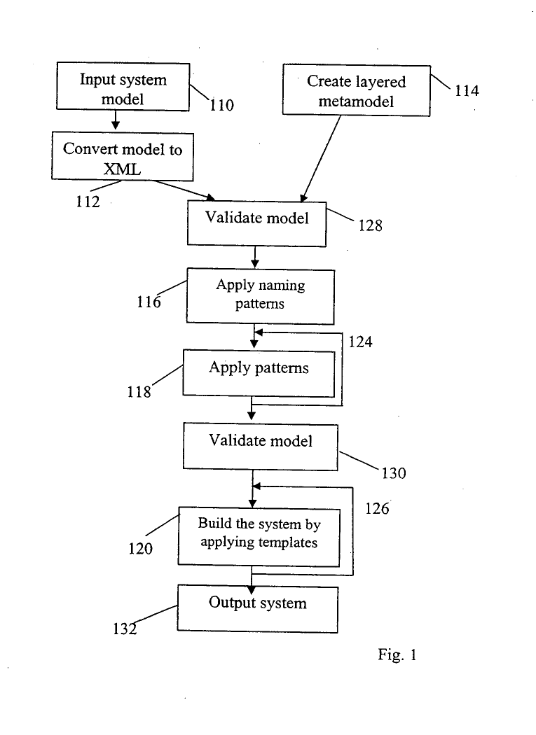

FIG. 1 is a flowchart illustrating an overview of one embodiment of the invention;

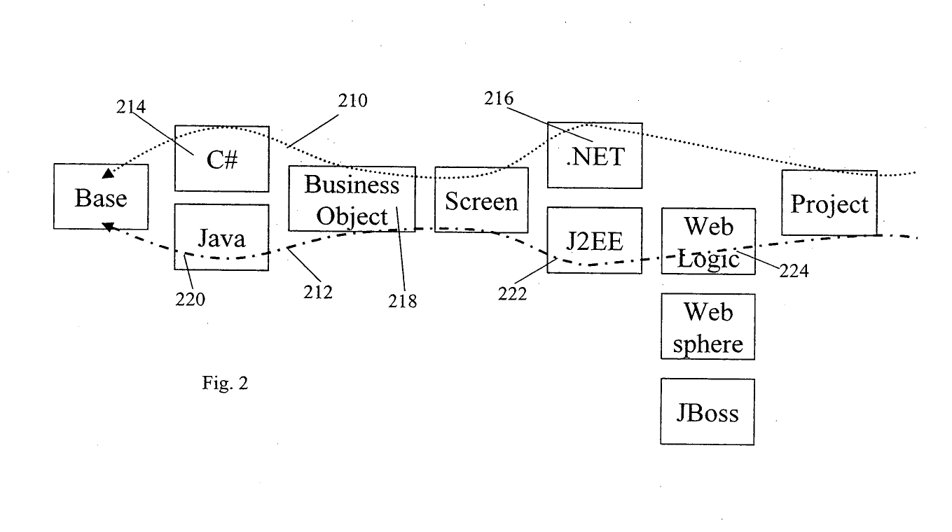

FIG. 2 illustrates a layered meta-model according to one embodiment;

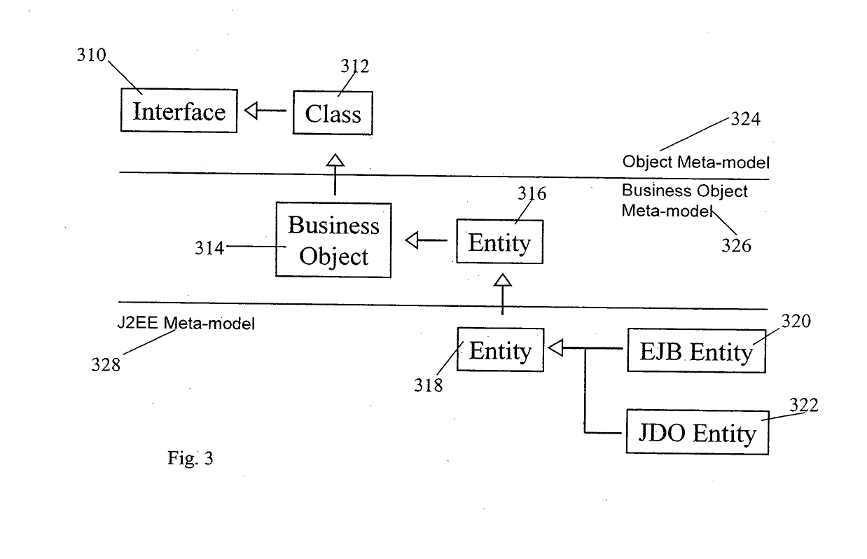

FIG. 3 illustrates types of objects grouped into meta-models according to one embodiment;

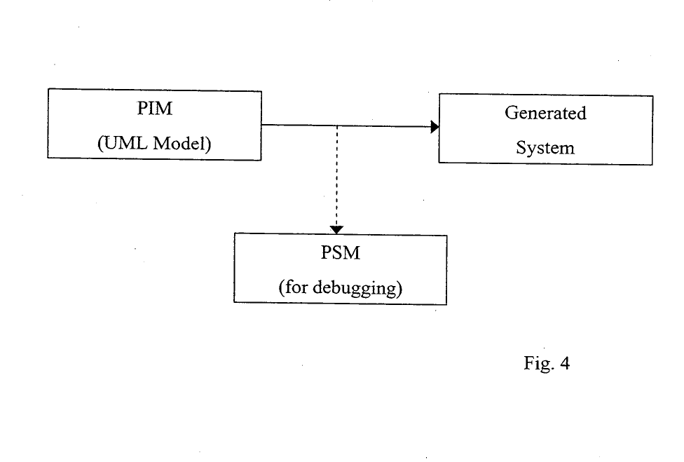

FIG. 4 illustrates schematically the process of transforming a platform-independent model into a generated system;

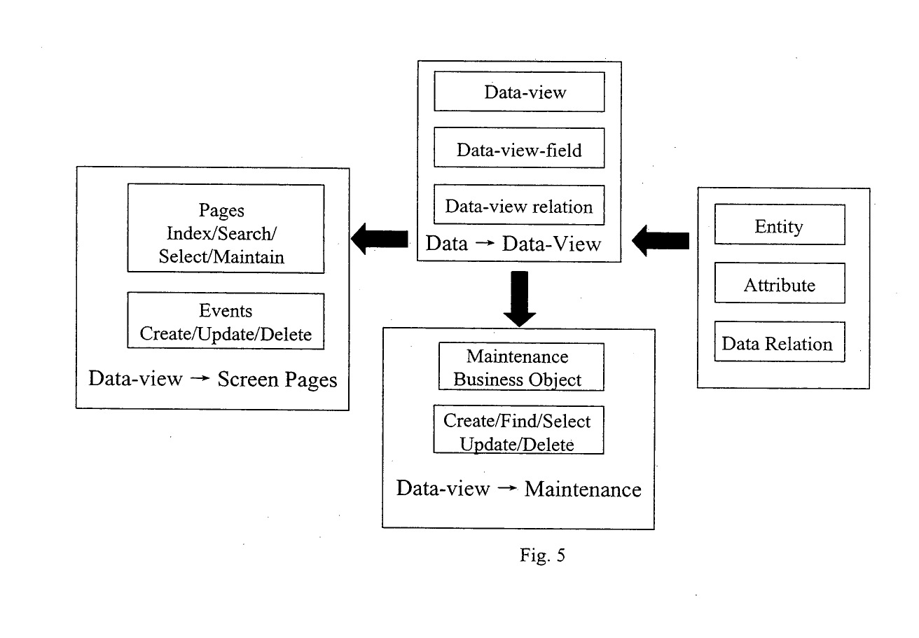

FIG. 5 illustrates schematically the process of creating an extra tier in the model according to one embodiment;

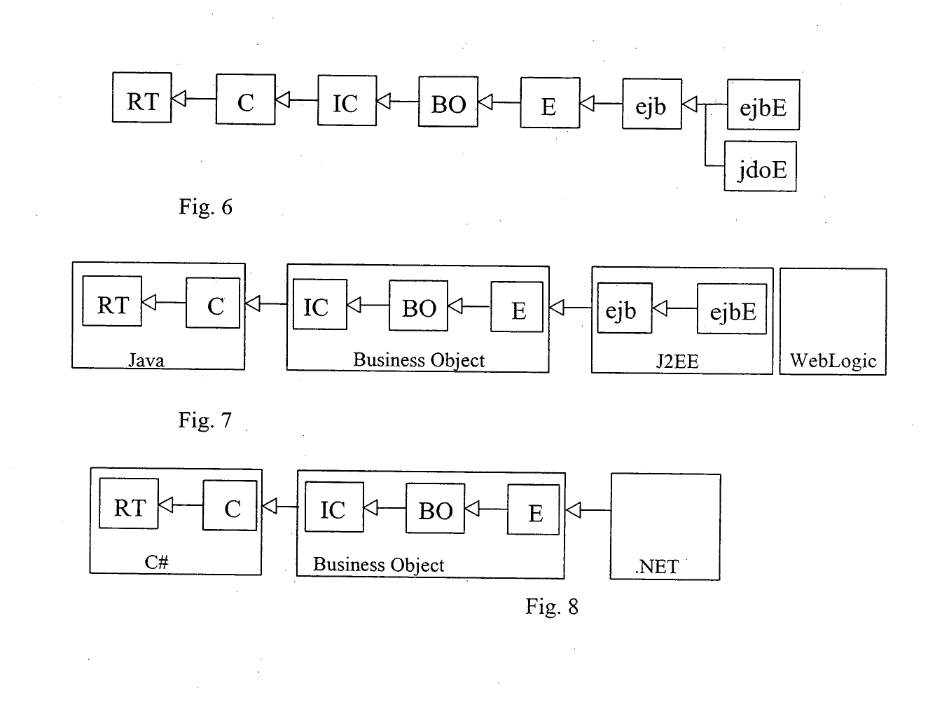

FIG. 6 illustrates part of a meta-model inheritance stack according to one embodiment;

FIG. 7 illustrates the grouping of objects into meta-models according to one embodiment;

FIG. 8 illustrates a .NET stack of meta-models according to one embodiment;

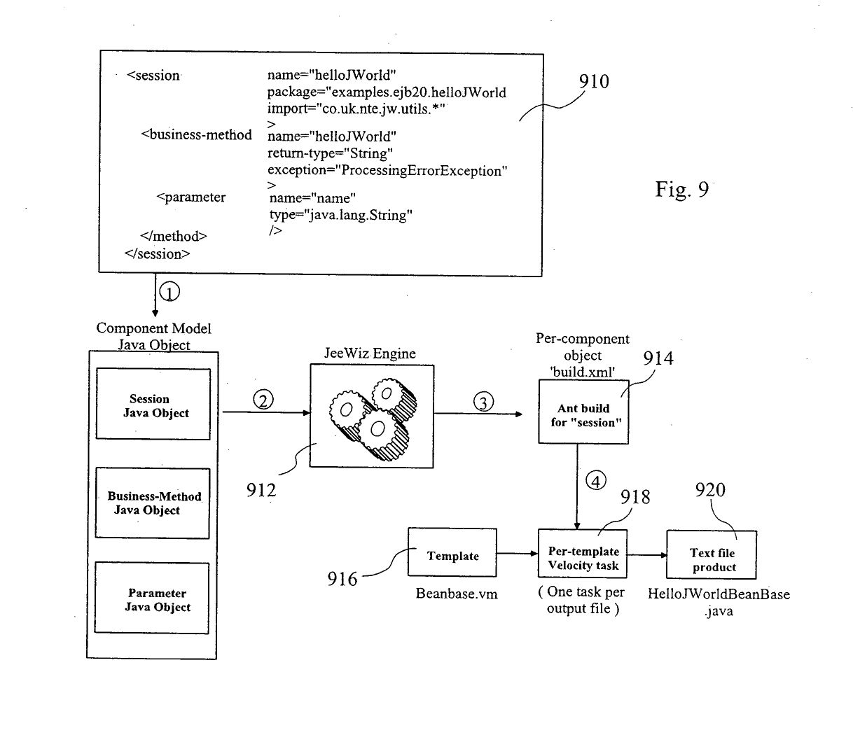

FIG. 9 illustrates one embodiment of the process of generating a system from a specification;

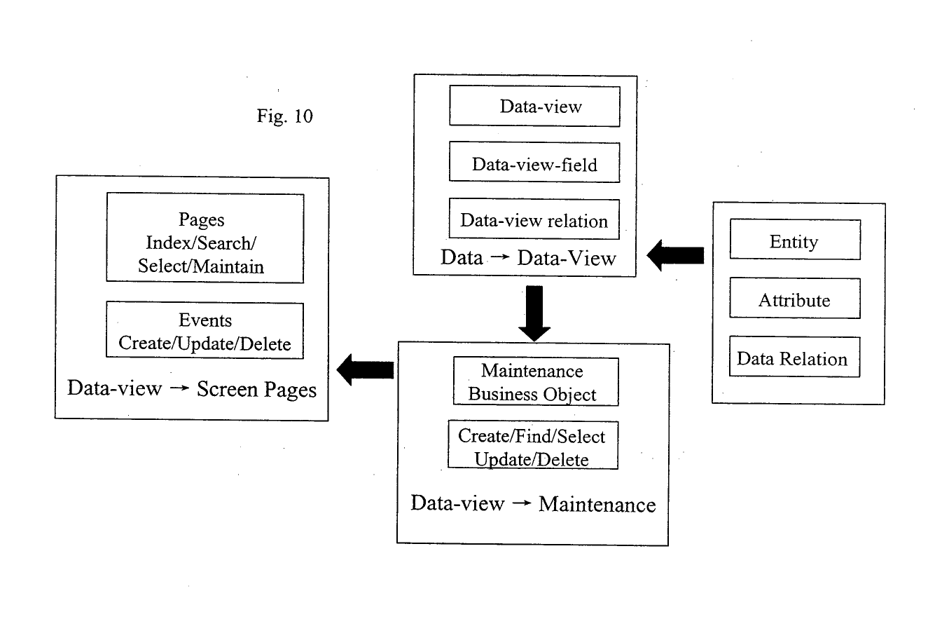

FIG. 10 illustrates schematically examples of mega-patterns;

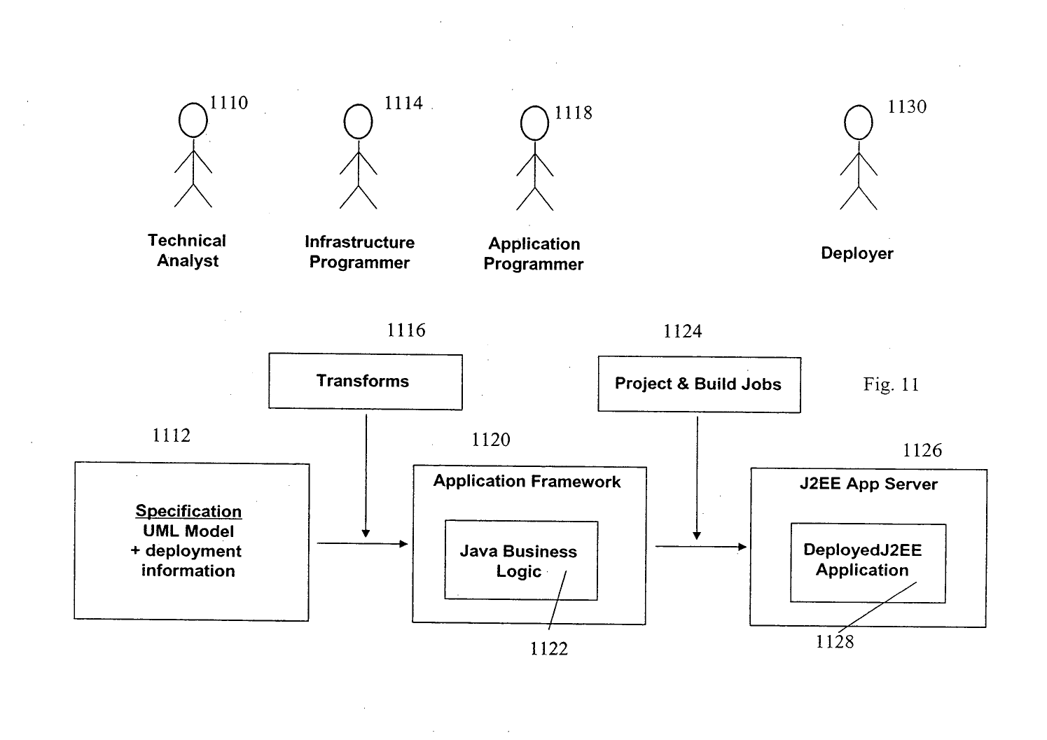

FIG. 11 is a schematic diagram illustrating the process of generating a system according to one embodiment;

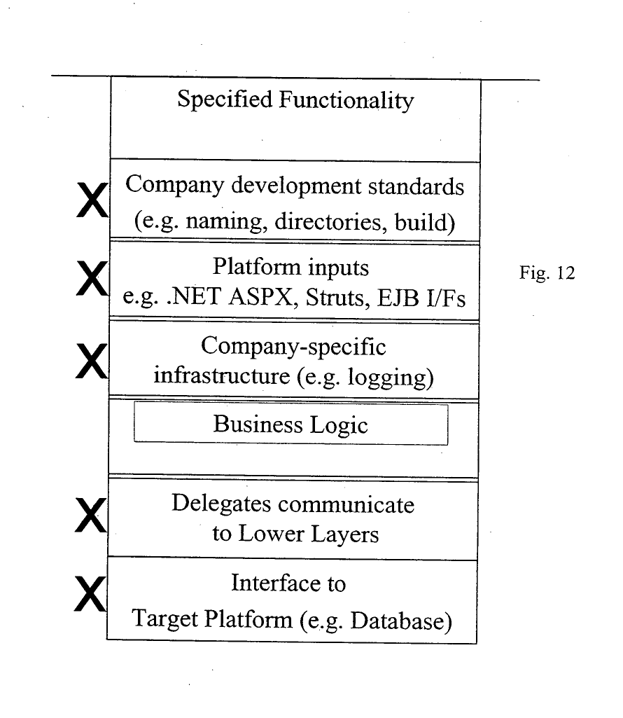

FIG. 12 illustrates one embodiment of business logic housing;

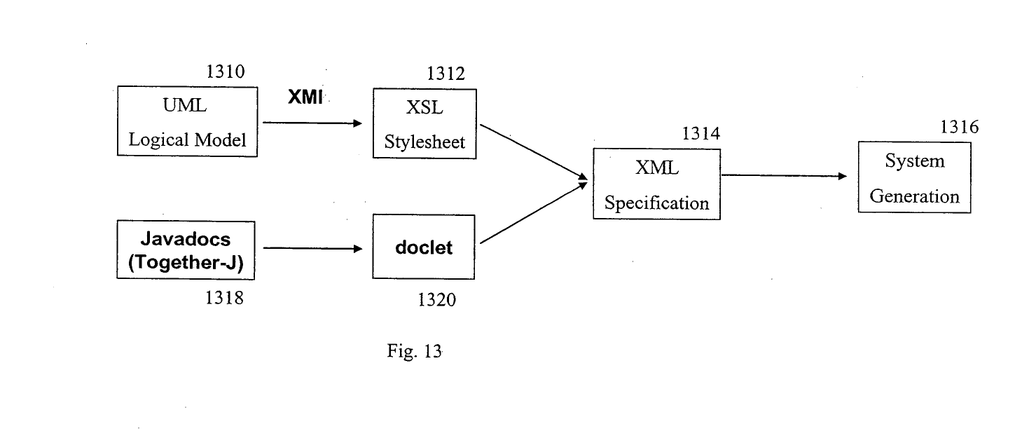

FIG. 13 illustrates the process of translating models to simple XML according to one embodiment;

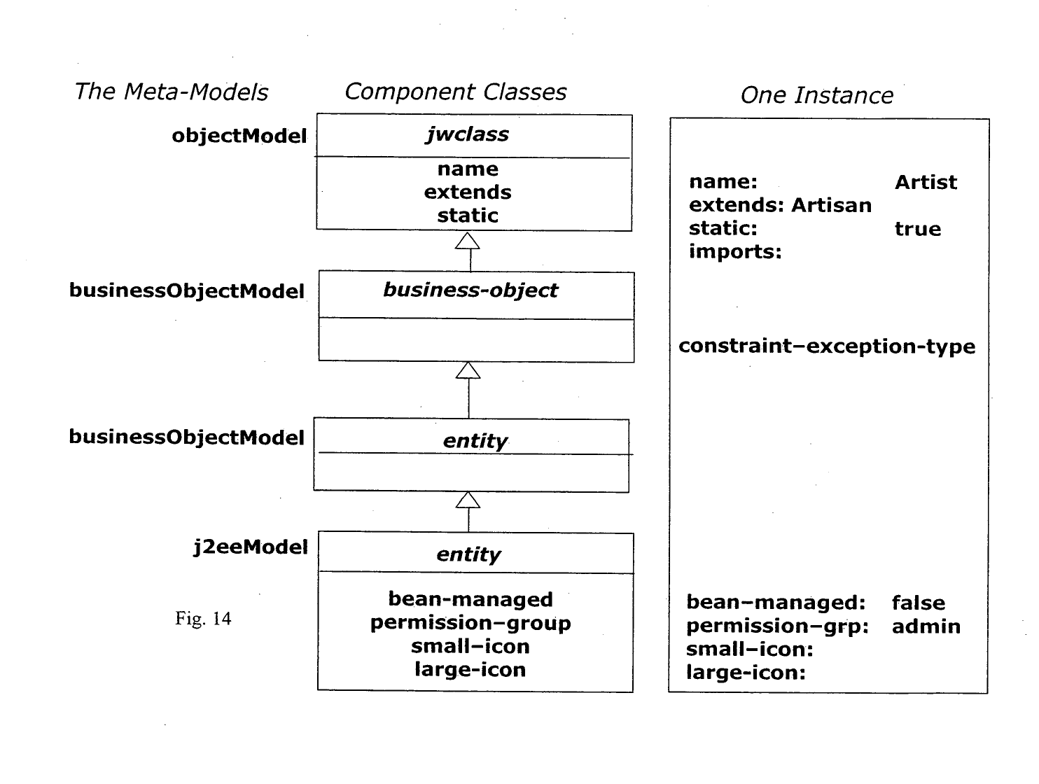

FIG. 14 is a schematic diagram illustrating examples of meta-models and the objects within the meta-models according to one embodiment;

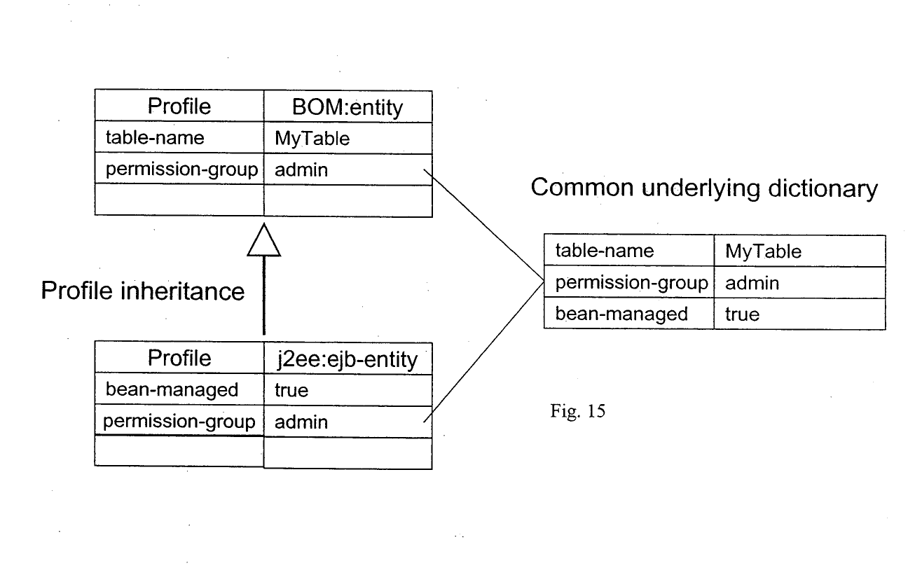

FIG. 15 illustrates schematically features of an editor which may be used in conjunction with the present system;

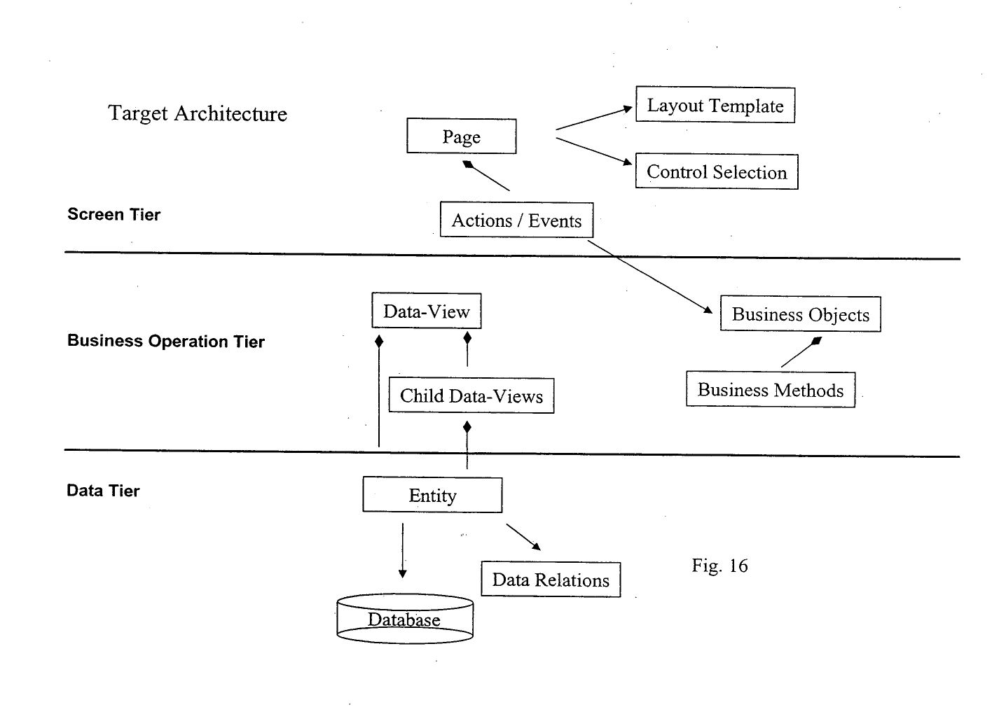

FIG. 16 illustrates a further embodiment of the system architecture;

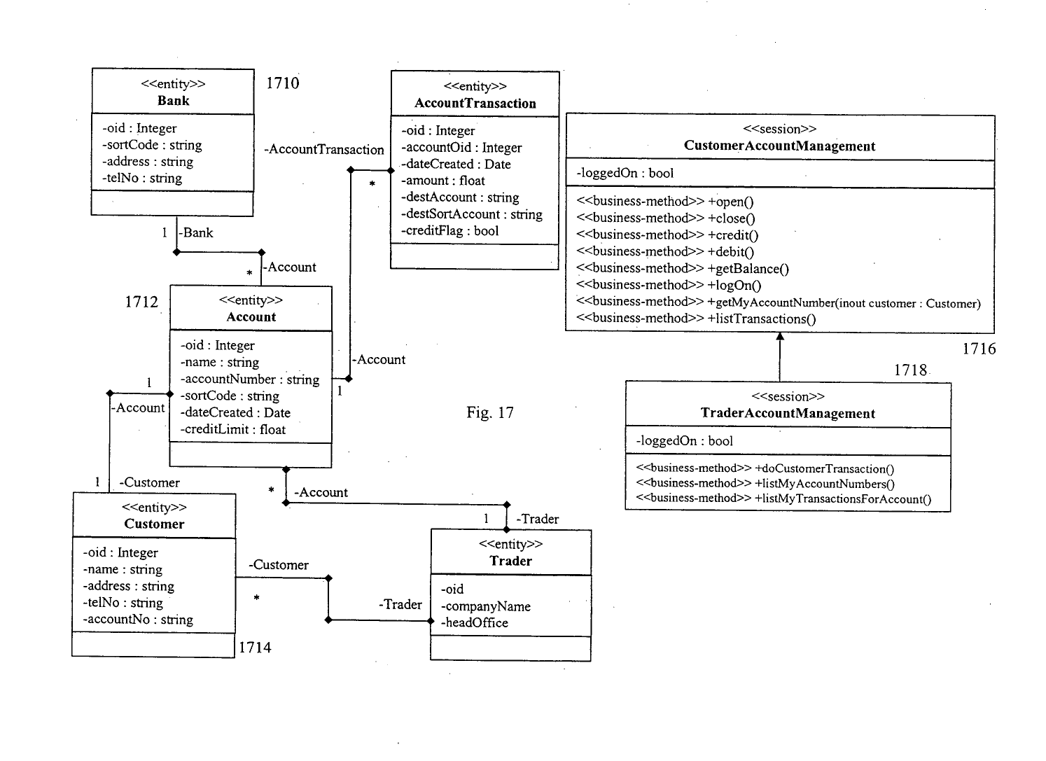

FIG. 17 is an example of entities illustrating their associated properties and methods according to one embodiment;

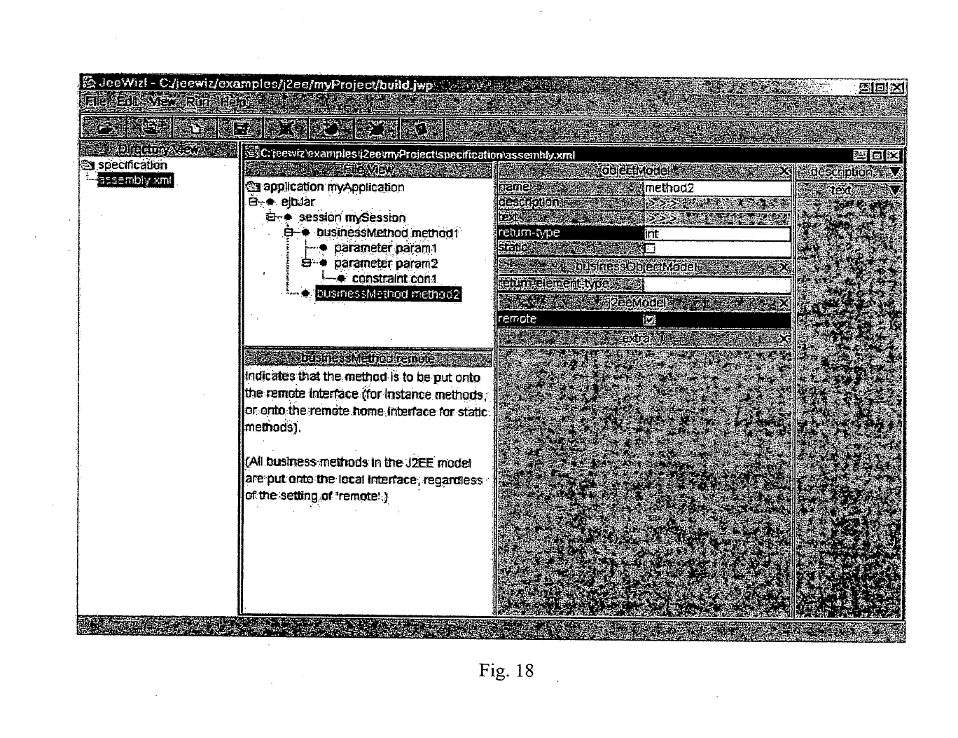

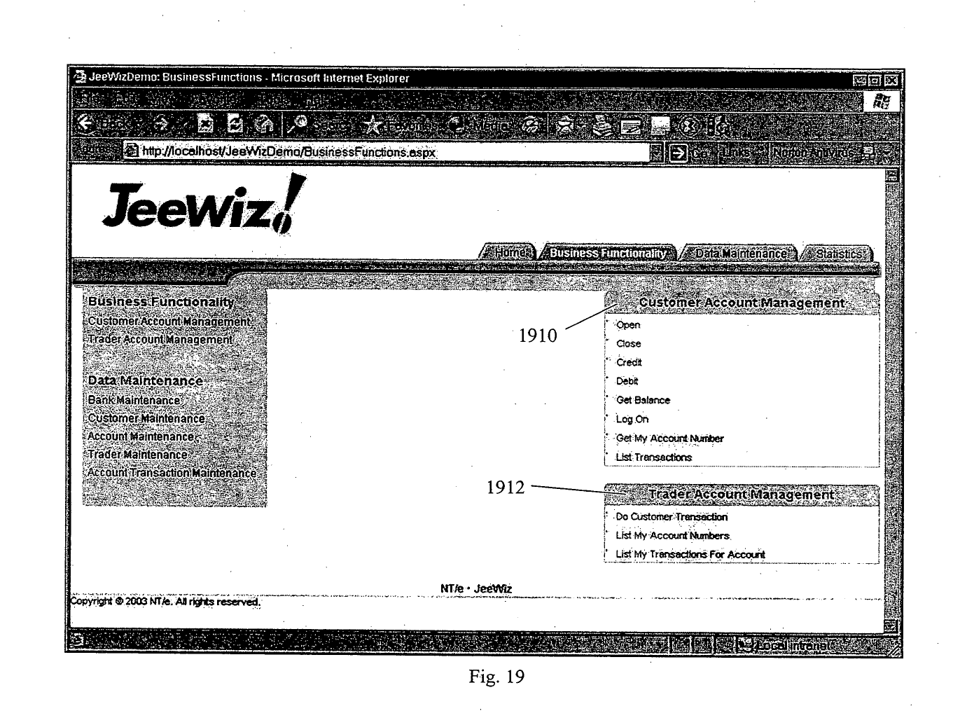

FIG. 18 is a screen shot of one embodiment of an editor that may be used in conjunction with the present system;

FIG. 19 is a screen shot of one embodiment of a system created using the systems and methods described herein;

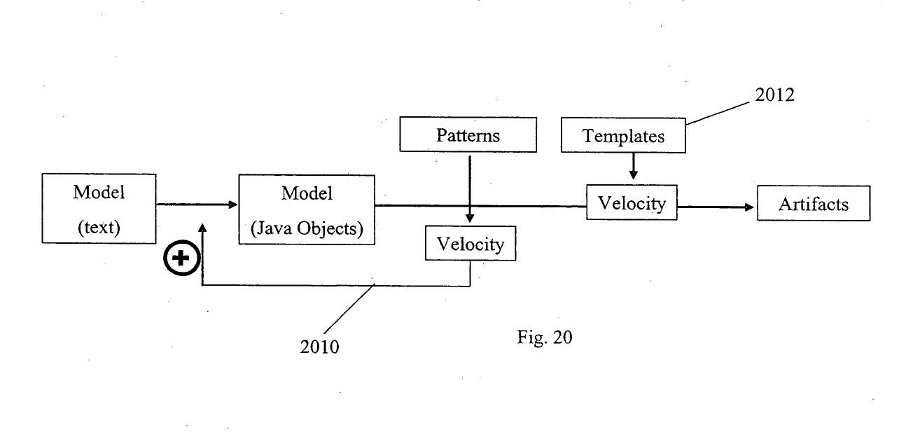

FIG. 20 is a schematic diagram of the process of developing and building a system according to one embodiment;

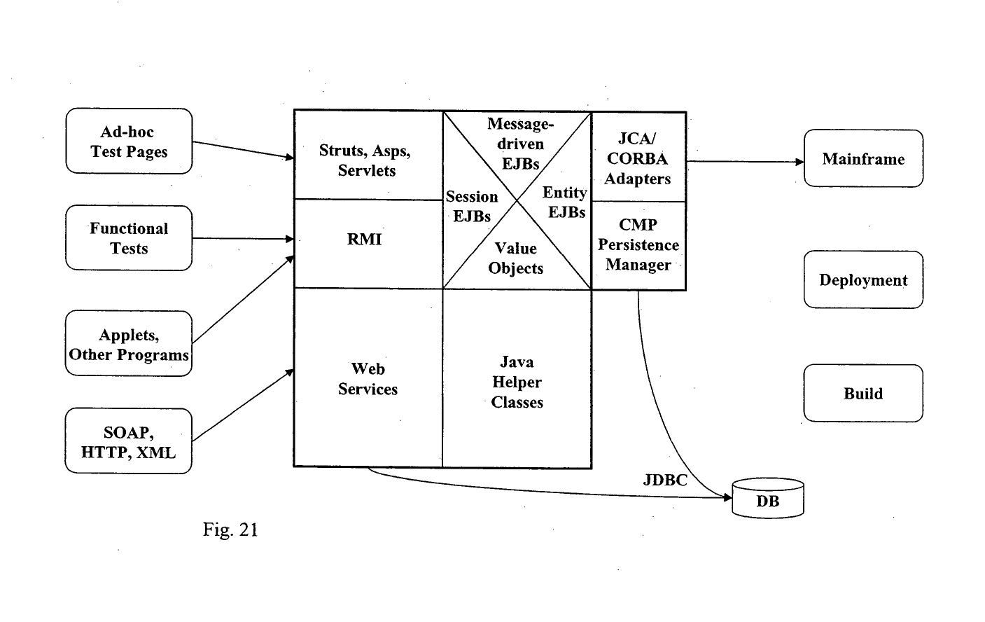

FIG. 21 illustrates aspects of a system that may be generated using the systems and methods described herein;

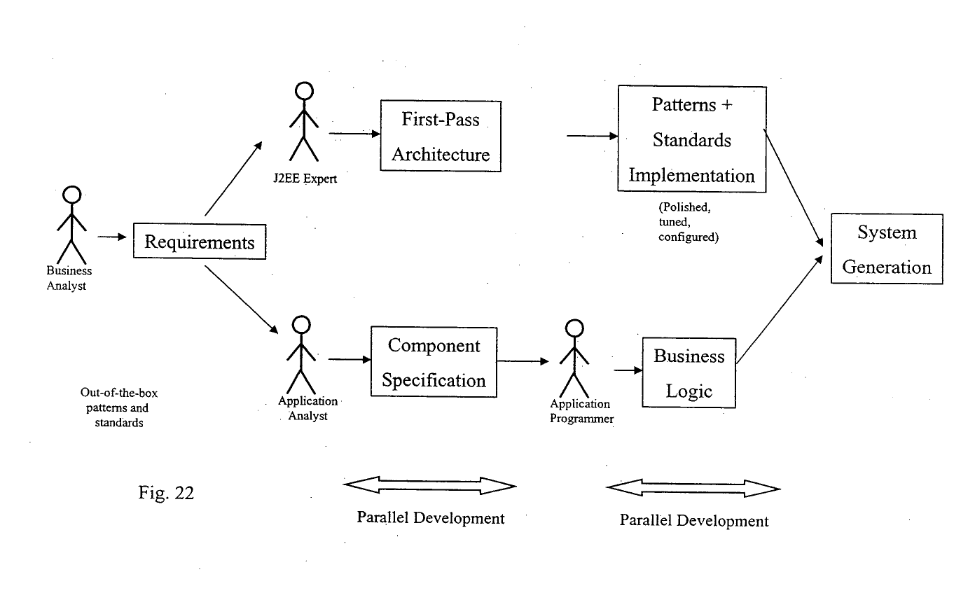

FIG. 22 illustrates one embodiment of the process of developing a system using the techniques described herein;

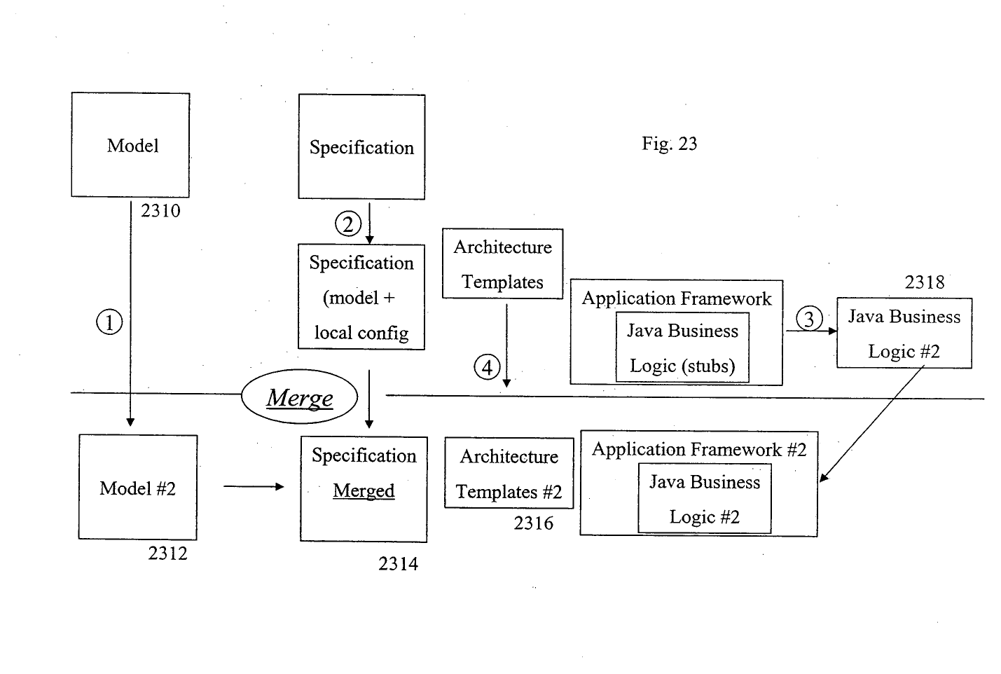

FIG. 23 illustrates how aspects of the system may be merged according to one embodiment before the system is generated;

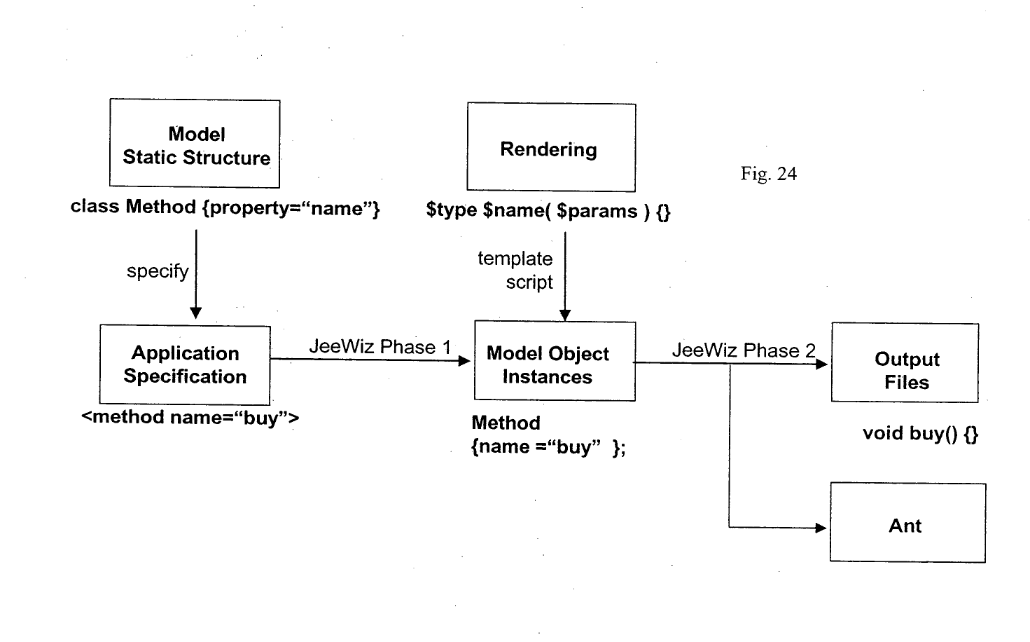

FIG. 24 illustrates the operation of the generator system according to one embodiment;

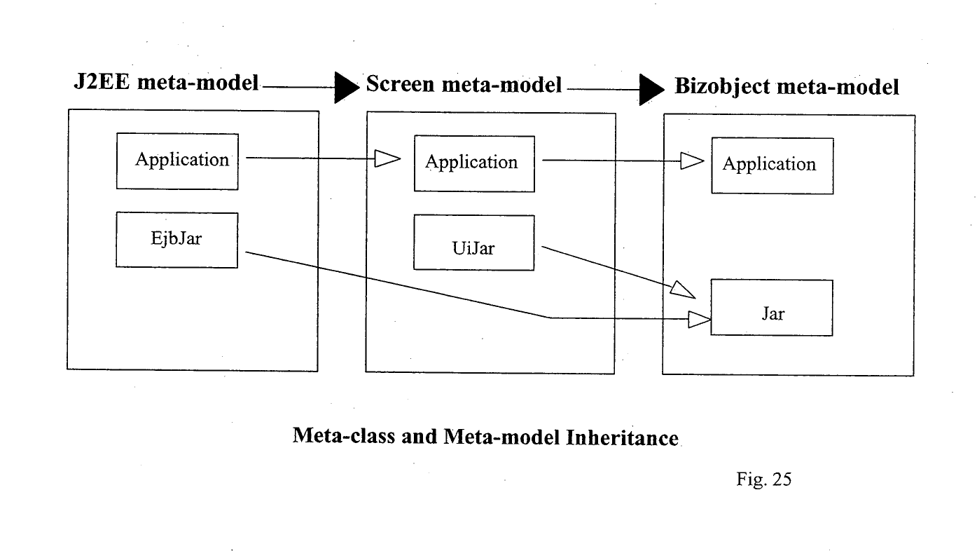

FIG. 25 is a schematic diagram showing inheriting meta-classes and meta-models according to one embodiment;

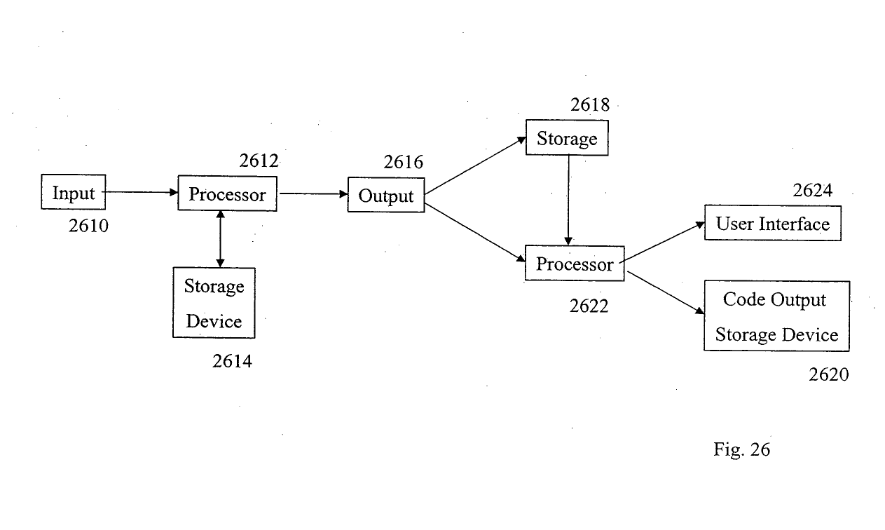

FIG. 26 is a schematic diagram illustrating a system that may be used to implement aspects of the system described herein;

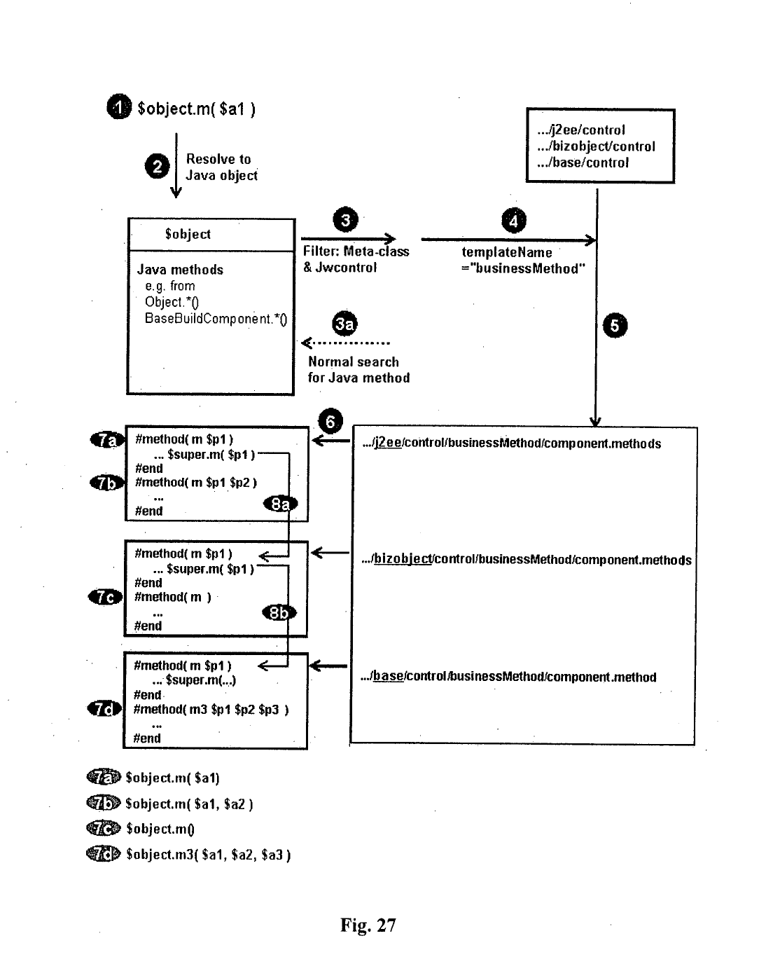

FIG. 27 illustrates the Velocity “method” extension.

### OVERALL DESCRIPTION OF ONE EMBODIMENT

A simple embodiment of a process for generating a coded system from a business model will now be described by way of illustration with reference to FIG. 1. The embodiment is not intended to be limiting in any way and steps may be omitted or re-ordered or additional steps may be added into the process. Details of how each step is implemented and details of further steps or sub-steps that may be incorporated into embodiments of the process are set out below.

A model of the system for which the code is required is developed by a technical analyst 110. This model is a Platform Independent Model (PIM) comprising analysis elements. The model may be developed in one of a number of different formats, for example the model may be developed in a language such as XML (Extensible Markup Language), such as simple XML or using a more complex XML-based language. Alternatively, the model may be developed using a modelling language, for example UML (Unified Modelling Language) or using a modelling tool, such as the “Rational Rose” modelling tool.

If the model is not written in simple XML, the model is converted into a simple XML format 112.

A layered meta-model 114 is developed to set out how the system model is to be implemented. The meta-model is described in more detail below but, in summary, the layered meta-model comprises a number of stacked meta-models relating to different aspects of the system. For example, a C# meta-model includes rules to define how C# may be generated from the system model and a business object meta-model defines rules for how the business-level aspects of the model may be implemented, for example defining the attributes and possible interactions between objects such as customers and products.

The meta-models used to form the full layered meta-model for a particular system are selected by the systems architect depending on the system they wish to develop. For example, to create a .NET based system, based on the C# programming language, the meta-models for .NET and C# are incorporated into the stack of meta-models. Some meta-models, such as the base meta-model and the business object meta-model, will be present in most layered meta-models and other meta-models, such as a project or company-specific meta-model may be particular to the system being generated.

Once the system model has been produced, rendering of the system model takes place. In the present embodiment, this includes applying naming patterns to the model 116, firing patterns 118 to generate more model objects and using templates 120 to generate the output. Each of these steps is described in more detail below. Additional or fewer steps may be used to render the model, for example validation steps are preferably included as described in more detail below.

In the first step of rendering, naming patterns may be applied to the model 116. This may allow the naming conventions in the models and code generated from the system model to be consistent with existing naming conventions used by the company, for example in applications and directory systems with which the generated code will interact.

Patterns are then applied to the system model 118 according to the meta-models selected to form the layered meta-model. The patterns develop the system model further and add further detail to the model. The patterns are applied recursively 124 to develop the system model fully and allow the model to be automatically enhanced and generated to a much greater level of complexity and detail than would be possible in a manual operation.

The resultant system model may be several orders of magnitude larger and more detailed than the original model. As described in more detail below, it would be impractical to develop a complex system by applying patterns manually and the present system, which allows automatic and recursive application of pre-developed patterns may enable the development of more complex systems than was previously possible.

Templates are then applied 124 to the pattern-generated system model to convert the detailed model into computer-generated code. The templates applied to the system model are dependent on the model developed by the patterns and hence on the layered meta-model originally defined by the systems architect. For example, if the meta-model includes a Java layer, the patterns and templates used will develop the code using the Java language. In the present embodiment, templates are applied to the system model as the system is built using the Ant processes and protocols, as described in more detail below. The system is generated by running an Ant build file for each object in the model and working through the objects from the bottom up in a tree structure. Ant build files may call particular templates and the templates themselves may contain further Ant build files to generate further sections of the system 126. The completed generated system may then be output for use 132.

Validation of the system may take place at one or more of a number of stages in the process. For example, validation of the original system model is preferably performed before patterns are applied to the model 128. This may be used to ensure that naming and model-generation patterns will work properly based on the original system model. Also, once the patterns have been used to develop the model, validation 130 may be used to ensure that the templates will work when applied to the model developed using the patterns.

Hence, in summary, the generation process may use the following inputs in addition to the model:
a set of patterns, for use in complex areas such as system engineering, which enhance a PSM to create the logical structure of the application
a set of templates to define the structure of generated files
system and component properties that give values required by the build, reflecting local standards and build structures
Ant build files that drive the various tools, like Java and EJB compilers and the template processor, to generate the build products for individual model objects.

FIG. 11 is schematic diagram illustrating a further embodiment of system generation in which a technical analyst 1110 creates a specification as a UML model 1112 with deployment information. An infrastructure programmer 1114 develops transforms 1116, which may include patterns and templates, which may then be incorporated into the application framework 1120. An application programmer 1118 may further create business logic, such as java business logic 1122 to be incorporated into the framework 1120. Project and build jobs 1124 are then applied and the system, for example a J2EE application server 1126 is built, which may then be deployed 1128 by a deployer 1130.

FIG. 20 is a schematic diagram of steps in the process of developing and generating a system according to one embodiment. In particular, it is noted that the application of patterns may be recursive 2010 and that templates are applied 2012 after the model or specification has been developed.

FIG. 21 illustrates aspects of a system that may be generated using the systems and methods described herein, for example web services and ASPs may be generated.

FIG. 22 is a schematic diagram of one embodiment of the process of developing a system. In particular, the diagram illustrates how some aspects of development may be undertaken in parallel. FIG. 23 illustrates how aspects of the system developed in parallel may be merged before code is generated. For example, two models 2310, 2312 may be merged to produce a single merged specification 2314. Additional architecture templates 2316 and Java Business Logic 2318 may also be added to the system to facilitate the generation of the code.

FIG. 24 is a schematic diagram illustrating the operation of the generator according to one embodiment. The model, for example in UML, is translated into a specification and rendering, for example patterns and templates, are applied to generate model object instances and output files, which may be built using ‘Ant’.

Aspects and features of the system will now be described in more detail. It will be appreciated by one skilled in the art that not all of the features described may be implemented in a particular embodiment of the system and features may be provided independently or in combination.

It will be clear to one skilled in the art that the system described herein may be implemented using conventional processing systems. FIG. 26 illustrates an example of a processing system that may be used, including input means 2610 to input a specification for the system, a processor 2612, which may be used to process the specification according to the methods and techniques described herein. The input means 2610 may comprise direct input means, such as a keyboard, or may comprise means for obtaining a prepared specification from a storage device. The processor may further access a storage device or memory means 2614 to obtain meta-models, patterns, templates and controls described herein and to store aspects of the system being created, such as the stacked meta-model. An output 2616 may further be provided to output the generated code, for example to a storage device 2618 or to a further processor 2620 (which may be implemented as part of processor 2612) to compile and run the generated code and to output the results, for example to a user interface 2624 or to a further storage device for the code output 2620. It will be clear to one skilled in the art that alternative or modified implementations may be provided and that aspects of the implementation described may be implemented in a single device or using a plurality of devices. For example, the storage devices 2614, 2618, 2620 may be implemented in a single storage device or across a number of storage devices and the processors 2612, 2622 may comprise a single processor or a network of processing devices.

For the purposes of illustration, there is set out below an example of how features of the system described herein, which may be referred to herein as the “JeeWiz system” or the “JeeWiz engine”, may be combined and implemented to create a complex transform. The example is not intended to be limiting in any way. It will be clear to one skilled in the art that features of the system described may be provided independently or in alternative combinations and modifications to the system described may be provided.

The Scenario

This example uses the ‘simple’ example from the J2EE set of examples. The starting point is the XML assembly file, representing the specification of a simple J2EE application:

| | |
|---|---|
| <application | name=“SimpleApp” |
| | > |
| <ejb-jar | name=“SimpleAppJar” |
| | uid=“SimpleAppJar” |
| | > |
| <entity | name=“Simple” |
| | uid=“Simple” |
| | > |
| <attribute | name=“name” |
| | uid=“name” |
| | required=“true” |
| | /> |
| </entity> | |
| </ejb-jar> | |
| </application> | |

This produces a J2EE/Java system when run using the J2EE meta-model stack. Where contrast between different meta-models is required, the examples use the .NET meta-model stack, producing a .NET/C# system.

Specification Read-In

In this step, the JeeWiz engine reads the specification from the ‘assembly’ directory, or the single ‘assembly file’, and converts it into memory-based Java Objects.

The configured meta-model stack for the J2EE build in this exposition is:

| | |
|---|---|
| resources\demo\control | |
| resources\jboss3\control | |
| resources\j2ee\control | the (physical) J2EE level |
| resources\screen\control | the (logical) screen level |
| resources\bizobject\control | the (logical) service level |
| resources\object\control | the (physical) Java language level |
| resources\base\control | the base. |

For specification read-in, the ‘demo’ and ‘jboss3’ levels can be ignored because they have no meta-model objects of their own—they add renderings only. The byte code for the meta-model object classes at each level are housed in the ‘components.jar’ file in the above directories. Furthermore, there are similar jars—jwcontrols.jar—in the above directories housing JeeWiz (generate-time) controls.

We use the term ‘high’ to mean how high up in this stack a particular meta-model is. In the above stack, the ‘demo’ meta-model is the highest; the ‘base’ meta-model is the lowest. There is a precedence relation implied by the position of the meta-model: it can alter the behaviour of lower meta-models in a variety of ways, but this behaviour can in turn be overridden by higher meta-models if required.

Creating the Root Model Object

The specification is an XML document, which means it has a root element, representing the top-most object in the specification tree. In the example specification, the root is ‘<application>’.

The root element is searched for based on:
the name—which is converted to class format (e.g. ‘Application’ rather than ‘application’)
using the ‘package’ names declared in the model.properties file for each level.

In the case above, the J2EE model.properties file declares its package as uk.co.nte.jw.components.j2ee, so the complete class name is uk.co.nte.jw.components.j2ee.Application.

In this case, this class exists. If it had not, the class would have been searched for at the screen level, then the bizobject level.

Specification Polymorphism.

The example of specification polymorphism provided below shows how the top level object can be changed to a different class depending on the configuration of the meta-models in the stack. To build a .NET system rather than a J2EE system, the meta-model stack would be

| | |
|---|---|
| resources\demo\control | |
| resources\jboss3\control | |
| resources\dotNet\control | the (physical) .NET level |
| resources\screen\control | the (logical) screen level |
| resources\bizobject\control | the (logical) service level |
| resources\cs\control | the (physical) C# language level |
| resources\base\control | the base. |

In this case, we have changed ‘j2ee’ to dotNet’ and ‘object’ (for Java) to ‘cs’ (for C#), but the other levels remain the same. The class for the <application> top-level object in the .NET system would be uk.co.nte.jw.components.dotNet.Application because the model.properties for the .NET meta-model declares its package as uk.co.nte.jw.components.dotNet.

In other words, the specification we have read in is the same, but the top-level object has been changed based on the configuration. This is the first aspect of this principle; other examples will follow. The implication is that both the structure of the underlying objects and the implementation code that can be part of the meta-model will change.

Setting Attributes

The ordering of the meta-models in the stack is important, because some of the features of the higher levels use features of the lower levels. This manifests itself when we set attributes.

The engine uses normal JavaBean conventions to invoke getters and setters on model objects to set attributes. So, the application's name=“SimpleApp” attribute results in a call to a ‘setName(String)’ method. However, this is not in the uk.co.nte.jw.components.j2ee.Application class itself. Instead, this meta-class extends from the uk.co.nte.jw.components.bizobject.Application meta-class; it is this class that has the ‘setName’ method.

Meta-Model Inheritance

The above was an example of meta-class inheritance. Meta-models are simply convenience groupings of meta-classes; the grouping is represented in the ‘components.jar’ file. In a sense, meta-models inherit if one or more of the meta-classes in a meta-model inherit from meta-classes in another meta-model. FIG. 25 is a schematic diagram showing inheriting meta-classes and meta-models, and gives a hint at the flexibility of JeeWiz meta-model inheritance.

The meaning of ‘meta-model inheritance’ is discussed in more detail below in relation to the rendering side of the system.

Creating Nested Elements

Many design systems are explicit about the (meta-model) origin of elements to be set. For example, XML Schema uses qualified names, which have a prefix indicating the XML Schema defining an element type. UML is even more verbose when represented in XMI.

JeeWiz does not require any indication of the origin of any nested elements to be set—such as <ejb-jar> in the example above—because the parent-child relationship is implied by XML nesting. The JeeWiz meta-modelling system has the ability to define lists of “child” meta-model objects on a parent. A list stores objects of a certain type and has a name: often these two are the same, so the nested element—whose XML tag indicates the name of the list—produces a model object from a meta-class of the same name. For example, the <ejb-jar> nested element leads to the creation of a model object of type EjbJar. Occasionally the name and the type on a list are not the same: this gives the meta-modeler the opportunity to create different model objects from the same tag names. An example of this is the concept of an element in XML Schema, where the <element> nested element has different properties depending on its location. The JeeWiz meta-model allows us to create a model object of the GlobalElement meta-class when the element is a direct child of a schema but of the Element meta-class in other situations (e.g. underneath a sequence).

From FIG. 25, it is important to note that, when the meta-model stack is used, applications can have Jars as nested elements as well as EjbJars and UiJars. This is a consequence of the Application meta-class inheritance.

In other words, we have shown how
different meta-classes can be created based on location
meta-classes can be called up from different meta-models
the structure can change depending on the meta-models in the stack configured for build.

The point is that JeeWiz can use very simple models—without any explicit indication of the meta-model origin of attributes or nested elements—that nevertheless invoke meta-model objects from complex and rich meta-models.

An analogy from biology may help here. ‘Stem cells’ are undifferentiated cells that are capable of changing into a range of specific cells—blood cells, sensory cells etc. The change is triggered and guided by the interaction with the environment. Similarly, the JeeWiz engine can absorb undifferentiated XML, which has the ability to turn into a range of specific meanings depending on the environment—which in this case is the stack of meta-models.

Overriding Model Objects

The Java type of the model object created for a nested element is normally predetermined by the meta-model of the containing element and the tag. This follows the well-known ‘Ant’ conventions for automatically mapping an XML tree to Java objects: the parent object has a method such as

public void addNestedTag( ObjectType o ) { . . . }

When the ‘nested-tag’ is seen, the JeeWiz engine introspects the parent object, finds the ‘addNestedTag( )’ method, and creates an instance of ‘ObjectType’ class to be the child model object.

The point is that the ‘ObjectType’ class is fixed in the meta-model.

However, to allow overriding of individual model object types, without having to construct a new parent, a class with the same class name (i.e. ObjectType) can be defined in an overriding meta-model. Even though this should have a different package name, JeeWiz will load this if the ‘auto-override’ flag is set on the meta-model definition of the meta-class. This feature is used on complex meta-models series, such as XML-Schema/WSDL/SpecialBinding, where the special binding will need to override some WSDL meta-classes.

XML Tag Conversions

Occasionally, it is useful to switch the XML tags to a more convenient name from an input design format to the names required for rendering. This is done by putting a

convert(oldname)=newname

in one of the per-build or per-meta-model configuration files (which are described next). For example, the <entity> XML element has its named switched in this example to ‘ejb-entity’. This is because the standard rendering of an entity in the J2EE model is to use entity EJBs. (This can be changed to use JDO entities, by a configuration override.) This feature is used later in the description of component.properties.
Pruning the XML Tree

In many situations, the input XML specification is richer than the rendering requires. For example, in XMI there is graphic information defining how the UML model is presented on the user interface; this can be discarded entirely. In the case of very large input XML documents, pruning the tree reduces the memory required to represent the XML as model objects, which means that larger models can be processed quickly in smaller machines.

JeeWiz provides features to prune of the input XML tree as part of the configuration. This uses a variant of the ‘convert( )’ feature described in the previous section.

To delete a complete sub-tree—a given XML element and all nested elements—the ‘*’ is used:

convert(Diagram)=*

discards graphic information from an XMI 1.1 document.

To delete one level, but preserve children (which then become children of the pruned node's parent) the ‘-’ is used. For example, the top-level <XMI> node, which is the root of the document, is not used in transforming XMI to the JeeWiz format, so that XML element is discarded:

convert(XMI)=−

Including Code as Character Data

In addition to XML elements and attributes, the specification can carry XML character data (typically as CDATA sections). This is used wherever free-form text is required—for example, descriptions are easier to put is as the CDATA of a <description> element than the other alternative, as the value of an attribute.

An important example of this is where the element represents a method or a class: in this case, the character data is used as code. For methods, it becomes the body of the method (with the signature being generated from the specification). For classes, it becomes additional code to be included within the body of the class. This may be an important feature in two situations. The first is in meta-modelling, where much of the implementation of meta-classes is generated from the meta-class specification . . . but an important part of the implementation is not. Putting code into these meta-classes means that the model objects that are in the meta-class will exhibit specific functionality.

The second situation where code is important is in patterns, where the code to implement the interaction between generated classes can be generated in the pattern. In other words, patterns don't just create more design: they can, and normally do, create full-fledged implementations.

Rich Logical Specifications

As more meta-models are added to a meta-model stack, the concepts expressed become higher-level (more abstract). Eventually, it becomes possible to express concepts and properties directly from the user's problem. The structure of adding meta-models allows an incremental approach to adding new groups of concepts; it turns out that in all domains where JeeWiz has been applied to date there is an inheritance relationship between the meta-models—even if they are different meta-models.

To create complex applications, it is important to have rich logical specifications. ‘Rich’ means a wide range of attributes and concepts, potentially drawn from across the range of meta-models. ‘Logical’ means that concepts that derive from the individual nature of a particular platform should not be used—but concepts that are, or could be, replicated in other platforms and are generally useful, should be specifiable. The difficulty is that these terms are relative, depending on the domain being modelled.

JeeWiz provides properties at the meta-model level to indicate whether meta-classes and their attributes should be present in the design tool. This allows local architects to define the level and range to be used in modelling, appropriate to the modelling domain and the skill of the modellers.

Multiple Specifications

In some situations, it is appropriate to have multiple specifications rather than just one. This is used in JeeWiz to build higher-level meta-models whose meta-classes inherit from meta-classes in other meta-models. It is also appropriate to define a complete development and deployment environment: the application is one type of specification, the deployment environment is another, but for a complete deployed solution both specifications should be used.

JeeWiz provides a feature to specify up to 10 additional specifications in a given build. This is recursive: the additional specifications can use additional specifications (as they do in a complete inheritance chain of meta-model specifications); there is no fixed maximum number of additional specifications. The additional specification is incorporated into the containing specification by creating a property of the root model object: the name of this property is defined by the containing specification's configuration; the value is a reference to the root model object of the additional specification.

Additional specifications are not rendered: they are present to make extra information available to the current rendering.

Model Manipulation

The read-in of the model from the XML file or files, to create the Java objects giving an internal representation, was described in the previous section.

Before creating the artifacts—the output files from the build, there is an intermediate stage where the model is manipulated in memory. The main content of this phase is pattern firing, although there are important aspects concerning validation and naming standards also incorporated into this stage.

A point discussed in more detail later is that the ‘meta-models’ do not simply define groups of meta-model classes: they also coordinate the rendering (how the model objects are turned into systems).

Finding Files

This section is a precursor to understanding details behind the present embodiment of model manipulation and the operation of templates, as described in the next major section.

Finding Per-Build Configuration Files

As the very first stage of a build, the per-build configuration files are read in. The main file is normally called build.jwp and is contained in the project directory; this drives the specific features for the project, although with defaults set by other files this file can be completely blank.

A typical line in the build.jwp file is

templateDir=${jwhome}/resources/demo/control

This defines the template directory, which is a term for the top-most meta-model.

Additional sources of per-build configuration are (a) the user's build.properties file (in his home directory)—this allows the user to take a new distribution of JeeWiz but impose his own overrides, for example which application server or database to use, and (b) the build.properties file in the bin directory of JeeWiz—this gives standard defaults from the JeeWiz distribution.

The properties defined in these configuration files define the model to be read in, the meta-model stack to be used (by specifying the top directory), and other configuration values to guide the build.

Variables in the Definition of the Meta-Model

The top-most meta-model of the stack is defined by the templateDir property, from one of the build properties files, such as buildjwp. ‘Parents’ of each model (i.e. the next level down) are defined in the ‘parent’ property in the model.properties file in each template directory. For example, in the demo/control directory, the model.properties has

parent=${jwhome}/resources/${appServer}/control

Variables (i.e. ${jwhome}, ${appServer}) should be allowed in the definition of the meta-model stack, for the following reasons:
the overall location of files is variable: ‘jwhome’ is the configuration variable for the JeeWiz home directory, so ${jwhome} is a variable reference. However, ‘${jwhome}/resources’ is effectively fixed relative to the JeeWiz distribution. This allows a user to reference locally-defined meta-models outside of the JeeWiz distribution, as well as standard JeeWiz meta-models.
in the standard meta-model stack for J2EE or .NET, there are two standard areas of variation: in the application server—.NET, or WebLogic6, JBoss3.2 or one of the other J2EE app servers. The use of ${appServer} in the ‘parent’ property allows substitution of the correct application server; the same applies to the ‘objectModel’ which is the name for the configuration property defining the language—it is typically ‘object’ for Java, or ‘cs’ for C#.

following a ‘parent’ chain allows the meta-model stack to be any length—and even in the same generic type of build (business application on a Web application server) there can be different levels. For example, the J2EE/.NET example above, the .NET stack would have 6 levels:

demo .NET screen bizobject cs base

while a WebLogic8 build would have 8:

demo weblogic8 weblogic7

j2ee screen bizobject object base

The ‘weblogic8’ and ‘.NET’ are placed in the chain by setting ${appServer}; similarly ‘cs’ and ‘object’ by setting ${objectModel}. The weblogic7 and j2ee meta-models are referenced from higher levels as constants.
The meta-models shown above are large and in some cases compositions of various sub-layers of technology: for example, the J2EE meta-model also includes renderings for Struts. In order to override parts of a large meta-model, the standard meta-models use another level of direction. Rather than fixing ‘parent’ in the model.properties, another variable is used—e.g. in the demo meta-model, ‘parent=${demoModelParent}’. While the demoModelParent will be defined to point to the application server's meta-model by default, it is possible to override ‘demoModelParent’ in the configuration. This would allow a sub-technology insert to be used, without altering the content of the existing meta-models.

These features help to ‘wrap up’ technology mappings in such a way that variations can be added as overrides in a highly modular way.

Finding Per-Meta-Model Properties Files

Before the model is read in, a further group of files are read in. These are the ‘system.properties’ files from the meta-model stack. These files are found in each ‘control’ directory in the stack; the composition of the stack is described in the previous subsection.

The system.properties files allow each meta-model to define default values that will guide the generation based on that meta-model; these default values are overridable by higher meta-models.

For example, the normal separator in a JNDI (Java Naming and Directory Interface) path specification is ‘.’. Therefore the J2EE model defines this default in the system.properties:

### The default JNDI separator is ‘.’. ...
jndiPathSeparator=.

The JBoss application server has a different approach: it uses the “/” character as the separator in JNDI paths. It therefore has the following in its system.properties file, which because the JBoss meta-model is higher than the J2EE meta-model takes precedence over the ‘.’ definition above:

#The default JNDI separator is ‘.’. We need to override it to be
’/
jndiPathSeparator=/

These properties are read once (before the specification is read in, although they are not used till later).

Finding Per-Model-Object Files

As the rendering proceeds, there are other files that are searched for each model object. JeeWiz uses a special lookup for these types of files, which has two dimensions to the search: the outer level of the search is driven per model object type; the inner level of the search follows the precedence order of the meta-models as shown described in the previous section.

JeeWiz originally used only a one-dimensional look-up for this type of file—without the outer, per-model-object type dimension. However, for some implementations, this may not be sufficient. In the same way that Java-based meta-model objects can inherit functionality from super-classes, so it is with renderings. However, there is an added complication in that the single-parent Java inheritance is not sufficient to express per-model-object renderings. We therefore need another mechanism, which is described here. This additional requirement, to mix-in additional functionality from outside of the Java inheritance chain, is used in a minority of cases. However, this seems to be a general pattern that is also observed in the JeeWiz meta-modelling generator: single inheritance may not be quite enough to fully express real world requirements. In what follows, long search chains are described. To reduce search times, all files found are cached, so the search process is only executed once for a given template file/model object type combination. This means that you should not let the length of the search path for template files deter you from using stacked meta-model directories. In practice, the length of this search chain does not make an appreciable difference in normal use of 10-30 directories in the two-dimensional meta-object class/meta-model search chain.

This search applies to renderings—pattern files and template files. The template directory chain starts with the top-most template directory as defined meta-model stack. It then follows the meta-model stack.

Within each meta-model, the file is looked for against a particular model object type, so we use a template directory name based on the xml-style name of the model object type—like ‘application’ or ‘ejb-jar’—below the model's control directory. The full path search for therefore is

$modelControlDirectory \ $elementXMLName \ $filename

The search process stops when it finds a file of the right name: any other files that may exist further down the chain are ignored.

For example, say we are processing an ‘application’ object in the build for the example. If we look for the build.xml file as part of the rendering, the paths searched will be

jeewiz\resources\demo\control\application\build.xml
jeewiz\resources\jboss3\control\application\build.xml
jeewiz\resources\j2ee\control\application\build.xml

and the file is found in the j2ee model—it produces the standard ‘application.xml’ required by J2EE. This shows how the ‘inner loop’ changes the meta-model directories that are searched in. In describing this search path,
jeewiz\resources\demo\control is the control directory for the ‘demo’ meta-model
jeewiz\resources\demo\control\application is the template directory for the application object in the demo meta-model
jeewiz\resources\jboss3\control is the control directory for the jboss3 meta-model
jeewiz\resources\jboss3\control\application is the template directory for the application object in the jboss3 meta-model
jeewiz\resources\j2ee\control is the control directory for the J2EE model
jeewiz\resources\j2ee\control\application is the template directory for the application object in the J2EE model

The search order described in the previous section can be altered by ‘diversion signs’ given in a template.properties file in the control directory of an object's rendering. This allows the search to be switched from one object's directory to another object's.

There are two types of lines that can be specified in the template.properties file:
Transfers unsatisfied file searches to the named template, but if the file is still not found, continues processing lines in the template.properties file.
The common scenario for using includes in a template.properties is one ‘include’ line followed by a ‘goto’ line.
   Include=[Template]
The include feature can be turned off for the current object type (or directed-to directory) by an ‘include=’ line in the template.properties file. Once a ‘goto=’ is encountered, includes will be honoured again. For example, some EJB features are added in by an ‘include=ejb’ entry, which is used by session, entity and message-driven model objects. These occur (in current implementations) in the template.properties files in the session, message-driven and ejb-entity directories in the J2EE meta-model. When EJBs are not to be used (but servlets are), an ‘include=’ line can be inserted in the template.properties file in a ‘higher’ meta-model to prevent inclusion of the EJB features. For example, in a customer's meta-model, you could add a ‘session\template.properties’ with the ‘include=’ line. This would turn off the ejb features for the session object only.
   Goto=[Template]
Transfers unsatisfied file searches to the named template. This will be the last line processed in the template.properties file. For example, there is commonality between business-methods and methods. In some cases, the business-method provides a template; in other cases, the template may be the same between business-method and method. If an unsatisfied search is switched from the business-method to the method object, then the method object's templates can be re-used.

The ‘goto’ and ‘include’ diversion signs operate on any template or pattern rendering file, including the special file ‘component.properties’. What it says to the generator is: “if you haven't find the file you are searching for after this directory, start the search afresh using this new model object”.

The ‘attribute’ meta-class extends (in the Java sense) from the ‘field’ meta-class: the field is the simple Java data-holder in a class, whereas the attribute has additional connotations of creating getters and setters, persistence, whether or not it is a key in the database—there are over 20 additional properties. There is a template.properties file with ‘goto=field’ in it in the business object meta-model for the attribute; there is also the first occurrence of the includeSpec.vm (main pattern file) in the business object's field directory. This means that the list of files checked for existence to fire the main pattern on the attribute is:

jeewiz\resources\demo\control\attribute\includeSpec.vm
jeewiz\resources\jboss3\control\attribute\includeSpec.vm
jeewiz\resources\j2ee\control\attribute\includeSpec.vm
jeewiz\resources\screen\control\attribute\includeSpec.vm
jeewiz\resources\bizobject\control\attribute\includeSpec.vm (T)
jeewiz\resources\demo\control\field\includeSpec.vm
jeewiz\resources\jboss3\control\field\includeSpec.vm
jeewiz\resources\j2ee\control\field\includeSpec.vm
jeewiz\resources\screen\control\field\includeSpec.vm
jeewiz\resources\bizobject\control\field\includeSpec.vm

After checking for includeSpec.vm in the bizobject attribute level, the engine encounters the template.properties file with ‘goto=field’. Therefore, the second “outer” loop starts looking down the meta-model stack—from the top-most ‘demo’ meta-model—this time in the ‘field’ directory.

The inheritance is completely under the meta-modeller's control. This makes it possible—but stupid to implement rendering inheritance completely divorced from the Java inheritance.

We give an example of the ‘include=’ style of redirection in template.properties below.

Rendering Polymorphism

The preceding techniques for searching for the various types of files give a fine-grained way of altering the generated code in an organised way: the organisation is driven by the meta-model stack and the types of objects being rendered. The level of granularity afforded by the searching techniques is at the rendering file level. However, the next section and further items will show how the level of granularity can go down to the word level.

In the first section, we noted the concept of ‘specification polymorphism’—the same specification could result in a different run-time representation for different meta-model configurations. The lookup features are the basis for ‘rendering polymorphism’: the same specification can result in different renderings being invoked for different meta-model configurations—and in fact for the same run-time specifications.

Component.properties—Naming Conventions

Most companies have development standards that cover the naming of variables etc. in programs, the names of files, the structure and naming of directories—and even the layout of code.

JeeWiz uses the ‘component.properties’ feature to allow rapid changes of these standards. It does this by attaching names to the model objects, via a per-model-object HashMap, that can be used in renderings; these then appear as additional properties on the model object. The values for the properties can be functions combining literals, pre-existing names, values in the object or its parent tree, or calculations on the object itself. To change the naming convention, an architect only needs to change the calculation of the name, not the renderings. As the names are typically used many times in the renderings, this approach—for the cost of one level of indirection—makes it easier to maintain the renderings, which are the more complex part of a system.

This feature uses the component.properties files in a particular way, because additional properties must be individually added as we go ‘up’ the meta-model stack—rather than just overriding whole files, as described in the previous section.

In common with Java properties files, JeeWiz component.properties files have a number of lines of the form

property_name = property_value

JeeWiz adds the additional feature to substitute values. The simplest format uses ‘${p}’, where ‘p’ is the name of an existing property, or a getter on a model object. There is also the ability to reference properties on specific object ‘o’, using the ‘${o.p}’ syntax.

Declaration order is observed. This means that references to properties set in previous lines of the same component.properties file are specifically allowed and will be evaluated as expected. This is noteworthy because Java properties are evaluated in random order, which can lead to unexpected results. Because order is observed, you can set a property based on some calculation, and then later on use that value in another property-setting calculation. For example, the system.properties file for the J2EE model uses sequences like

specDir=${assemblyDir}
source=${specDir}/src

In this example, the use of specDir in the second line depends on its being set beforehand—this is why order is important. There are often 10 or 20 such interdependencies in the complete set of properties for a model object.

The values are always set on the current model object, even though substitution values may come from a parent model object. This means that it is possible to re-use names that have been set by a parent, which can be useful in naming conventions that define ‘container’ directories. For example, node N provides a ‘$containerDirectory’ directory string to its children. Its child node C uses the provided ‘$containerDirectory’ value to set its own container directory property:

containerDirectory=${containerDirectory}/${name}Build

This is a recursive structure (any number of layers are possible) and it allows lower objects to build their own components without knowledge of how they are going to be used. This approach is used in the J2EE rendering to build applications based on a passed-in ‘$buildContainerDir’, which then resets the value for use by the contained Jars. This technique means that the applications be further contained as part of larger builds which can use the same technique, without disturbing the application or Jar builds.

Property value references of the ${p} form are searched for in a number of ways:
first, as a JavaBean getter (public getP( ) method) on the current object. This encompasses both attributes read in from the specification and hand-crafted Java get( ) methods that are placed in the meta-class's specification.
second, as additional properties attached to the model object—which can be created either by previous lines in the component.properties feature as described above, or by the preIncludeSpec.vm which is described later
third, a recursive examination of the object's parents in the specification. For example, if the component.properties feature is run on the attribute but the property is not found there, then the entity, ejb-jar and application will be examined in that order using the two steps described previously
fourth, values set from the per-build properties (buildjwp, user build.properties and jeewiz\bin\build.properties)
finally, values set from the per-meta-model ‘system.properties’ files.

The properties that are set are the aggregate of all component.properties files found in all files defined by the ‘per-model-object files’ as described above. In other words, rather than finding the first file and using that (as renderings do), the component.properties feature walks all model object types, following the template.properties directions, and within that searches down the meta-model stack for component.properties files.

Following this approach, the complete list of component.properties files used for an entity is the component.properties files from the following meta-model and meta-model types:

| | |
|---|---|
| j2ee | ejb-entity |
| j2ee | ejb |
| bizobject | entity |
| bizobject | business-object |
| bizobject | internal-class |
| object | jwclass |
| object | interface |

The j2ee/ejb component.properties file is found by an ‘include= . . . ’ line in the template.properties of the j2ee/ejb-entity. Then the entity, business-object, internal-class, jwclass and interface following the rendering inheritance stack via goto=lines in various template.properties files.

The algorithm for aggregating the various lines of the component.properties, to support overridability but also preserve the inter-line order described above, is:
1. Take each line in order from the lowest-precedence component.properties file. In this example, that is object/interface. The first line in this file becomes the first line in this evaluation.
2. Then take exam each line in order from the next-higher-precedence component.properties file. This means the next file is object/jwclass, followed by bizojbect/internal-class etc.
3. If the property name of a line in step 2 has not been used in this component.properties, add it to the end of the ordered list for evaluation.
If the property name of a line in step 2 has been used in this component.properties algorithm, the override the value calculation from the new value, but preserve the order of the property evaluation established by the lower-precedence file.

For example, the first three lines in the object/interface component.properties—and therefore the first three properties evaluated for an entity model object—are

classNameToGenerate=${name}
targetDir=${genSourceDir}
outputFilePath=${targetDir}${packagePathPlusSlash}/
${classNameToGenerate}.java

However, the classNameToGenerate is overridden by the bizobject/internal-class with

classNameToGenerate=${name}Base

This overrides the value to be calculated for classNameToGenerate—but does not affect the order of evaluation. This overriding therefore means the final evaluation starts off like this:

classNameToGenerate=${name}Base
targetDir=${genSourceDir}
outputFilePath=${targetDir}${packagePathPlusSlash}/
${classNameToGenerate}.java

The overriding of the classNameToGenerate alters the final ‘outputFilePath’ value—but not the calculation performed. This means that interconnected sequences of properties can be defined by a given meta-model/model object type, but that parts of this can be overridden by higher levels without affecting the sequence. The usual way of using this facility is to override non-dependent values in higher meta-model/model object types (i.e. values that are not dependent on previous component.properties lines) and leave the calculation of dependent properties unchanged, and so determined by the original definition.

There are limitations to the power of the component.properties feature: conditional logic (if/else) is not possible. In cases where more powerful control of names is required, the preIncludeSpec (or possibly extraIncludeSpec) pattern must be used. These give unrestricted calculation capabilities.

Patterns—Mechanics

In JeeWiz, a pattern is a type of rendering that produces—rather than output files—more specification as illustrated schematically in FIG. 20.

A pattern is always run for a particular model object. The output of a pattern must be an XML document, whose root element is either ‘<this>’—so the current model object is targeted—or ‘<parent>’, where the parent of the current model object is targeted. This document is merged into the existing model at the point of the root element, by altering the targeted model object.

Patterns are triggered by the existence of three specific rendering files; these files are found on a per-model-object basis, as described in the section “Finding Per-Model-Object Files” above. The names of these files, and their usage, are as follows:

| | |
|---|---|
| includeSpec.vm | The includeSpec.vm is the main pattern file. This |
| | will typically create additional objects that are |
| | mostly based on the existence the model object |
| | ‘firing’ the pattern. These may be in the same |
| | tier, or cross-tier projections of the object. |
| preIncludeSpec.vm | The preIncludeSpec.vm is used to ‘fix’ up |
| | the current model object, before other processing |
| | on the model object occurs. |
| extraIncludeSpec.vm | The extraIncludeSpec.vm is used to ‘fix’ up |
| | the environment surrounding the current |
| | model object. |

Patterns share their rendering engine with templates (which produce output files)—they use Velocity, they can access the pattern or template files using the per-model-object file lookup scheme, and they can read and write the current model object directly, and other areas of the model object tree (the in-memory representation of the specification) indirectly. Here is an extra of the preIncludeSpec for an attribute (from the file jeewiz\resources\bizobject\control\attribute\preIncludeSpec.vm, which is part of the business-object (bizobject) meta-model):

```
#if( $name )
        <this
                            access=“private”
    #if ( !$dbmsColumn && $parent.isSQLReservedWord($name) )
                            dbmsColumn=“${name}_J”
    #elseif ( !$dbmsColumn )
                            dbmsColumn=“${name}”
    #end
    #set( $wrapType = $lang.getPrimitiveWrapperClass($type) )
                            type=“$wrapType”
                            />
#end
```

This uses the Velocity scripting language to express the meta-program for this pattern. In English, it reads:
If the name of the current object has been specified (otherwise, a validation error occurs later)
   Set the attribute's ‘access’ to private (because public getters and setters are generated)
   If the ‘dbmsColumn’ has not been specified and the name is a SQL reserved word
      set the dbmsColumn to the attribute's name, suffixed by ‘_J’
   otherwise it the dbmsColumn has not been specified
      set the dbmsColumn to the attribute's name (with no suffix)
   Adjust the type to the wrapped type for a primitive type.
   This promotes ‘int’ to ‘Integer’ in Java or to ‘Int32’ in C#.

The resulting text for the name attribute would be

| | |
|---|---|
| <this | |
| | access=“private” |
| | dbms-column=“name” |
| | name=“name” |
| | type=“String” |
| /> | |

When this is ‘read in’ again, the effect is to set the appropriate properties on the ‘name’ attribute, which fixes it up to adhere to the rules inherent in the pattern.

Creating New Objects

The previous example merely amended an existing object; it is also possible to create one or more objects. This is done by nesting elements within the root node. For example, there is a pattern on an entity, as part of its database mapping, to create a primary key if one does not already exist.

| | |
|---|---|
| #if( $keys.size( ) == 0 ) | |
| <this> | |
| <attribute | name=“oid” |
| | autokey=“true” |
| | type=“Integer” |
| | /> |
| </this> | |
| $this.reset( ) | |
| #end | |

In English this pattern reads:
If this entity has no keys (i.e. attributes that go to make up the primary key)
   Underneath this object (which is the entity)
      Create an attribute of name ‘oid’, as an auto-incrementing Integer

This new field becomes a child model object on the entity—just like other attributes.

Locating New Objects

Newly-created objects are by default positioned underneath the current model object if <this> is the root of the generated XML and underneath the parent model object if <parent> is the root.

Sometimes, this is not adequate. For example, if a new <page> has been created from a session bean method, in J2EE this belongs in the UI jar, not the ejb-jar containing the session. This is neither the current object nor the parent of the session bean, or even the session, so the default <this> or <parent> model objects are not the correct location for the new object.

To address this situation, the location of the new object can be explicitly set. This is done by executing the ‘setPatternRootElement($location)’ method on the current object during execution of the pattern. For example, if $uiJar is a reference to the model object for the jar containing UI elements, we can place a new page in the uiJar in the following way:

```
#if( $keys.size( ) == 0 )
            <this>
                <page  name=“${name}Page” ... />
            </this>
    $this.setPatternRootElement( $uiJar )
#end
```

This feature is important to ‘cross-tier’ patterns, which project an object in one tier into related objects in another tier, when the other tier is represented by a different branch of the model object tree.

Multi-Stage Patterns

Sometimes it is convenient to express a complex pattern in stages. For example, in the J2EE system for entity EJBs, we create a boilerplate ejbCreate method that takes a value object. But then, the ejbCreate methods are handled specially in the entity EJB patterns. So it makes sense to use two stages to the pattern: first, create the ejbCreate; then, do the pattern that will further process this.

This is an example driven by modularity, and so is a design choice rather than being a necessity. But there are situations where a multi-stage pattern is necessary in the present implementation:
when the objects to be created have different parents
when the operation of a later stage depends on the existence of an object created in an earlier stage, or on a value defined in an earlier pattern stage.

This is done using the ‘next-pattern’ property on the current object—the first-stage pattern sets this to the name of the file to be used for the next stage of the pattern. JeeWiz then recognises this immediately after processing the previous pattern, and runs the next pattern. This is a ‘one-shot’ attribute: it is reset before the next pattern is run. However, the next-pattern attribute can be set in a next-pattern too, so there can be any number of stages in a pattern.

Any objects created in this step are processed once the complete pattern file has been read (i.e. Velocity #parse's)—in other words, the specification is read in, new objects are created. If there are next-pattern phases, the model is actioned immediately, before the next pattern.

The next-pattern property on the current object can be set in two ways: as a pattern or as a method call. The following example shows both:

<this nextPattern=“includeSpec2.vm”
/>
#set( $this.nextPattern = “includeSpec2.vm” )

Patterns—Usage

The previous subsection dealt with the mechanics of how patterns work. This section draws out some of the implications of the use of patterns within the overall framework of JeeWiz.

Predictive Assumptions and Overriding

The above examples assume a certain style of working and predict what the modeler would like to result from an incomplete specification.

In other words, the patterns make ‘predictive assumptions’.

This allows a continuum of development styles. In the early stages, a RAD (Rapid Application Development) approach—where fast specify/generate/evaluate cycles can be used to get early customer feedback—can be used, relying on predictive assumptions. As development proceeds, more detail can be added to the specification to adapt the generated system to the target environment.

In some environments, architects will need to change these predictive assumptions or turn them off entirely. This is easily done by overriding the pattern in question, by placing a file in the highest meta-model in the same relative location as the pattern to be overridden; for example, the attribute pattern above—in jeewiz\resources\bizobject\control\attribute\preIncludeSpec.vm—can be overridden in the demo meta-model by creating jeewiz\resources\demo\control\attribute\preIncludeSpec.vm. Patterns can create no XML (i.e. the result of the rendering is whitespace only or blank), in which case the pattern is ignored; this effectively turns off a pattern.

Creating Code

Specifications can include code as character data within classes or methods—although this feature is rarely used in original specifications.

However, as patterns create additional specification XML, this feature is also available in patterns, where it is crucial to delivering integrated pattern renderings. This is in contrast with the design-tool approach to patterns, which creates additional design objects but without implementation code.

This is a powerful feature of JeeWiz patterns because the implementation of almost all model objects created by patterns can be automatically generated: the fact that a related object is generated by a pattern means that its connection to the original object—expressed in its implementation code—can be generated by the same pattern. Only business logic, in service methods and some page events, needs to be written by hand.

Recursion and Dilation Factors

The process finding a pattern and creating a new object is recursive: the new object can itself fire patterns. The <attribute> created by the example in the previous section will fire the attribute's patterns, including the one in the last section but one.

Patterns can amplify the input XML to the finally resolved XML quite significantly. The dilation factor—the ratio of the sizes of the input XML to the final XML after all patterns have fired—can be very high. Dilation factors of 25:1 are typical, and in RAD situations can be much higher.

Declarative Meta-Programming

By ‘meta-programming’, we mean write programs that generate systems: in this sense, the JeeWiz engine is a meta-programming system. Most meta-programming tools for creating large-scale business frameworks use a scripting language, with normal functional language features, such as if/then/else. This aspect of JeeWiz is provided by Velocity, which is used in renderings.

However, the ability of a pattern-writer to create other objects via patterns gives a declarative aspect to JeeWiz meta-programming. Creating a logical object—like a ‘page’—will result in different knock-on effects depending on the environment. The page could result in a Struts implementation, or a servlet/JSP implementation in J2EE, an ASP.NET implementation in .NET, and so on. The details of the knock-on effects need not concern the writer of the original pattern; they are the concern of the writer of the pattern to generate the artifacts for the page.

This facility operates at multiple levels. The ‘page’ example uses a logical object from the screen meta-model. Some parts of the architecture generate classes or interfaces—model objects from the ‘object’ layer. It is still useful to implement these as patterns (i.e. declaratively) rather than implementing them as renderings. Partly this is so the class and interface renderings can be re-used; but it also offers the ability to switch the generated classes between equivalent languages, for example from Java to C#.

Single-Step Generation

A consequence of JeeWiz's ability to create code and rich architectural frameworks from patterns is that JeeWiz is best operated in a single-step generation when generating output files from a given input specification.

This contrasts with the approach that creates more physical design representations (more platform-specific models) from more logical designs (platform-independent models), with manual fix-ups of intermediate models. This approach is easier to meta-program, because the conceptual distance between the steps is smaller. However, manual fix-ups introduce the opportunity for a designer to alter the intention of the original designer—which is often a mistake. Because the JeeWiz approach can bridge conceptual distances from specification to generated system of any size, there is no need for the intermediate step.
This is not to say that multiple JeeWiz steps are never used—they are. Pipelines of JeeWiz transforms are commonly used. For example, JeeWiz transforms XMI into native JeeWiz XML, according to the meta-model stack, in one transform; then builds application systems in another transform. The same applies to Web Services: these are converted into native JeeWiz XML in a (different) preparatory transform. However, the point is that the ‘specification-massaging’ transform and the system-generating transform are both completely automated, and therefore the combination can be automated too.
   Coordination of Model Manipulation

JeeWiz implements model manipulation in a series of steps. These steps integrate validation, naming conventions, patterns and other aspects.

The order of these steps and their usage is based on experience of creating very complex enterprise-level renderings. In particular, the framework for model manipulation handles creation of a related architectural tier in both directions:
from the depended-on object (e.g. entity) to the dependent object (e.g. data-view, which depends on the entity during validation)
from the dependent object to the depended-on object, which is much more difficult: we must avoid the situation where the dependent object validates or uses the depended-on object before the pattern has created it!
   Preparation Phase

The preparation phase is to do with validation, fix-ups and reordering to before the main pattern phase.
1. First, the current object's children are reordered if necessary. The order of the children is important because it is also the order that patterns are fired.
   It is necessary to reorder the children so that the pattern processing and validation is done in the correct order, when there are inter-model object dependencies. For example, the order of the types of children below a jar in the Business Object model is: general classes; internal-classes; business objects; entities; relations; data-views; data-view-relations; sessions.
   This is the ‘correct’ order so that patterns are fired and validation done on depended-on objects first. For example, entity objects come before the relations, because relation ends (R/end in the example below) reference entities (E1 and E2 are named in the ends)—in other words, relations depend on entities. Similarly, data-views are also dependent on entities in the standard architecture, because data-views can be ‘backed by’ entities (as shown in the ElDataView's ‘initial-entity’ attribute): there is a reference in the data-view to the entity. The re-ordering allows a data-view to create an entity during its pattern processing.

In the XML specification, these references between dependent and depended-on objects are specified by the name of the depended-on object, but this is converted to a Java object reference during the main validation. If the depended-on object is not present, the validation fails. The following specification shows the model objects in the ‘correct’ order.

| | |
|---|---|
| <jar | name=“J”> |
| <entity | name=“E1”/> |
| <entity | name=“E2”/> |
| <relation | name=“R”> |
| <end | entity=“E1”/> |
| <end | entity=“E2”/> |
| </> | |
| <data-view | name=“E1DataView” |
| | initial-entity=“E1” |
| | /> |
| </jar> | |

Children are added to various model objects, such as the <jar>, during pattern processing. The order of the children is not adjusted immediately, as every object is added. The ordering described is done at this point in the pre-phase and also at the start of the main phase. Models that are added during pattern firing are added at the end of the parent object's child list, and the model manipulation processing described in this section is done for new objects in the order they are created.
The relative order of model objects is defined in the meta-model by overriding the getPositionWithinParent( ) method for the object, which by default returns 0. These references should be computed and validated in the meta-model, not in the rendering. The children of ‘jar’ in the business-object model order themselves as follows: normal classes and interfaces return 0 from getPositionWithinParent( ); internal-class returns 10; business-object returns 20; entity returns 30; data-view returns 40; and so on.
2. If there is a ‘preIncludeSpec.vm’ script for the object, this is invoked as a pattern (i.e. the property is interpreted as the name of a script, it is processed through Velocity and the output is interpreted as more specification). The preIncludeSpec.vm file is looked up as described in “Finding Per-Model-Object Files”.
   preIncludeSpec patterns are primarily intended for adjusting various properties on the current object only, as shown in the business object attribute example discussed above. Properties set in the preIncludeSpec can be used as the basis for derived names in the component.properties—which is the next step. Therefore, the preIncludeSpec is the only rendering where a model object's derived names are not available.
   The use of patterns at this point is part of the ‘predictive assumption’ capability of JeeWiz, to create missing values based on intelligent assumptions. The meta-modelling system has the ability to specify defaults for properties in a number of ways, but preIncludeSpec patterns are an efficient way to express these intelligent decisions because they can easily take into account aspects of the environment and use functional programming techniques.
3. ‘Pre-phase’ meta-model validators are checked, to ensure that the model object information is correct. This is typically confined to the object and its ancestors, because related objects may not exist yet—they may be created by the extraIncludeSpec patterns.
4. The model object's preInitialiseComponent( ) method is called. This is an opportunity for the model object to further validate and digest its own information. This step can also return validation errors. Further steps are gated by the validation of the object and its children being successful; if errors have been detected by the validator or preInitialiseComponents for this object's sub-tree, the remaining steps in the model manipulation are not done. This means that the remaining steps can assume that the object is valid and therefore not code defensively to protect itself against invalid specifications.
5. Component properties are set, as described in the “component.properties” section above. The derived properties are set on the model object, and can use attributes resulting from the actions of steps 2, 3 and 4 above—as well as the specified data itself.
6. The children of the current model object are processed, in the order of creation as adjusted by step 1, for their respective preparation phases. Note that this imposes a top-down order up to this point; the extraIncludeSpec step follows this one, so that is effectively a bottom-up approach.
   The original children may have created peer model objects—they are new children of the current object. According to the conventions recommended here, the new children will be created by the extraIncludeSpec phase, described next. They could also have been created by the preIncludeSpec, described above.
   Because the children of a model object are processed left-to-right, it turns out that new children are caught by the left-to-right sweep. This means that all the original child objects first get processed first, followed by any new children. This is so, even if a child creates a new peer—as may happen. For example, a data-view could create a peer entity object during the preparation phase: both are children of the jar, so the entity will automatically get included in this step.
7. If there is an ‘extraIncludeSpec.vm’ script for the object, this is invoked as a pattern (i.e. the property is interpreted as the name of a script, it is processed through Velocity and the output is interpreted as more specification).
   The original children may have created peer model objects—they are new children of the current object. According to the conventions recommended here, the new children will be created by the extraIncludeSpec phase, described next. They could also have been created by the preIncludeSpec, described above
   The extraIncludeSpec feature addresses a very specific situation—creating an object on which the creator depends in a pattern, such as a data-view creating an entity. Any objects created in this pattern are processed in the same way as other objects, immediately initiating the preparation phase for the new objects, before continuing with previously-defined objects.
      The Main Pattern Phase

The main pattern phase checks inter-model object dependencies and creates additional objects by running patterns. This is where the bulk of the pattern firing happens.

Whereas the preparation phase operates top-down, the main pattern phase operates bottom-up, left-to-right. For example, if we consider the tree surrounding a method in a J2EE build, we will process
parameter constraints for a given parameter
each parameter
the method holding the parameters (and its peers, like fields/attributes)
the class—e.g. the session (and its peers, like data-views and entity objects)
the ejb-jar and its peers
finally, the application itself.

At each model object, the pattern phase does the following:
1. First, the current object's children are reordered if necessary—exactly the same as is done as the first step in the preparation phase. This reordering catches any objects created during the preparation phase and ensures they are correctly ordered.
2. Then the children are processed (using this main phase), working left-to-right. This causes the bottom-up firing of patterns in the main phase, because the children are processing before firing the main pattern in the step 5.
3. Meta-model validators, of the non-‘pre-phase’ variety, are checked. These validators should check references to other model objects. For example, if a reference to another object is required, the validation expression will be something like ‘getOtherObject( )!=null’.
4. The meta-model object's initialiseComponent( ) method, if present, will be called.
   As with preInitialiseComponent, the intent of initialiseComponent( ) is to do more complex validations and preparations than are possible using the validator expressions—this time, ones that reference other model objects.
5. The includeSpec.vm script—the main pattern—is processed by Velocity and the resulting output interpreted as more specification. This is where the bulk of pattern-firing occurs, to ‘implement’ the object.
   JeeWiz Controls (Generate-Time Controls)

JeeWiz controls, also referred to as ‘generate-time controls’—or just ‘controls’ where the context is clear, are Java objects outside of the model object tree representing the specification that generate text that is to merged into a rendering (either pattern or template) via the Velocity substitution mechanism.

The main benefit of JeeWiz controls is to separate the concerns of rendering from (a) the detailed minutiae of the generated code and (b) changes for local configuration. By using JeeWiz controls, the meta-programmer can create renderings, templates in particular, that can be used unchanged on different platforms and configurations.

An important implication of this approach is that renderings can be used in environments not anticipated by the meta-programmer: a new environment can define or configure the JeeWiz controls used in the renderings without changing the rendering, thereby adapting the rendering to the new environment.

A subsidiary benefit of JeeWiz controls is that they factor out common sequences of logic; these can be referenced as properties of the control from the rendering, thereby reducing the total volume of meta-program code to be written.

Using Controls

To initialise a variable to a ‘nothing’ value, the code for an object reference will be

$type $name = null;

or, for a boolean:

$type $name = false;

JeeWiz controls allow the meta-programmer to generate the variability here—‘null’ or ‘false’, or ‘0’ for integers—without resorting to the Velocity #if statement. This is done by accessing a property (or method) of a control—using standard Velocity syntax—which returns the appropriate value for inclusion in the rendering. If the control is referenced in the Velocity variable $jwc, the generalised code for the above sequence would be:

$type $name = $jwc.nullValue;

This example uses a simple property of the datatype control that produces a string-valued result for substitution into the generated text. There are richer and more complex properties available on the datatype control, examples of which are given below:
returning values for use in the meta-program: convertStringToInternalTypeThrowsException returns true if converting a string value to an internal type causes an exception. This will be false for Java's String, and also Java's Boolean, which does not throw an exception even if the input value is unrecognisable. In situations where this value is true, the meta-programmer must catch and handle exceptions in the code to convert an external (string) value to an internal format.
using parameters: convertStringToInternalType generates the run-time code to take a string parameter and return the internal type of the control. The string parameter must be passed in to the method.
holding state. Datatype controls do not hold state—they are the simplest type of control. However, other types of controls do. For example, within the language control there are various types of collection controls. These hold the variable name for the collection so that an iterator-generating method (‘foreach’) can incorporate the collection variable in the generated code.
   Composite Controls

A composite control is where one control depends on a reference to another. All but the simplest types of controls are composite.

For example, a UI control holds the datatype of the value being rendered, in order that the UI control itself can make checks on the datatype values during processing, or to create text substitution values that incorporate some of the datatype's text substitution properties.

Note that we use this term when control depends on another. In other words, this is not just a piece of state that may be present. Database map a datatype with a certain style to a database regime (database product plus local variations): the presence of a datatype is central to the meaning of the database control. Similarly, some UI controls present a particular face for a datatype: again, these are meaningless without the datatype. Composite controls can also hold an array of children, which gives the ability to build up containers (in the same way that windowing systems do, except that these are present at generate-time).

This is another area where JeeWiz provides object-oriented facilities to system generation. Composition of diverse types of objects in a tree is a well-known technique in object-oriented systems; providing them in the scripting environment to generate text or control meta-programs in a system generator is novel. This level of requirement only becomes apparent when large-scale, complex meta-programs are implemented. Building presentation instructions at generate-time rather than run-time has some inherent advantages in the JeeWiz environment:
The implementation can be layered: presentation aspects can be implemented separately from the mapping to the target platform, which can be separate from datatype representations. This gives the ability to reuse the different layers when building different target systems, using the stack of meta-models approach. A typical scenario for re-use of layers is to have one level of control from a lower-level (‘physical’) meta-model provide controls that wrap the available platform technology, and a higher-level (‘logical’) meta-model provide controls that add higher-level value by using the lower-level controls.
By the same token, it is realistic to retarget to different platforms, by switching the physical-level controls.
The code to generate complete pages can be automatically generated
It is possible to be smarter about layout and representation because the totality of what is being represented, and what is surrounding it, is known at build time—it comes from the structure of the model. In contrast, object-oriented windowing systems must have very general code which either becomes highly complex of sub-optimal in representing special case.
   Application Areas

JeeWiz provides a number of pre-constructed types of controls:
Language The overall structure of the class and method signatures is handled by the renderings at the language meta-model level (‘object’ for Java, or cs for C#). However, meta-programs still need information about types, primitive-to-wrapper type manipulations, and even the names of libraries and methods on standard objects types. For example, the length of a string is different between Java and C#. ‘${lang.String.length}’ returns ‘Length’ in C#—this is a String property—but ‘length( )’ in Java, which is a method on String.
Logging Logging controls are provided as default for output to the console—the default output device, or in Java via log4J. The logging control facility provides the capability to change the type of logging control at different points in the model object tree: this is why a control object is necessary; simple renderings will not do.
   This feature is necessary in the .NET environment, where there is no console available from UI programs. The logging controls can handle this by instantiating a different logging control for server-code assemblies and UI code assemblies. Using the delegating property approach, the meta-programs to create methods and classes do not need to know which logging control will be picked up—the correct control will be found as a delegated property.
Datatype These are the fundamental datatypes of the languages, and their usage in the meta-programs. There is some overlap with the language control.
Database Database controls are used to adapt an input datatype to the requirements of the target database product and local environment. This covers the type actually used on the database and the representation of common types in a local environment, for example, representing Java boolean datatypes as a character with ‘Y’ or ‘N’. This typically affects the SQL generated in data-views or BMP entities.
UI UI controls generate presentation ‘faces’ for a particular datatype. For example, a Textbox ‘face’ represents a textbox in a UI environment; the TextboxDate control represents a Date value in a textbox, whereas the DMYDate control represents a Date value using drop-down lists for the ‘D’, ‘M’ and ‘Y’ values.
   Control Management

The objects for JeeWiz controls are not specification model objects—but they share a number of implementation features.

Meta-Model

JeeWiz model objects and controls are both defined in a meta-model. Controls have a restricted structure, because there are only two types of meta-classes:
Control type—‘datatype’, ‘database’, ‘UI’ etc.
The individual controls—‘String datatype’, ‘UI TextboxString’, which must belong to a defined data type.

Controls are in fact a sub-meta-class of the Java (‘object’) ‘jwclass’ meta-class—because they produce Java classes. Key features of object-oriented design, such as Java-style inheritance and overriding are supported. As usual, implementation code for the controls can be inserted directly into the meta-class specification; but—as usual—some special features for controls are implemented by control-specific renderings.

To allow controls from different sources to be combined, controls of different types can have the same names; it is only within a given control type that names are unique.

Component.properties—Naming Conventions

The individual controls and control type objects, on instantiation, implement the naming conventions (via component.properties) described previously. This means that extra properties can be defined in component.properties files. These follow the approach to looking up files and aggregating properties described in the earlier section on component.properties.

The lookup of the component.properties for model objects varies the meta-model and the object type name. This is also the case for component.properties for controls, but to allow multiple controls with the same name another directory level, for the control type, is added. For example, the location of these files for a particular meta-model and control lookup name could be:

$modelControlDirectory \ jwcontrol \ <controlType> \
$controlLookupName

Note that on any given lookup, there are still only two dimensions to the lookup—the model stack and within that the control name—because for any given control instance, the <controlType> is fixed.

The component.properties files for control type objects could be looked up in a directory such as

$modelControlDirectory \ jwcontrol \ $controlType

Inheritance

Controls inherit and override in a number of dimensions:
Control types can inherit, using Java inheritance. For example, a GridUIControlType could inherit from a ContainerUIControlType, which could inherit from a UIControl.
Similarly controls can inherit using Java inheritance. For example, a very common approach is to implement an abstract base control for a control type that gives default or null implementations for the controls; ‘first-line’ instances can the inherit from the base control, and therefore only need to implement methods that must differ from the base implementation.
Control types and controls automatically override objects of the same name in lower meta-model objects. This is a slight difference from model objects, where the ‘auto-override’ flag has to be set to trigger automatic the overriding. For control types and controls, there is no option: if a control type or control is defined in both a higher-level and lower-level meta-model, the one from the higher-level meta-model will prevail.
This gives effective overriding of controls at the Java level.
Rendering inheritance follows the same overall approach as rendering inheritance for model objects. component.properties, template.properties and Velocity templates all follow the same scheme as for the model objects, with minor variations for the exact file names.
For simple overrides, the various aspects of rendering inheritance are easier to use than Java-level inheritance.
   Dimensions of Variability

There are two dimensions to the variability of JeeWiz controls:
they can represent different things within a meta-model (e.g. different datatypes in Java)
they can represent similar things across meta-models (e.g. a ‘Date’ control can be used from both C# and Java).

Therefore, each control-type reference in a meta-program (that is not control-type specific, as some may be) embodies these two dimensions of variability. Not only can the control reference be generic across the control instances allowed across the control types; it can also be generic across meta-models.

The organisation of this variability is entirely consistent with similar features for model objects. While there are some implementation variations here, there are no new concepts.

Templates

JeeWiz uses the Velocity engine to build templates; there are extra features to define the ‘context’ for a Java generation to be the current model object, and allow access to all objects in the model object tree.

One individual Velocity invocation produces one output file, which can be code, a configuration or build file, or some other sort of product such as XML output. The generation of multiple output files for a given model object node is coordinated by an Ant build script.

Java-Velocity Continuum

Substitutions in Velocity can come from the current model object, configuration files, values on parents, an explicit reference to some other model object, or JeeWiz controls.

This section applies to the substitutions involving model objects or controls in patterns or templates. When a model object or control is referenced, we have discussed how Velocity substitution values can come from
properties or lists defined in the meta-class or a superclass
additional methods defined in the meta-class or superclass
component.properties.

In building complex objects, particularly composite controls and model objects that use them, it convenient to also be able to access methods on a particular object coded in Velocity rather than Java (‘Velocity method’), because it is easier and more concise to generate output text and reference other objects in Velocity than Java. JeeWiz provides such a feature; this is not provided in standard Velocity.

Analogous to the component.properties file, which defines properties, the code for Velocity methods is placed in a ‘component.methods’ file, which is placed in the directory for searching for per-model-object files, i.e.

$modelControlDirectory \ $elementXMLName \ component.methods

The ‘per-model-object’ search technique described earlier is used to find such files (i.e. searching the meta-model stacks and observing template.properties for rendering ‘inheritance’).

A method in the component.methods file has a header ‘#method( )’, with the method name and any parameters listed inside the parentheses, and a body terminated by #end, e.g. the header for a method m with parameters ‘p1’ and ‘p2’ would be

#method( m $p1 $p2 )

As with Velocity macros, the parameters are substituted, untyped, from the arguments in the call: Velocity methods can be called with any type of parameter, even null.

The result of calling a Velocity method is to return the text output by the script as the value of the method. In other words, a string is returned; this is then substituted for the text of the call. Naturally the mechanism can be used recursively: a Velocity method can reference properties or methods on other objects, which will be substituted during the evaluation of the Velocity method.

Methods of the same name with different numbers of parameters are distinct, so a Velocity method must be called with the correct number of parameters: there are no defaulting mechanisms that might accept a different number of parameters. Methods of the same name and number of parameters are considered the same for overriding purposes—just as properties in the component.properties file override by name. This means that a Velocity method defined in a component.methods file from a ‘higher’ meta-model will override a Velocity method of the same name and number of parameters defined in a component.methods file from a ‘lower’ meta-model.

This feature is termed ‘the Java-Velocity’ continuum because, for references made from Velocity, a Velocity method of a given name and number of parameters will override all Java methods defined in the model object or control. This means that a basic implementation can be given in Java but overridden in Velocity. The Velocity script is better at expressing meta-programs—that create text—than normal third-generation languages like Java. The Java-Velocity continuum, and Velocity methods, apply object-oriented techniques—modularity and reuse, separation of concerns, overriding, and polymorphism—to meta-programming. Large-scale meta-programs can use properties and methods from encapsulated layers of technology—as represented in the meta-models—to build additional modules as Velocity methods. For example, a Velocity method on a model object—such as a page—can use the output of methods on other model objects or on controls—such as a grid representing a collection—to build a composite output, without knowledge of the underlying technology. The end result is that highly complex meta-programs can be expressed as simply as possible in a way flexible enough to be adapted locally.

Generalisation

The “Java-Velocity continuum” approach can be generalised: it is a technique for referencing properties and methods through a single programming object that can be specified in diverse programming languages that do not share a common run-time. In contrast:
references can be made in .NET to objects coded in different languages that share a common run-time representation
script languages like JSP have the ability to reference from the scripting language to methods coded in another language (Java), but using a distinct syntax for this purpose.

Furthermore, both properties and methods can be overridden by model object inheritance (for facilities coded in Java) or the configured meta-model stack (for component properties or methods). We have shown how this applies to a meta-programming environment operating at ‘generate-time’, but the same technique would apply, and be useful, at execution time, for example generating HTML (which was Velocity's original domain of operation).

Velocity Extensions

Velocity can be used in preferred embodiments to code templates (for generating code files or other output of the generation system) as well as patterns (for augmenting the input specification), as has been described above. As mentioned in the preceding sections, JeeWiz provides an extension to the standard Velocity templating language which provides for the definition of Velocity “methods”. This extension (usable both in templates and patterns) will now be described in more detail, along with two other Velocity extensions (#return and #divert). Specific features, for example syntax, are given by way of example and in relation to a specific embodiment; as will be readily apparent, other implementations are also possible.

Velocity Methods

This JeeWiz Velocity extension supports object-oriented methods on model objects and JeeWiz controls. Methods can be defined on generate-time ‘objects’, which in JeeWiz templates and patterns means model objects and JeeWiz controls. Another Velocity feature for defining named sequences of Velocity script is the ‘#macro’ feature. JeeWiz methods add the extra feature of being able to attach named scripts to a particular object type—in other words, the JeeWiz method feature is object-oriented.

The brief overview of this facility is as follows:
1. Methods are defined in a file called ‘component.methods’. ‘component.methods’ is a fixed name.

2. Multiple methods can be defined in a component.methods file. Methods use the following syntax: the Velocity directive ‘#method’, followed by a list of parameters, then the body of the method, terminated by #end:

```
#method( methodName [$param]... )
    ... the body of the method ...
  .
#end
```

3. Methods are identified by
   the object type for the object (e.g. for a model object, the effective tag of XML definition for the element)
   the method name
   the number of parameters

In other words, the number of parameters is important in picking which method to use, so the following method declarations create distinct methods:

#method( methodName $p1 )
#method( methodName $p1 $p2 )

4. Unlike methods defined in Java, which are distinguished based on the type of the parameters, JeeWiz methods ignore the type of parameters (because Velocity is an untyped language). The only considerations in selecting a method to execute are
   the method name
   the number of parameters
   the method's precedence in the stack of template directories.

5. Methods are invoked in Velocity using the following method invocation syntax:

$object.methodName( “arg1” $arg2 )

will invoke the method named ‘methodName’ with one parameter defined on $object.
6. As with macros, multiple component.methods files can be defined in different template directories and found using the template.properties file as described in the section on Finding Files above. The template name used to look up the component methods is
   for model objects, usually the name of the modelled element's stereotype such as ‘entity’ or ‘businessMethod’
   for JeeWiz controls, the template name in the constructor for controls created dynamically.

For example, for a template directory stack of

jeewiz/resources/j2ee/control
jeewiz/resources/bizobject/control
jeewiz/resources/base/control

and a template type of ‘businessMethod’ the component.methods files that will be read, if they are present, are

jeewiz/resources/j2ee/control/businessMethod/component.methods
jeewiz/resources/bizobject/control/businessMethod/component.methods
jeewiz/resources/base/control/businessMethod/component.methods

The ‘include’ and ‘goto’ features of template.properties are supported.
When multiple component.methods files are found, the definitions are aggregated, with declarations in ‘higher’ files (i.e. in an earlier-encountered template directory) of the same method name and number of parameters overriding similar declarations in lower directories.
7. Though a ‘global’ method declaration capability could be provided (Velocity has the ability to define global macros in VM_global_library.vm), in preferred embodiments, such a ‘global’ facility can instead be simulated using the template.properties feature, by going to, or including, a base element type.
8. For meta-classes and JeeWiz controls defined in Java, methods defined via ‘#method’ take precedence over available methods defined in Java.
   Constructing Objects to Use Methods on

Methods can be used on model objects and JeeWiz controls. Both types of objects can be defined in Java, or defined on an ad-hoc basis.

Model objects explicitly defined in Java are created by reading in a model, or by creation in a pattern, when the XML element maps to a meta-modelled class. Ad-hoc model objects are created when XML is read in but there is no meta-class to match the XML element. In this case, the object created is of the type ExtraBuildComponent—which is to all intents and purposes just a basic model object, which supports all the model object helper methods.

JeeWiz controls can be explicitly defined by a class using the techniques described in the section on Controls. Ad-hoc controls can be created by calling the getNewControl(String xmlTemplateName) method on a model object:

$this.getNewControl( “myControlType” )

This creates a new control, using the directory ‘myControlType’ to look up the component.properties and component.methods files for the control.

Method Syntax

In the embodiment described, the declaration of a method should only be done as a top-level directive in a component.methods file; in other words, #method directives cannot be
embedded in any other Velocity directive (e.g. #method within a #method or #macro block)
defined in any file other than component.methods.

Although the method name is normally defined with a name (rather than variable reference—i.e. with a preceding ‘$’) and its parameters are normally defined with a variable reference (rather than being preceded by a ‘$’), either names and variable references can be used to define the method name and the parameters. In other words, the complete syntax for the method declaration is:

#method( [$]methodName[-] [[$]param]... )
... the body of the method ...
#end

The ‘$’ is removed from both names—of the method and of the parameters.

The ‘[-]’ in the above syntax indicates a special feature to trim the output of a method. Velocity allows the character in variable references, and JeeWiz takes advantage of this to allow the method declaration to indicate the method is intended to be used in-line. In this case, any whitespace is trimmed from the beginning and end of the method. For example, a method declared as follows

```
    #method( inlineMethod- )
        a
    #end
when evaluated in the following line
    Give me $c.inlineMethod() ‘B’
produces
    Give me a ‘B’
If the ‘-’ is omitted from the method name, this produces
    Give me a
    ‘B’
```

If a method is producing line-oriented output, this facility should not be used: it will cause any following output to be concatenated onto the end of this method's output with no intervening line break. As this example shows, any number of parameters, including 0, is allowed.

Note that this feature is triggered by appending the ‘-’ to the method name only—and to the final character of the name being ‘-’. If a method has a ‘-’ inside the name (which is not recommended but supported) then it becomes part of the name, and must be used in the invocation and does not trigger the inline feature. If a parameter is declared with a trailing ‘-’ (e.g. ‘$a-’), then the ‘-’ is part of the parameter name and must be used in references (e.g. ‘$a-’).

The method body can be any legal Velocity script. Methods can take advantage of Indentation in Scripts to lay out the script with leading tabs discarded.

Invoking Methods

Methods are invoked using the syntax:

$object.methodName( [args...] )

We say the method is being executed, or evaluated, on the object. If no parameters are defined, the parentheses ‘( )’ are still required to trigger the method invocation. As with other methods accessible by Velocity, methods declared via the JeeWiz “method” extension are identified by the (case-sensitive) name and number of parameters. In this implementation, there is no type matching with JeeWiz methods, because there is no type information in the method declaration.

Evaluation Context

Arguments to a method are passed by value. In other words, the Velocity engine evaluates each argument and assigns the value to the corresponding parameter before executing the method body. This is done “quietly” so that, if a null argument is passed there is no error and the method is still evaluated, but the corresponding parameter is null. Velocity macros may be used alongside methods, in which case it should be noted that methods operate differently to macros in this regard. With macros, it is possible to pass references to objects that are currently undefined without causing an error. A change to the parameter in the macro is reflected in the calling context. In other words, macros use “call by reference”.

There is a local context for the evaluation of a method. The details of this context depend on whether the method is being executed on a model object or a JeeWiz control. For a model object, the context contains:
The $this variable, which is the same as the object the method is being executed on.
The $self variable, which is the same as the object the method is being executed on. In other words, this is a duplicate of $this.
The $super variable, which is described below.
Any parameters.
Local variable created via #set in the method body.
A link (i.e. context search delegation to look up any unsatisfied variable references) to the context for the pattern or template being executed. For any variable references not satisfied by the current context, the evaluation delegates to the linked context. This will then pick up values from the model object and its parent contexts (i.e. properties on parent objects or defined in system.properties) as described elsewhere in this document.

For a JeeWiz control, the context contains:
The $this variable, which is a copy of the $this of the enclosing context, which will be the model object the template or pattern is being run on. This approach allows methods on controls to call methods on other controls and have $this be propagated properly.
The $self variable, which is the same as the control the method is being executed on.
The $super variable, which is described below.
Any parameters.
Local variable created via unqualified #set directives (e.g. #set($localVar= . . . )) in the method body.
A link (i.e. context search delegation) to a context containing the properties defined on the control. These properties are (a) those defined in component.properties for the control and (b) any set by ‘#set’ on $self. Note that these properties are preserved across method calls whereas the local variables are not.
A link to a context containing the values set at generate time from build properties .jwp files or system.properties. This means that build and system properties are the last port of call for unqualified variable references not resolved previously.

The reason for having ‘$self’ as well as ‘$this’ is to support the following usage:
Set values on the object the method is being executed on via ‘$self’.
Use $this to access helper methods.

This makes it possible to have common ‘subroutines’ which do not need to know whether they are being executed by a control or a model object.

Here is an example of a method that takes a parameter:

#method( generateCallWithHisNameAndMyName $methodName
$object )
${methodName}( “$object.name”, “$name” );
#end

This is a two-parameter method that takes the method to call and an object. It generates a call to a method (Java, C# etc.) using the $methodName parameter as the name of the method to call. The parameters to the called method in the generated call are the name of the passed object and the name of the current object (either a model object or a control).

$super

The $super variable is put into the evaluation context of a method. This variable can be used to call “overridden” methods. The $super reference is actually a proxy object that has no other use than to call methods. When this is used—in an invocation like $super.methodName( . . . )—the action is as follows:
The $self variable is substituted for $super. In other words, the actual object used for calculating references in the called method is the $self—the object that the method is executing on.
The template directory in which the current method is defined is examined for a ‘goto=’ in the template.properties file. If there is no Such goto, then an exception is thrown—this is an invalid use of $super.
The method, with the correct number of parameters, is looked up starting with template directory named in the goto. If there is no such method, in the indicated directory, or any of the template directories indicated by the ‘include’s or ‘goto’ chain, an exception is thrown.
If there is such a method, then that method is executed.

For example, a valid use of $super is as follows:
A variable $c is created using $this.getNewControl(“int-datatype-control”).
The template directory int-datatype-control, in some available directory in the meta-model stack, has a template.properties with goto=numeric-datatype-control.
A method methodName( ) is defined in a component.methods file in an numeric-datatype-control directory.
The reference $super.methodName( ) in method defined in an int-datatype-control directory. Then this is a valid reference and the method defined in the previous bullet is invoked.

This mechanism can be used to ‘top and tail’ a value: put information before and after the value returned from the super method:

#return( “Top${super.methodName( )}AndTail” )

The dump of the aggregate XML includes a section on the methods encountered during the build. The methods listed in the dump are for both controls and meta-classes.

Methods—Details of Operation

This section describes the details of how the method feature is implemented in a preferred embodiment, with reference to FIG. 27 (the step numbers below correspond to those in the figure):

[1] The Velocity engine—itself Java code—is the running application and operates in two stages. First, it parses the textual form of the Velocity scripts into an intermediate form using Java objects. (To implement additional directives like #method( ), the JeeWiz engine provides additional facilities in the Velocity intermediate form.) This stage is done once, however many times the script is executed.

The Velocity parser recognises a method call by the pattern

$object.methodName( ... )

[2] The second stage is the execution of the Velocity script. The Velocity processor locates the initial referenced object—$object—as a starting point for looking up methods. In general, there is a different value for $object for each execution of the Velocity script.

Although this description only uses examples from the first reference (i.e. “$object.”), the syntax of Velocity is more general than the example shown: it allows a chain of method calls attached to an initial reference. For example, a chain of methods could be

$object.getMyRelation(“mother”).methodName(...)

The process used to interpret these chains is exactly the same for subsequent method invocations (e.g. ‘.methodName( . . . )’ in this example) as for the first method invocation (e.g. ‘.getMyRelation(“mother”)’).

[3] The JeeWiz enhancement to Velocity first examines $object. It must be a model object or a JeeWiz control to continue this process. Similarly, for chained object invocations, the value of the object preceding the method invocation must be a model object or a JeeWiz control.

[3a] If not—or if the process described below stops at any subsequent point—then the normal Velocity Java method lookup is done.

The implication of this evaluation order is that methods defined in Velocity with #method( ) take precedence over any applicable method defined in Java.

[4] For model objects and JeeWiz controls, the templateName for the object is determined by calling ‘$object.getXmlTemplateName( )’.

The cases for the templateName, and the resulting templateName, are as follows:
Model object whose class is defined in a meta-model: the name of the meta-class
Other model objects: the name of the XML element tag used to defined the object
Dynamically-created JeeWiz controls: the template name provided in the constructor.

Pre-loaded JeeWiz controls: the template name is constructed as

```
“<controlName>-<controlType>-control”, where:
  − <controlName> is the name of the JeeWiz control as defined
      in the meta-model “<jwcontrol>” tag - e.g. “int”
  − <controlType> is the type of the JeeWiz control - e.g. “datatype”,
      “database”, “ui”, “logging”
yielding a unique name such as ‘int-datatype-control’.
```

[5] A list of template directories is constructed using the techniques described above. This list is used to create a second list, of all files named ‘component.methods’ in the template directories.
[6] Each of the available ‘component.methods’ files is read. Each ‘component.methods’ contains any number of method definitions. The methods are used to build a list of Velocity-based methods for the current templateName. Methods are identified both by name and number of parameters. Where there are multiple instances of the methods with the same name and number of parameters, then
Methods from component.methods files in “higher” directories (i.e. earlier in the search order) are used in preference to methods in lower directories. Within component.methods files, the precedence is undefined and so duplicate methods should be avoided.

This search order implements overriding between methods defined in different template directories.

[7] Examples of the overriding feature are shown in the diagram:

7a $object.m($a1)—The component.methods file from the j2ee template directory has this method. The similar methods from bizobject and base template directories are overridden.

7b $object.m($a1 $a2)—Shows that the method ‘m’ with two parameters is different from the method with one parameter.

7c $object.m( )—This examples shows that a method from a lower template directory—in this case the bizobject level—can be referenced if there are no overriding definitions

7d $object.m3($a1 $a2 $a3)—This method goes to yet another level of the template directory stack and also has three parameters.

[8] When $super is used, the context object does not change. In this example, if from a method called via $object as the reference, when “$super.m($a1)” is executed, the context object is the same—the value of $object from the original reference. What does change is that the template name is cast down to the next lower template directory in the stack from where the current method was defined. Thus, the effect of ‘super’ depends on the class in which the current method is running.

Accordingly,
[8a] the execution of ‘$super.m($a1)’ in the j2ee's method links down to the next available method m($p1), which in this case is in the bizobject directory
[8b] and from there, further execution of ‘$super.m($a1)’ links down to the method in the base directory.
   The #Return Directive

Velocity script is normally used to produce text output. More specifically, a given portion of Velocity script, whether in a template, macro, or method as described above, generates text which is added to the output stream. This is referred to herein as the rendered output of the script.

To provide greater flexibility, JeeWiz provides a ‘return’ feature (as the #return directive). This can be used in a template, macro or method script to
stop the processing of the script immediately
return a value, rather than the rendered output of the script.
   #return can be used with 0 or 1 arguments, e.g.:
#return( )
#return(true)

The parentheses are required to invoke the #return functionality. The parameter passed to the 1-parameter version of #return can be any legal Velocity expression. Note that, in the present implementation, a macro invocation (e.g. #mymacro(arg)) is not a legal Velocity expression. This restriction is simply the result of the Velocity syntax. In other words, in this implementation you cannot write return statements like
#return(#mymacor(“a” “b”))

However, alternative implementations may of course provide such functionality.

Examples of legal Velocity expressions are
true
false
$object
$object.methodThatReturnsAnObject( )
1
2>1
2>$logLevel
(2>$logLevel)
   Operation of #Return

Both the 0- and 1-argument version of #return directive stop processing of the current script immediately (after evaluation of the argument in the 1-argument case). This aspect of the #return feature can be useful for avoiding multiple nested #if's that reach to the end of the script. So instead of:

#if( $condition1 )

...

#else

#if( $condition2 )

...

#end

#end

it is possible to write

#if( $condition1 )

...

#return( )
#end
#if( $condition2 )

...
#return( )

#end

This of course becomes more useful the more conditional cases there are.

Returning a Value

The #return directive is used in a script—a template, method or macro. The default operation of a script is to output text, and this is still what happens if #return( ) without an argument is used. When #return is used with an argument:
any existing output from the script is discarded
the argument is evaluated as an expression in the context of the script
the expression is returned, without at this point converting it to the string representation.

Of course, if the invocation of the script was not in an expression (which must be the case for a #macro or a template/pattern included via #parse) then the normal action of converting the expression to its string representation is performed. When the invocation of the script is part of a Velocity expression—which is only possible if the script is a JeeWiz method—then the returned value is substituted for the invoking expression.

This means it is possible to return ‘true’, ‘false’, numbers, expressions and objects from a method. For example, the method

#method( giveMeATrue )
#return( true ) ## e.g. #return( $n > 1 ) is also possible
#end

can be used in an expression:

#if( $nc.giveMeATrue( ) )
...
#end

Thus, the #return directive can be used to generate values for further use in expressions instead of simple text output, as is the normal behaviour of Velocity script. This significantly increases the expressive power and flexibility of Velocity, in particular when used with the “method” Velocity extension described previously.

Instead of discarding the output of script (e.g. a method) upon executing #return(expr), a variable could be created to hold the script output for later use. This variable could be a default variable or could be explicitly specified (for example in the #return statement). The variable could then be referenced later in the script to incorporate the “discarded” output back into the output stream.

The #Divert/#Revert Directives

Occasionally in templates and patterns, it may be convenient to create some text as part of processing the script, and then use that text later.

To assist with this, JeeWiz provides the #divert directive to temporarily divert the output of the script to a Velocity reference. The reference will typically be a local variable—e.g. $phase1—although any other form of reference is allowed.

There is a matching #revert( ) directive, which terminates the current #divert directive.

#divert( ) requires a single argument which must be a valid reference:

#divert($foo)
#divert($this.bar)

The parentheses are required to invoke the #divert functionality.

#revert( ) is called without an argument.

Operation of #Divert/#Revert

#divert and #revert are executable statements and are independent of the flow of control structure. In other words, it is possible to write sequences like this:

```
#if( $doDivert )
    #divert( $divert )
#end
...
#if( $doDivert )
    #revert( $divert )
#end
...
#if( $doDivert )
    $divert #* include the diverted output *#
#end
```

When the last #divert is #revert-ed, then the output of the script reverts to the original target (whatever file or variable it was being directed to). To get access to the diverted output, the references in the #divert( ) directive must be evaluated at some later point otherwise the output will be lost.

The #divert and #revert directives must be matched up. It is an error to execute the #revert( ) directive if there is no existing #divert( )-ed variable. It is also an error to leave one or more #divert( )-ed variables remaining at the end of the script. In the case of these errors, the engine throws an exception and terminates the build.

However, there is no restriction on #divert/#revert being outstanding when a #return is executed; returning immediately implies discarding all the #divert-ed streams.

It is possible to have a #divert( ) outstanding when a call to #parse is made. The output of the #parse script is added onto the pushed variable as normal for script evaluation.

As implied by the names of these directives, it is possible to have multiple #divert( ) directives in operation simultaneously—although this may not often be useful in practice.

Pushed References

When #divert is executed, the reference is examined and three actions taken depending on the outcome:
If the reference does not have a value, a new StringWriter is created to hold the forthcoming output of the script. The new StringWriter is immediately set into the reference. At this point the new StringWriter will be empty.
If the reference does have a value and it is a StringWriter, it is used to collect the output of the script. However, it is not allowed to use the same reference simultaneously in a stack of #divert( ) directives.
If the reference has a value but it is not a StringWriter, an exception is thrown.

As the script is executed, the output is collected in the StringWriter. If you were to evaluate the reference during the script, it would constantly change as script was produced to produce the output. When the matching #revert is executed, the StringWriter used to collect the output of the script is retired. It is already available in the reference.

This method of operation means that the same variable reference can be used to collect pieces of script in sequential #divert/#revert operations.

The reference spans calls. This can be used in a typical sequence that tops-and-tails the output of a call, but typically only if it produces some output:

```
#method( getNavigationRule )
    #divert( $cases )
            $self.findEventHandlerChildren( $self )
    #revert( )
    #if( $cases.trim( ) != “” )
            ${i}
              /${viewId}
              $cases
            ${u}
    #end
#end
```

In this method, the local variable $cases does not exist, so a new StringWriter is created and assigned to $cases. Then the rendering of all the event handlers in the children are called. If this produced an output, then this is topped and tailed with a navigation rule. Even though the event-handler processed proceeds through other methods, and probably uses other objects to build its output, the diversion to the variable $cases in the current context remains intact.

Following the above non-limiting example, further details of features and aspects of embodiments of the invention will now be described in more detail.

The Model or Specification

A ‘model’ may also be described as a specification; as used herein, the term “meta-model” may be used to define what can be specified by an application designer.

The system generation is based on the initial platform-independent model (PIM), or specification, consisting of analysis (business-domain) elements. According to preferable embodiments, a single-step transformation may be used to build the system directly from the model—without outputting any intermediate models. (This does not mean that we are generating the detailed business logic: there is still custom application code to be written, but it will be ‘picked up’ as part of the overall system build.)

A consequence of going straight from the design class to the code is that there is no need to produce a platform-specific model (PSM) for designers, which provides advantages such as:
The architect's original design cannot be changed by the business analyst
An extra step simply introduces more possibility for error
PSMs quickly become too big to manage.

Historically, the PIM/PSM split mirrored the split between the business analysis and design phases. If the Model Driven Architecture (MDA) architect can specify PIM transformations that generate the design classes, the PSM is useful only for debugging and the present system preferably produces a PIM output for debugging and/or documentation, as illustrated schematically in FIG. 4.

Preferably, the original specification or model should be:
‘logical’, or platform-independent
rich enough to contain all the information necessary to build the complete architecture
high level, using concepts at the business analyst's level of discourse.

The original specification may be written in the Unified Modelling Language (UML), for example using a UML modelling tool, or may be written in Extensible Markup Language (XML), or in an XML-based language.

An example of high-level concepts occurs in modelling User Interface (UI) pages where concepts like wizard-page and event handler are available as shown below (using Extensible Markup Language (XML)):

| | |
|---|---|
| <wizard-page | name=“Survey4” |
| | container=“Survey1” |
| | data-view=“ContactPersonDataView”> |
| <event-handler | name=“Save” |
| | success-forward-page=“index”/> |
| </wizard-page> | |

A wizard page has a forward and back button, knows the order of pages visited so the ‘back’ button works correctly, keeps state of the assembled information (as a tree of data-views) as we go forward and back, and can execute code depending on events being triggered (e.g. the ‘Save’ button in this example). This will create many classes and fill in many methods with connective code. The business analyst doesn't specify these: they are generated from patterns as described in more detail below. The only handwritten code in the UI is the implementation of the save button—and if that is just a call to a session method it can be generated as well. Hence a complex transformation of the original model must be performed to produce the code to implement the model.

Advantageously, meta-models may be used to turn the ‘wizard page’ specification in the UML model into code. It may be possible to use UML profiles to perform the transformation, but UML profiles are not rich enough to transform complex specifications. Hence, as described in more detail below, we will have a ‘wizard-page’ class in our meta-model; this gives meaning to a <wizard-page> element in the XML format, or a <<wizard-page>> stereotype in UML with corresponding tagged values.

As outlined above, the present embodiment uses a simple form of XML for specifications. Other approaches, such as MDA, use a much more complex format. For example, the XML format of the MDA specification language—UML—is typically 5-10 times larger than the simple XML format. Similarly, an XMI specification may be 30 to 60 times more verbose that the simple XML, it would be impractical to create specifications or patterns in this way.

Advantageously, by using a simple view of XML, without any additional format requirements, it may be possible to use any XML document as a specification. This adds to the universal nature of the system: anything that exists as, or can be converted into, XML can be used as the input to the system engine. As XML has become the industry standard for exchanging structured information, XML may be used as a very general-purpose but highly capable information transformation. This approach may also make it easier to write patterns since the specification to be produced by a pattern, as described below, is as simple and concise as possible. In alternative embodiments, this may be done in UML for example, but patterns would be longer and more complex and hence would be harder to write.

The XML models may also permit Java code (or a combined Java/C# dialect, using the language control as discussed below) into the model. This may not normally be used by human model creators, but may advantageously allow patterns to create the code necessary to connect automatically-generated objects.

Further advantages of using XML as the internal specification language for the system may include the facts that XML is:
a simple—it is easy to write simple definitions
universal and unambiguous—it is widely used and transmitted
complete—most information domains can be expressed as hierarchical trees of information, which XML supports naturally. With the addition of references between elements, it is possible to build directed graphs which can describe most information structures and language transformations
multi-purpose—we use it for data, models, and meta-models; it is also becoming the basis for action languages such as BPEL and BPML
not restricted to object oriented (O-O) technology—JeeWiz has features that can be used beyond O-O
easy to generate—we will see how important this is when we discuss patterns.

As mentioned above, if the specification is not written in XML, the specification may be translated before further processing and the process of translation is illustrated schematically in FIG. 13. FIG. 13 illustrates the process of translating a UML Logical Model 1310 via an XSL Stylesheet 1312 to an XML specification 1314 before the specification is processed further by the system 1316. Similarly, a Javadocs specification 1318, for example written in Together-J, may be converted into a doclet 1320 before being translated into XML 1314.

UML Modelling and Automatic Stereotypes

If the specification model is written using a UML modelling tool, features may be provided in the present system to enable the model to be created more easily. In particular, automatic stereotypes may enable the modeller to avoid having to specify stereotypes, and so speed up the modelling process. This is particularly useful, for instance, when the modeller wishes to prototype a system, providing the minimum information to generate a deployable system.

A number of other options available to the modeller will now be described.

General points to note about this group of features:
The features may be applied when transforming XMI produced by a modelling tool, for example Rational Rose, into XML.
The features are not defined within the UML tool but in the translation of the exported XMI to the XML.
They are controlled by a number of system properties which are within the domain of the Architect and not the Modeller. The Architect may change the configuration of the XMI translation.

Automatic stereotyping of classes by name may be provided to enable the modeller to automatically attach a stereotype to a class based on the class name. For example a class named ‘MyFirstPage’ could be turned into a <<page>> without the need to explicitly stereotype the class. The feature may be controlled by system properties in the translation process. In brief, the ‘suffix’ property is used to determine what class names are converted and what they are converted into.

An example of the suffix property is shown below:

suffix.DV=data-view
suffix.DataView=data-view
suffix.Session=session
suffix.Entity=entity
suffix.Page=page
suffix.wizardPage=wizard-page

This says any class name ending with ‘DV’, or ‘DataView’ is turned into a <<data-view>>, classes ending with ‘Session’ into <<session>> etc. Note that the suffix is case-sensitive—e.g. a class name ending with ‘WizardPage’ will not work. This feature can be enabled or disabled by the means of the ‘autoStereotypeByName’, the default is disabled.

The system may further provide default stereotyping of classes, which may allow unstereotyped classes—that also are not stereotyped by the name, as described in the previous section—to be automatically stereotyped based on a defined default value. (The ‘out the box’ default is <<entity>>). For example all unstereotyped classes could be turned into <<data-view>>s. This is done by setting the ‘defaultClassStereotype’ flag. Only one default value can be specified.

A further feature of the system may be automatic stereotyping of related elements, which may mean that there is no need to stereotype the related elements of a class. For example a class stereotyped as a <<data-view>> will not need to have the attributes stereotyped as <<data-view-field>>, or the operations of a session will be stereotyped as <<business-method>>. This feature may be available in three styles. They are:
attributes of classes.
operations of classes.
associations between classes.

Unstereotyped elements will always be stereotyped to a default value. However it is possible to control the default stereotype of the element.

The ‘out the box’ defaults are:

operations on <<session>> become <<business-method>>
attributes on <<entity>> become <<attribute>>
attributes on <<data-view>> become <<data-view-field>>
associations between <<entity>>s become <<relation>>
associations between <<data-view>>s become <<date-view-relation>>
associations between <<page>>s become <<event-handler>>
associations between <<wizard-page>>s become <<wizard-event>>

A further feature that may be provided is the automatic generation of components. The modeller can leave off any or all of the components and the translation process will generate them, as well as calculating any required dependencies. The naming conventions of the components are as follows:
The application name is the model name.
ejbjar name is the model name with the suffix ‘Jar’.
The ui-jar name is the model name.

As a further feature, the system may provide automatic assignment of classes within components. Classes should be assigned to components to avoid confusion. However any unassigned classes will be placed into the appropriate component (entities, session, data-views into the ejb-jar and pages, wizard-pages into the ui-jar).

The description below explains how to configure the various automatic stereotype features described above according to one embodiment.

All the configuration settings described are used in the transformation from XMI to XML, for example in the ROSE XMI 1.1 conversion which uses the \resources\xmi_rose meta-model. Defaults are specified in the meta-model but each setting can be overridden at the higher level (i.e. in the ‘build.jwp’ file). Note: A stereotype turns the UML element into a Java Model Object of the stereotyped class and will therefore affect renderings.

The process of configuring the stereotyping of classes by name uses a very similar notation to the process of configuring the automatic stereotyping of related elements described below but whereas automatic stereotyping of related elements can not be switch off, this feature can. A flag ‘autoStereotypeByName’ is used to switch this feature on or off. The default is false. To set this feature ‘on’set the flag to true e.g.

autoStereotypeByName=true

Once the feature is ‘on’ the ‘suffix’ property is used to control the stereotyping, The default values according to one embodiment are shown below:

suffix.DV=data-view
suffix.DataView=data-view
suffix.Session=session
suffix.Entity=entity
suffix.Page=page
suffix.wizardPage=wizard-page

As set out above, this says any class name ending ‘DV’, or ‘DataView’ is turned into a <<data-view>> and classes ending with ‘Session’ into <<session>> etc. To change the stereotype value, for example, to set the stereotypes of classes names ending with ‘DV’ to <<entity>>s set the value as shown

suffix.DV=entity

If you wish to add a new value to set class names ending with ‘MY_PAGE’ to have a stereotype of <<page>> add a new property as shown

suffix.MY_PAGE=page

The feature of configuring the default stereotyping of classes has only one property ‘defaultClassStereotype’. The default setting is shown

defaultClassStereotype=entity

An unstereotyped class will always be stereotyped to the value of this property. This feature can not be switched off but to change the default setting, say, to be a <<page>> set the property as shown

defaultClassStereotype=page

The feature of configuring the automatic stereotyping of related elements may be used to automatically set the stereotypes of unstereotyped UML elements. As set out above, this feature is available in three different styles, i.e. this feature is used on three UML elements. They are:
attributes of classes.
operations of classes.
associations between classes.

This configuration uses a similar dot notation to set the values for each of the styles. For example the defaults are shown below.

attribute.entity=attribute
attribute.data-view=data-view-field
operation.session=business-method
association.entity=relation
association.data-view=data-view-relation
association.page=event-handler
association.wizard-page=wizard-event

Looking at the first style (attributes)

attribute.entity=attribute
attribute.data-view=data-view-field

This says an unstereotyped attribute on an entity will be stereotyped as a <<attribute>> Similarly, an unstereotyped attribute on a data-view will be stereotyped as a <<data-view-field>>.

The second style (operation)

operation.session=business-method

says an unstereotyped operation on a session will be stereotyped as a <<business-method>>

The third style (association)

association.entity=relation
association.data-view=data-view-relation
association.page=event- handler
association.wizard-page=wizard-event

says an unstereotyped association linking two entities will be stereotyped as a <<relation>>. An unstereotyped association between two data-views will be stereotyped as a <<data-view-relation>> and so on.

To override a value, set the stereotype value, e.g.

operation.session=method

This will turn an unstereotyped operation on a session into a <<method>>

It is also possible to add new values, for example to attributes of classes, operations of classes and associations between classes. For example, if you wish to make the operations of entities to become stereotyped as <<ejb-q1>> add the property as shown below.

operation.entity=ejb-ql

This feature will not override the stereotype of a UML element if the stereotype has been specified by the UML modeller. It will only override unstereotyped UML elements. So, for example, a modeller may wish to specify a session with business-methods and methods (operations which are not exposed to ‘the outside world’). As unstereotyped operations will be stereotyped as <<business-method>>s the modeller need only stereotype the operations which will not be exposed. These operations will need to be stereotyped as <<method>> (The modeller could stereotype all the operations as required).

Meta-Models

A meta-model may be used to specify what can be in a model, that is it restricts the valid contents of a model and may provide for validation constraints and defaults.

Meta-models normally map to technology layers; for example, a layered meta-model of a J2EE system may include:
a base meta-model, describing underlying features
a language meta-model, describing the language that can be use (e.g. Java, C#, C++)
a business object layer, where operational business concepts are defined
a generic deployment layer, such as J2EE or .NET
a specific deployment layer, such as BEA's WebLogic or IBM's Websphere
customer-specific enhancements and/or project-specific enhancements.

Splitting up the constituents of multi-tier technologies in this way makes it easier to specify the complete system.

In creating a meta-model, the main building blocks include the meta-model classes and their relationships, and meta-class validation. Meta-model classes are useful in reducing the complexity of transformations. Not only can we hide a lot of the detail, we can also build up layers of meta-models that culminate in business-level concepts. Because the structure is general and open-ended, it gives us a way to incrementally add high-level concepts, which eventually match concepts in the business analyst's vocabulary.

This is based on inheritance relationships between meta-model classes, both within the same meta-model and across meta-models. For example, if we look at the way we can define entities in J2EE, either in Java Data Object (JDO) or Enterprise JavaBean (EJB) style, we get the structure set out in FIG. 3.

In summary:
the most fundamental meta-class shown is the interface 310
classes 312 add more features to interfaces, such as data fields 312
business objects 314 have the idea of exposing methods outside the component or server
entities 316 have the notion of persistence and special handling for entity relationships
J2EE entities 318 have J2EE-specific primary key handling
EJB 320 and JDO 322 entities within J2EE have special configuration and deployment information.

Meta-model classes are grouped into ‘meta-models’. FIG. 3 illustrates three groups of classes that are defined as meta-models; the object meta-model 324, including interface and class objects, the business object meta-model 326, including business objects and business entities and the J2EE meta-model 328, including J2EE entities such as EJB and JDO entities. Meta-models may provide a way of reusing common information by configuring different stacks at generate-time as described in more detail below.

The meta-model is preferably implemented in simple XML, hence a user is not required to learn an additional meta-modelling language (unlike in UML, where MOF is a separate meta-modelling language). In addition, this feature may also enable the system and techniques described herein to convert the meta-models into Java code.

FIG. 16 illustrates a further embodiment of the system architecture, incorporating a screen tier, a business operation tier and a data tier.

A further feature of the present embodiment is that Java code can be added into the meta-model by a user. This may enable additional features to be created, such as views on the model and complex processing.

In the present system, the meta-models may be described as “pluggable” meta-models. A “pluggable” meta-model provides the ability to use equivalent layers to generate the output from a single design. For example, a user can build a system using a programming language selected from Java or C#, which alters the behaviour of one layer, but the other layers in the meta-model can be used unchanged.

It is not just single meta-models that are plugged in: multiple meta-models can be swapped around, as long as the complete stack makes sense. For example, say we want to build two systems from the same model: one for J2EE, the other for .NET. The stack of meta-models involved is illustrated in FIG. 2. The upper dotted line 210 shows the stack of meta-models that would be used in a .NET build. These meta-models include the C# and .NET meta-models 214, 216 specific to the .NET environment, but also include general meta-models such as the business object meta-model 218, which may be used in most layered meta-model implementations. The lower dotted line 212 shows the stack for a WebLogic J2EE build, including Java 220, J2EE 222 and WebLogic 224 meta-models, in addition to the standard meta-models.

A further useful feature of the pluggable meta-model may be meta-model inheritance. The layers of technology in large-scale systems tend to exhibit “inheritance”: higher layers are often based on, but are more rich and specialised than, the lower layers. Advantageously, the complete meta-model can be organised in an inheritance hierarchy, and this features may be allied to pluggable meta-models so that any layer in the hierarchy can be replaced.

The C# and Java meta-models are examples of the ‘object’ meta-model referred to above, occupying a supporting role for the ‘business object’ meta-model. The C# and Java meta-models are preferably designed to fulfil the requirements of the business object meta-model. As noted above, the business object and screen meta-models are common between the stacks. This may enable the system to use significant shared specification and related implementation code: for example, about 50% or more of the meta-model specification and logic is reused between J2EE and .NET stacks.

As well as promoting re-usability, this ability to configure different stacks of meta-models enables the system to produce .NET and J2EE deployments from the same model. Transformations are also attached to the meta-models to enable this feature and this will be discussed in more detail below.

The layered meta-model structure is completely flexible and relatively easy to refactor. For example, a persistence meta-model may be split out from the J2EE layer; but refactoring part of this job is minor compared to building and testing the patterns for another persistence mechanism. Additionally, users can add their own levels. The example shows a ‘project’ meta-model as a home for project-specific concepts, but there may be additional layers, for example a meta-model for company standards may be inserted between the project and the WebLogic layers. Pre-built renderings may be designed for different technologies and for different problem spaces.

A further related concept is rendering inheritance. In other words, a meta-model layer doesn't just define what designers can specify: it also defines what will be generated as the result of this specification. To take the Java/C# example: Java and C# use different representations of the same concept. The rendering is what produces the different representations. The original designer does not need to specify this ‘physical’ detail: when the system is generated, the correct syntax will be rendered automatically based on the selected meta-models. Hence a single ‘logical’ specification may be used to produce different ‘physical’ manifestations.

Meta-model inheritance and rendering inheritance share a similar concept but are expressed using two different mechanisms. Meta-model inheritance may be implemented using the inheritance feature of Java, combined with the idea of grouping meta-model objects into meta-models and features to support this, such as deployment in a single jar per level, or hiding properties at higher levels that no longer make sense. Rendering inheritance may be implemented using the technique described below. The system starts by looking for a template or pattern file in the directory named after the type of object. For example, if we are looking for the ‘includeSpec.vm’ file for an entity, we will look for the file jeewiz/resources/<top-meta-model>/control/entity/includeSpec.vm. If it is not there, we look for jeewiz/resources/<next-meta-model>/control/entity/includeSpec.vm. This works its way down the “meta-model” stack; if no file is found, it terminates unsuccessfully.

This first dimension of lookup is similar to the normal idea of a lookup (such as C++ include paths, Java classpath). A second dimension may be added, which comprises alteration of this search order based on the object. This second dimension may be invoked when a file “template.properties” is included at some point in the lookup path. This can have two types of lines: an ‘include’ line, which takes a temporary diversion to a directory named after an aspect (e.g. ejb), or a ‘goto’ line, which stops the search of the current directory and redirects it to another directory. The ‘goto’ usually follows the model inheritance chain (i.e. an ‘entity’ will go to a ‘business-object’), but need not.

An implication of this is that the term “meta-model stack” may not be strictly accurate for all embodiments, because for the purposes of rendering, directories can hold no meta-model objects at all and may be present purely to adjust the rendering related to meta-model objects at lower layers.

In one embodiment, the search order can be altered by ‘diversion signs’ given in a template.properties file in the control directory of an object's rendering. This allows the search to be switched from one object's directory to another object's.

There are two types of lines you can specify in the template.properties file: include=[template]-transfers unsatisfied file searches to the named template, but if the file is still not found, continues processing lines in the template.properties file. The common scenario for using includes in a template.properties is one ‘include’ line followed by a ‘goto’ line.

goto=[template]—transfers unsatisfied file searches to the named template. This will be the last line processed in the template.properties file. For example, there is commonality between business-methods and methods. In some cases, the business-method provides a template; in other cases, the template may be the same between business-method and method. If an unsatisfied search is switched from the business-method to the method object, then the method object's templates can be re-used.

In this embodiment, the ‘goto’ and ‘object’ diversion signs operate on any file, even including the special files ‘build.xml’, ‘component.properties’, ‘includeSpec.vm’ and ‘uptodate.vm’. What it says to the generator is: “if you haven't find the file you are searching for after this directory, start the search afresh using this new model object”.

As an example, if the stack of models is:

myCompany
weblogic6
j2ee
bizobject
object

and we are processing ‘business-method’ and searching for the files ‘x.vm’ and ‘y.vm’. The effect of putting a ‘template.properties’ file in the ‘bizobject’ with goto=method is to alter the searched directories as follows:

myCompany / business-method
weblogic6 / business-method
j2ee / business-method
bizobject / business-method
<<-- template.properties processed here
myCompany / method
weblogic6 / method
j2ee / smethod
bizobject / method
object / method

Note that the generator effectively restarts the search so the ‘myCompany’ model is revisited to start the search. This search process occurs for the file ‘x.vm’ and then is repeated for the file ‘y.vm’.

It is possible to have many diversions (there is no limit) during the search for a given file. The ‘goto’ therefore gives you a way of doing controlled inheritance of templates: you define the search path chain along templates. This is in contrast to the way that Java inheritance works: if a Java object inherits from another object, the search for fields and methods always follows the inheritance order. Although the component model objects underlying the specifications use Java inheritance, we do not automatically use the same inheritance for searching for templates.

The “elementXMLName” value is not affected by the ‘template.properties’ diversions: it is always possible to get the original XML-style name of the element tag using ‘${elementXMLName}’.

A further searching feature may be the object property ‘delegate’, which may be set to true if the value of this property should be searched for in the parent model-object chain. Delegation may allow easy defaults combined with overrides at each point in the model tree and is typically used on Strings and booleans. For example, the generate-log-level is delegated.

This value may be present on:
constraints (for which extra error logging is generated)
internal classes (in the business object model) and all its derived classes, such as entities and sessions
their containing jar (or assembly in .NET)—‘containment’ here meaning that the entity is on a list in the jar.
their application.

This means that when this value is referenced, a search is made for a ‘delegate’ property being explicitly set on the entity, its parent jar and then its application. The first one of these that has a value set is used—and given the way this works, there is no point in setting a default on a delegated property because it will not be used. If none of these is set, the search for a value may be continued to:
the applicable ‘system.properties’ value, and failing that
a value set in the JeeWiz build properties file (e.g. build jwp).

In the case of the generate-log-level property, a default value is set in the base system.properties (see jeewiz\resources\base\control\system.properties).

A further feature of the system may be termed “rendering polymorphism”. Rendering polymorphism may allow the system to change the rendering to do different things in different environments, for example the same command may be used to reference different methods depending on whether the system is being implemented in Java or C#. In many cases, this follows meta-model inheritance.

This feature is similar to the polymorphism technique used in object-oriented programming whereby a generically-specified feature (such as ‘draw yourself’ on a graphical shape) can assume different forms depending on the specific object used—for example, a square draws itself as a square. Hence the detailed meaning and realisation of concepts defined in the specification may depend on the target technology. Polymorphism has been found to be a surprisingly powerful technique when applied at a more abstract level in conjunction with pluggable meta-models, enabling the system to act differently for the same input system specification, depending on what meta-models are being used in the generation. That is, a single specification can be interpreted and actioned in different ways depending on the set of meta-models used during the generation process and the original specification does not need to be changed to be useful in different technologies. This contrasts with prior art systems in which a separate step is required to adapt the original specification to the target environment, which may be error-prone and costly.

Hence, in summary, a particular set of meta-models may be selected at generate-time; this will lead to different model objects being instantiated in the run-time tree. So J2EE/Java model objects may be provided in a J2EE build, and .NET/C# models may be provided in a .NET build. To increase the capability for polymorphism, name-switching capabilities may be provided. For example, an <entity> in a J2EE build may create an EjbEntity or JDOEntity depending on the configuration; similarly, a <jar> may automatically be converted to an Assembly model object in .NET.

A similar process may be provided in the rendering, during the application of naming patterns, patterns and templates, as described in more detail below. The naming patterns, patterns and templates are typically also associated with the meta-model. For example, a class model object may be transformed into C# using a template in the C# meta-model. Or, as discussed above, a delegate sub-pattern may be used, which is rendered differently in C# than J2EE. As the components of the meta-model, the renderings can also be re-used, which means that many of the more complex patterns are re-used.

As a further feature, finer control over how the rendering is changed may be provided. The framework may allow additional levels to be added into the meta-model chain to allow this finer control to be added. Advantageously, rendering polymorphism may allow higher levels of the system to override any part of the rendering defined in lower layers; in other words, you do not have to create a whole layer to change the rendering. The level of change can often just be a few files (out of many hundreds involved in a large-scale rendering).

The meta-model system may further advantageously facilitate the handling of business logic, that is the logic that cannot be derived by pattern. In some systems, this may comprise business-oriented code; in other systems, it may have nothing to do with business. This may be achieved by providing a housing for the business logic that is as unobtrusive as possible. One option may be to provide “guarded regions” in generated files to contain the generated code, with business logic going into the unguarded regions. Preferably, however, the business logic is housed in a class that derives from the base class. In other words, the infrastructure housing may be generated into a base class defined by the architect; the business logic may then be put into a class that inherits from the infrastructure. This means that all the features of the infrastructure class are available to the business logic class via inheritance.

Small sections of business logic may be written into the model itself, but larger sections of business logic may be written into a user source directory, where the application programmer works. Features of the system relating to business logic may include:
the patterns provided by the system construct an environment for the business logic that is platform independent.
the user's code area is usually in a directory that is separate form the generated code. This means that the architecture patterns can be changed, completely regenerating the architecture, without impacting the user's code.
the user's business logic relates to the generated code by inheritance, which allows the same business logic to be incorporated into multiple deployments.
the class and method header information is rewritten if the model is changed, preserving the body of the business methods. This permits parallel development of the model and the business logic.

FIG. 12 illustrates one embodiment of business logic housing, which is protected via delegates.

FIG. 14 illustrates a further example of meta-models and objects or classes which populate the meta-models according to one embodiment.

FIG. 15 illustrates schematically some of the preferred features of an editor which may be used in conjunction with the present system. FIG. 18 is a screen shot of one embodiment of an editor.

FIG. 17 provides a schematic example of interacting entities having associated properties and methods. For example, the ‘Bank’ entity 1710 has properties including ‘sodeCode’ and ‘address’. This interacts with the entity ‘Account’ 1712 on a one-to-many mapping and the ‘Account’ 1712 entity has properties including ‘accountNumber’ and ‘creditLimit’. The ‘Account’ 1712 is associated with a ‘Customer’ entity 1714 via a one-to-one mapping. Method objects, such as ‘CustomerAccountManagement’ 1716 and ‘TraderAccountManagement’ 1718 may contain methods that can operate on the entities, such as the ‘Account’ 1712 and ‘Customer’ 1714 entities. For example, ‘CustomerAccountManagement’ 1716 may include methods such as ‘+open( )’ to open an account, ‘+credit( )’, ‘+debit( )’ and ‘+listTransactions( )’.

FIG. 19 is a screen shot of one embodiment of an interface for a system created using a model according to FIG. 17. Users may interact with the interface 1910, for example to log on and manage their accounts. There may be a further interface for traders 1912 to manage transactions.

Meta-Model ‘Inheritance’

As discussed above, meta-models may be described as groupings of (meta-)model objects. It is possible to derive model objects in one meta-model from a model object in another meta-model. This encourages modularity at the meta-model level: concepts appropriate to each particular meta-model are represented in the meta-model. More specialised meta-models can build on the more general meta-models and add features of their own.

More details of features of meta-model inheritance will now be discussed with reference to an example. Part of an inheritance stack to get to entity EJBs is illustrated in FIG. 6. The objects involved in this example are:

RT—the reference type (name and value)

C—class

IC—internal class (in business objects)

BO—business object

E—entity

ejb—Ejb

ejbE—Entity EJB

jdoE—JDO entity

The objects involved are grouped into meta-models, one embodiment of which is illustrated in FIG. 7. The ‘Java’ model contains the reference type and class model objects. The ‘Business Object Model’ contains the internal class, business object and entity model objects. The J2EE model contains Ejb, Entity EJB and JDO entity model objects. The WebLogic model currently does not contain model objects. (The screen meta-model illustrated earlier has been omitted in this example.)

Model objects can derive (using Java inheritance) from model objects either in the same meta-model or in a parent meta-model. For example, there is a ‘business-method’ in the business object model that derives from the ‘method’ in the business model, which illustrates inheritance within the same model. However, the business object model ‘method’ derives from the ‘method’ in the object model, which illustrates inheritance across models. This inheritance is reflected in a single Java object.

The idea of meta-model ‘inheritance’ will now be discussed in more detail. We use the term ‘inheritance’, but it is a pluggable inheritance, which can be changed at build time. For example, FIGS. 6 and 7 related to a J2EE stack of meta-models. FIG. 8 illustrates the corresponding .NET stack according to one embodiment.

As this illustrates, the business object meta-model may be re-used (and that is useful, because there is a lot of value in there). The business object meta-model needs an underlying object model—in this case we have used the C# meta-model, rather than the Java one.

The model inheritance structure begs the question as to whether the person specifying the application needs to know which model a concept comes from, to be able to reference it in the specification.

In the preferred embodiment of the system, the answer is, emphatically not. The whole point about the system definition is that the user should be able to use concepts from the business object and object models to create specifications, without knowing about the eventual realisation.

For example, take the case of the ‘entity’. This is defined in the business object model. This has well-accepted characteristics in business object modelling. For example, UML has an ‘entity’ stereotype.

We would like the same specification using the same business-object-level vocabulary—‘entity’ rather than say ‘entityEJB’—to be able to have a default deployment to a real app server. This allows most of the configuration information to be generated via patterns. Of course, there will be a need to differentiate the business-object-level specification into target-specific configurations. A specific merging facility may be provided to help with the deployment process, and having the same names helps here too.

The impact of using pluggable meta-models is that the specification itself exhibits a sort of polymorphism: in J2EE, an ‘entity’ stereotype in UML, or an <entity> element in XML, becomes an entity EJB (or JDO class); in .NET, the same model object becomes a C# class with ADO.NET persistence. One of the key requirements of MDA—that a PIM can be mapped to different platforms—starts with interpreting the specification according to the platform.

In general, the principle guiding how to group model objects into meta-models should be to find logical layers that have tightly coupled concepts and create a meta-model for them. This may allow a developer to determine which model a particular feature should go in and, hence, where you should look for a particular feature. There is no significant run-time overhead in creating meta-models. Because of the mix-and-match capability described above, extra flexibility can often be gained by having smaller meta-model groupings.

As an example, here is one embodiment of the inheritance structure of the J2EE models:
1. The ‘Java’ model (also referred to as the ‘object’ model) is a mapping of Java/C# onto XML. All the common features of Java and C# may be provided, using the Java names. For example, there are jars, interfaces, methods, fields . . . and also jwclass's (unfortunately ‘class’ would have been too confusing). This is a concrete model: you can create a jar from a specification using the default rendering.
2. The ‘business object’ model allows you to describe objects with business processing overtones. This model derives from the ‘object’ model and adds one or more of the concepts of:
   a. exposing objects and methods to clients
   b. entity/session functional distinction
   c. constraints
   d. logging and tracing
   e. aggregation objects called data-views (to build up richer objects than simple entities attached to tables
   f. relations between objects and data-views.
All the class and component diagram features of UML that are relevant to the system may be made available in this model. This is an ‘abstract’ model in that there is no default rendering: it needs to be mapped into J2EE, .NET or a DIY architecture to describe the particular rendering for that model.
3. The ‘screen’ model defines pages and events on the pages, which are rendered into Struts or ASP.NET
4. The ‘J2EE’ model derives from the business object model and allows you to add descriptions of J2EE concepts and deployment information. It also specialises some of the objects in the business object model, such as entity and session. As EJB is container-based, this also adds the concept of local/remote.
5. Above the J2EE model are variants for the particular application servers.
   Naming Patterns

As set out above, once the specification has been developed, patterns may be applied to the specification to conform the naming used in the generated system to allow it to integrate with existing directory and file naming standards and structures and also standard code layout. Hence a default ‘out-of-the-box’ implementation may be provided, but the user may override individual names or directory structures etc. as required.

The capability is preferably provided to easily create ‘variable names’ attached to a model object that hold the actual names to be used. This is more maintainable than writing fixed names into patterns and templates. This feature may be implemented in conjunction with the meta-model inheritance and overlaying structure described above. That is, the system may support overriding a naming scheme defined in a lower level meta-model whilst keeping the dependents of the overridden names defined in the lower level meta-model calculated correctly (using the overridden name).

The naming patterns may be applied to each model object using a per-object properties file. For example, the properties file for the entity type may include the lines:

# PK is the name of the primary key for this entity, if any
PK=${name}PK

This defines a convention for naming primary key classes. ‘$’ implies substitution so the primary key class for an entity name ‘E’ will be named ‘EPK’. This is referenced as ‘${PK}’ in patterns and templates. A standard definition is provided for each name; this can be overridden by the project to change the naming standards without affecting the original.

As well as generated class/operation/attribute names, this technique is also used to define directory structures, again with a view to conforming to existing project standards.

This feature may further allow the system to accommodate changes in the standards.

Further details of how the naming patterns are implemented when the system is build are provided below, however, in processing an XML model, the system:
reads a model object's XML element tag (e.g. ‘application’)
and creates a Java object (e.g. an instance of the ‘Application’ class).
looks up patterns and templates based on the Java object's name, to drive the rendering process. the ‘rendering’ of the element like Java code, deployment descriptors and build jobs.

There are features for varying the object names that are central to the build process.
Element Name Conversion—‘convert( )’. As described herein, the ‘convert( )’ allows you to specify generic names in the XML (e.g. ‘entity’) and specialise them by creating different objects (e.g. like ‘ejb-entity’) based on the build-time configuration. This means that you can design using generic names, but you can change the nature of the deployed software by a simple configuration change. For example, we use this facility in the examples to switch between EJB and JDO versions of entities in the J2EE model.
Rendering specialisation. Normally the model object defines how the specification will be rendered. And normally, to specialise a rendering, it is best to create a template or pattern in an override meta-model. However, sometimes additional templates and patterns may be useful—for example, you want to define a class, but render it as a singleton. This is done by specifying an override directory, just for this object, in the ‘template’ property—e.g. ‘<page template=“page_create”>’, which gives an override directory to start looking for templates and patterns.
Embellishing specifications. This introduces additional specification features by rendering the ‘preIncludeSpec.vm’ and ‘includeSpec.vm’ files and feeding the result back into the specification. For example, a ‘factory’ is a special type of class: it has a method to create objects of the required class and a private constructor. To implement this, the factory uses the ‘template=’ property to specify the template directory, and in that directory the includeSpec.vm file defines the XML for the factory method.
   Patterns

The term ‘pattern’ as used herein may be used to describe a process that adds new model objects or changes the current one and may further include processes that add code. The patterns described herein produce embellishments to the specification rather than output files—they are produced by templates, which are described in more detail below. The embellishments normally create derivative objects from a master object and its environment.

In the simplest generation systems, it is not necessary to use patterns and templates may be sufficient to generate the necessary code. However, patterns become important as the transformations become more complex.

A pattern uses an object in the model to further embellish the model to adapt it to the target environment. By using patterns, architects can create patterns that directly implement a logical (abstract) pattern, which is then adapted to the target environment by templates which produce the actual text build products.

The approach of the present embodiment to expressing patterns is remarkably simple, because it is uses a very straightforward XML core definition of objects. However it is also very powerful, for example patterns can be easily overloaded and the mechanism is recursive, promoting modularisation. The actual expression into textual build products preferably depends on the templates being used. In other words, a pattern operates at the model (logical specification level); the physical representation can be switched, for example to generate Java or C# code, or a .NET project or J2EE Ant build scripts depending on the target environment. This may be advantageous, because experience shows that:
the greatest cost is understanding and expressing business processes
the greatest productivity and flexibility gains come from patterns, which directly support productivity in business processes.

By separating logical patterns from the physical templates, these gains can be carried over to multiple environments.

In the present embodiment, patterns are rendered using the Velocity scripting language and the current object node as the context object, as for templates, but then the output is fed back into the system as though it were part of the original model. This process is illustrated schematically in FIG. 5, in which patterns, rendered using Velocity, are recursively fed back into the model that is being developed.

It will be clear to one skilled in the art that the system described above may be implemented in alternative ways. In particular, a language other than Velocity may be used to render the patterns and templates.

This straightforward recursive mechanism means that it is easy to write patterns and a wide range of features provided by Velocity can be used. The example set out below is an example of building ‘getters’ and ‘setters’ for public attributes, and then turning them into private attributes. The current context node is the attribute, <this> references it, the <parent> refers to the class containing the attribute, and we create two methods, peers of the attribute, within the class:

| #if( $access ==“public” ) | |
|---|---|
| <parent> | |
| <this | access=“private” /> |
| <method | name=“get${nameCapitalised}” |
| | return-type=“${type}” |
| | access=“public” |
| | > |
| | return $name; |
| </method> | |
| <method | name=“set${nameCapitalised}” |
| | return-type=“void” |
| | access=“public” |
| | > |
| <parameter | name=“_p” |
| | type=“${type}” |
| | /> |
| | $name = $_p; |
| </method> | |
| </parent> | |
| #end | |

For an ‘int’ attribute ‘A’, the eventual rendering in Java (assuming no tracing inserted) would be:

```
private int A;
public int getA( ) {
  return A;
}
public void setA( int _p ) {
  A = _p;
}
```

(The <this> mechanism doesn't create a new node; it just sets the properties specified in the pattern. This means that if the attribute A already had a default property, this would not be affected by the pattern.)

In some embodiments, this type of job may be implemented with a template, but using a pattern is preferable since it is language-independent—the above example will work in Java or C#—and tracing may be applied if appropriate.

The example set out below shows mapping a session object to an overall page (which will show up in the ‘lhs-menu’—a menu of the left-hand side of the page) and mapping the session's business methods to pages that will show up in the ‘rhs-menu’—the right-hand side menu for the page. The whole thing is dependent on the setting of the ‘generatePagesForBusinessMethods’ variable.

#if( $generatePagesForBusinessMethods )

| | |
|---|---|
| <page | name=“${pageName}” |
| | title=“${userName}” |
| | container=“${lhs-menu}” |
| | link-caption=“${userName}” |
| | user-name-base=“${userNameBase}” |
| | package=“${package}” |
| | > |
| </page> | |

#foreach( $_method in $aggregateBusinessMethodList )

| | |
|---|---|
| <page | name=“${pageName}_${_method.name}” |
| | title=“${_method.userName}” |
| | container=“${pageName}” |
| | link-caption=“${_method.userName}” |
| | style=“rhs-menu” |
| | > |

<event-handler name=“${_method.name}”

user-name-base=“${_method.userNameBase}”
business-method=“${_method.name}”
success-forward-page=“${$pageName}”
/>

```
      </page>
    #end
#end
```

As well as being language-independent, patterns can be platform-independent too. For example, this second example is platform-independent: it works both in C#/ASP.NET and Java/Struts and would work on any UI with a suitable rendering. The above pattern may be termed a PIM-to-PIM pattern, but the distinction between PIMs and PSMs is not operationally important in the present embodiment of the system.

This feature is similar to the ‘specification polymorphism’ described in relation to the meta-models. The pattern can be expressed in terms of generic objects (for example entities or sessions) supported by the target architecture; the detailed meaning of these objects may then be defined by the set of meta-models used during the generation. This technique may be used to decouple the ‘logical’ result of the pattern (determined by one meta-programmer) from its eventual effect, which can be ‘logical’ or ‘physical’ and may be written by another programmer at a later time. The meta-programmer may declare requirements in terms of generic (or ‘logical’) model objects; the detailed realisation may then be invoked separately. Hence, it may be possible to write powerful and valuable patterns in a simple and concise way.

The examples illustrate that the system may enable very powerful patterns to be implemented in a straightforward manner. This sort of pattern may be termed a ‘mega-pattern’ because it is projecting one tier (Business Objects in this case) into another (UI tier).

Patterns may be considered to ‘fire’ in a similar way to events firing. The firing of patterns may be orchestrated by the system based on finding certain files for the type of object. Hence, the context for the patterns is implicit: the context is the object that fired the pattern. In the present embodiment, it is not necessary to implement complex pattern-recognition specifications for whether patterns should fire; filtering may be performed by a sequence of #if statements, as in the above example.

Model objects created by patterns can also fire patterns, just like events, so the pattern firing is recursive. Using the present embodiment of the system, the simplest J2EE example (one entity, one attribute) where we create a CRUD (create( ), read( ), update( ), and delete( )) session and UI pages to access it, fires over 40 patterns, generating hundreds of model objects. Such large-scale generation of model objects is made manageable by the fact that each individual pattern can be analysed and debugged on its own. It is also clear from this example that the converse approach of requiring the programmer to specify the complete pattern-firing sequence would quickly be unmaintainable.

In some embodiments, mechanisms may be employed to modularise patterns to stop them becoming too large. Such mechanisms may include creating sub-patterns to be pulled in by the Velocity ‘include’ mechanism and/or chaining the patterns to additional patterns e.g. using a ‘goto’ command. For example, the pattern for the EJB entity has 19 included sub-patterns, 8 of which it shares with the JDO entity. Further decomposition can be done using more ‘include’s, using the snippets and other techniques. In a preferable embodiment, all of these support polymorphism, which gives an architect the opportunity to override details of patterns at a detailed level without rewriting the whole pattern.

According to another powerful feature of some embodiments, code may be included in patterns, for example code is included in the first pattern example above. Code may be included as Character Data (CDATA) in methods or page event-handlers, and will be incorporated by the final rendering into the method.

The ability to include code has been found to provide a powerful tool. In prior art systems, code generation that just produced stubs only creates a tiny fraction of the overall system. Maintaining code by patterns may allow a generator to get up to the 90-95% levels of automation.

As will be appreciated by one skilled in the art, the type of code generated in patterns varies widely. There are small connective methods that join objects that are adjacent in the architecture, but methods can also be large: the data-view (data aggregation) and UI controller objects have a wide scope and can produce large output files.

In prior art systems, PIM-to-PSM patterns use the Java or C# languages to write the code, but PIM-to-PIM systems, as described here use a combination of Java and C#. This combination is basically the intersection between Java and C#, plus calls to a ‘language control’, which may be accessible as a normal Velocity variable ${lang}, that generates the language-specific code. For example, to get the number of elements in a collection in Java we say:

c.size( )

In the Java/C# combination, the phrase would be

c.${lang.ArrayList.Count}

Advantageously, using such embodiments, this may allow a product developer addressing both platforms to make the patterns more maintainable.

The term ‘pattern’ in the prior art normally means simply ‘create more model objects from this one’ and no code involved. However, in the present system, code may advantageously be embedded into the pattern to enable the pattern to connect to objects in the surrounding environment. This may mean that the patterns are not normally separately usable.

For example, four Delegate pattern implementations may be provided in the one embodiment, which may be used to cover .NET and J2EE, and entities and session objects. They are all named ‘delegate.inc’, and included as appropriate depending on the platform and the object firing the patterns.

In summary, the patterns that may be implemented in the present embodiment may provide one or more of the following advantages:
pattern rendering may be arranged so that it does not alter the original specification, which stays at the user's ‘logical’ level. The pattern rendering affects a temporary copy of the specification and the temporary copy may be one or two orders of magnitude (e.g. 25 times) larger than the original specification. If this were to be reflected into the original specification, it would be unmanageable.
the patterns can be changed, or different patterns may be used, which may allow generations from patterns to be easily developed and maintained. It may also enable different architectures, for example .NET and J2EE, to be created from a single specification by invoking patterns appropriate for the target architecture.
the approach described may allow a developer to generate additional architectural tiers, which may be intelligently derived from a base architectural tier.
the patterns produce more specification, but the nature of the specification produced is open, so the technique is universal. If a design needs to be converted into artifacts for a new technology area, new patterns can be written to create additional specification objects appropriate to the new technology.
the application of patterns to the specification is automatically recursive; the framework of the system, described in more detail below, can attend to running patterns on a new object. A whole cascade of patterns may be run based on a first pattern. If the framework controls the timing and firing of second-stage patterns, the patterns themselves can be smaller and independent of their usage in a wider system. This may allow the patterns to be more flexible at a fine level of detail and supports pattern re-use.
the patterns may incorporate connective code to interface newly-created specification objects into the creating specification object's environment. This may allow the system described herein to automatically generate a greater percentage of the system than was previously possible.

It is possible to use patterns to create derivative objects of the main object in the same tier (i.e. at the same level of programming), but the present system preferably further provides patterns which create whole new tiers of a large-scale system by generating a master object from that tier. For example, a page may be created in the User Interface tier, representing an exposed business method in the service tier. This master (specification) object will the create JSP pages, or code-behind pages depending on the architecture being targeted. This process is illustrated schematically in FIG. 5.

MegaPatterns

A further advantage of approach to patterns described above is that it is possible to write mega-patterns, which create whole tiers of a system based on a previous tier. For example, there are patterns to map the data tier into the business object tier, and to map that into screen pages. Hence, a ‘big object’ in one tier creates another ‘big object’, where a big object is loosely defined as firing a complex pattern using multiple pattern components (include files).

Examples of mega patterns are set out schematically in FIG. 10 and detailed below
map-entity-to-dataView—maps entities to corresponding data-views
map-dataView-to-maintenance-session—creates a session to maintain the data-view, incorporating CRUD methods
generateMaintenancePages—generates the pages to go with the maintenance session's CRUD methods.
‘generatePagesForBusinessMethods’—generates the pages to invoke methods—which may be used just to get testing started.

Note that at all these patterns are defined below the application server models (J2EE and .NET) which means that they will be used in both J2EE and .NET.

Templates and the Build Process

Once the specification has been developed using the patterns, the resultant model may be rendered into code by a ‘build engine’ using templates to produce the output.

A special Ant task may be used, which processes templates into text products such as Java source code or deployment descriptors. This may be called the Velocity task, which is described in more detail below. Templates for a J2EE architecture may be provided and can be adapted by a J2EE expert; application programmers will normally use templates rather than write them.

Templates are similar to script programs or mail merge programs in that they contain literal text (e.g. “Dear”) interspersed with ‘variables’ (e.g. “${addressee}”). When the template is processed, the ‘variable’ is replaced by its current value (e.g. “John”, in a ‘Dear John’ letter). To apply this to Java, if a variable ‘name’ in a template has the value “HelloJWorld”, then the template processor converts the input:

```
    class ${name}BeanBase {
to
    class helloJWorldBeanBase {
```

Just like UNIX shell scripts, the ‘${variable}’ syntax is used to denote variables; where the syntax allows, the ‘{ }’ can be omitted and ‘$variable’ will be equivalent to ‘${variable}’. The files created in this way in the J2EE system may include:
Java source code—every generated Java source file has a corresponding template
XML deployment descriptors (as required by the EJB spec and the application server-specific files)—again, each type of descriptor has a template
second-stage Ant build files, which are generated so steps after the generation can be undertaken without JeeWiz being present.

However, this is not restrictive: any text file can be autogenerated, based on a template.

The values to substitute for the ‘$’ variables are picked out of the specification discussed above, or from properties described in more detail below. The system may use a specialised version of the Velocity task, which can pick substitution values out of either place. For example, a template for a session can use the variable ‘$session.name’ and this will get the name of the current session EJB. So, to be more correct, we should have written the example above as:

class ${session.name}BeanBase {

(The ‘{ }’ delimiters are required here to prevent overlap between ‘name’ and ‘BeanBase’.)

The concept used is similar to UNIX shell scripts. However, using Java/XML tree structures allows us to add additional levels of structure—we can access properties within the objects as well as just text values.

One advantage of using a component model written in Java rather than a passive XML specification is that methods written in Java can also be invoked from Velocity—just as if the methods were properties. For example, the ‘Method’ object has a method to get the parameter list in the correct format for use in Java code: method.getParameterListText( ). This can be accessed in templates using the JavaBeans style property name (dropping the ‘get’) by:

$method.parameterListText

This is a lot easier to work with than other techniques—using XSL-T to massage XML specification, for example.

As well as a rich set of features for expressing substitution, the system may further provide a set of features for finding the templates. This allows the system to be used effectively in complex development scenarios (as J2EE is).

The overall build engine will be now be described in more detail, followed by the idea of “artifact generation”.

The normal build sequence according to one embodiment is as follows:
The overall build is started, external to the system. As we are in the Java world, this is likely to be done using an Ant build script. This eventually ends up calling the overall system script (Windows batch file or UNIX shell script) to start off the overall system task.
The system reads the XML specifications for the system, building the Java objects to represent the specification and also calculating properties.
The system walks through the specification, invoking Ant build jobs on each object for which they are available.

As well as a possible over-arching Ant build job, there will be many small component-level build jobs. This may be compared to manufacturing: we build a sub-assembly (e.g. a parameter on a method call); then we use the parameter sub-assemblies to build a method; and so on, all the way up to a complete application.

It is up to the template designer (J2EE expert) as to whether to use a build job on a particular object. In the J2EE model, about a quarter of the model objects have Ant build jobs associated with them—application, ejb-jar, entity, session, method and parameter amongst them. The build jobs can do any of the tasks normally available in Ant—compile using Java, create Jars, do EJB compilation, make directories, copy or delete files, etc. They also have the important capability of creating files using the Velocity template-processing task.

FIG. 9 illustrates the process of building a system from a specification according to one embodiment. The XML specification 910 is input into the system and the engine of the system 912 develops the specification using patterns, as described above. The Ant build for the session 914 is then initiated and templates 916 are accessed as required. Per-template Velocity tasks 918 are performed to generate a text file product 920.

The input to the build engine is the Java model object tree representing the model (possibly augmented by patterns as described above). The build engine builds the complete tree, bottom-up, by running an Ant build file for each object that includes a ‘build.xml’. As an analogy, this is a similar approach as in manufacturing technology: raw materials are turned into sub-assemblies; sub-assemblies are recursively assembled into larger products up to the top level, where the complete system has been generated.

The embodiment of the system described enhances Ant so that scripts can use properties and methods from the model object tree and the names created from the naming patterns described above, in addition to its own properties.

The operation of the build engine may provide advantages such as:
it is easy to build large-scale production jobs without having to specify the overall control
the build process may be automatically modularized into small sub-assembly Ant jobs
Java programmers will be familiar with the basic building block, Ant
all the existing Ant tools may be available, for example compilers, file management, dependency checkers etc.
build jobs can automatically follow local naming conventions just by using the right properties
as the system itself is run by Ant, the system can be the master build job or just a component in existing build jobs, further promoting modularity and large-scale assembly of systems.

A special Ant task for artifact generation may be used to turn templates into text files. This uses Velocity as its engine and the current model node as its context. Like Ant, Velocity is preferably adapted to give access to the run-time model objects, which are generated in such a way that the ‘#foreach’ language construct in Velocity walks through nested model objects by type (e.g. foreach method in a class, or foreach parameter in a method). Velocity also has the usual range of programming features—#if/#else/#end conditions, variables, file includes and macros being particularly useful.

Like Ant, Velocity uses the ‘${ }’ construct to indicate textual substitutions, and automatically assumes getters and setters for properties. A simple declaration of a class's attributes in Velocity (assuming the class model object is the current context) may be represented as:

#foreach( $attribute in $attributeList )
${attribute.type} m${attribute.name};

An alternative embodiment may use JSP/ASP-style templates:

<% for (Iterator i = enum.attributes( ); i.hasNext( ); ) { %>
<% Attribute attribute = (Attribute) i.next( ); %>
<%=attribute.getType( )%> m<%=attribute.getCappedName( )%>;
<% } %>

However, for most purposes the Velocity style is more concise and easier to read, and is clearer when generating XML for descriptors. Velocity uses reflection to access variables in scripts, rather than this being compiled in during the JSP-script compilation. This is important for supporting polymorphism, as described later.

There are advanced techniques, which may be implemented to make templates more modular and easier to maintain:
the ability to direct the output of a template back into the context object for use later. The result is that a new property of a model object may be created, implemented in Velocity. This may be used, for example, for method signatures and fields.
delegated properties, which can be set higher up the tree of model objects or in configuration properties
‘includes’ based on variable names. This may be used to call out to template files from a base template. For example, the J2EE EJB-jar build job may call out to an App server-specific build to create extra EJB descriptors.

As for naming patterns, patterns and templates can be over-ridden locally to allow local variations to be applied. For example, if additional functionality is required in a delegate, the architect can over-ride the delegate sub-pattern. Similarly, a file for rendering does not have to be found in a particular object's directory—it can be provided by a superclass. For example, the rendering for the Struts classes and JSP pages for a “wizard page” (which is a meta-model class) is provided by the “page” object, from which it inherits. This may enable an architect to build more specialised objects relatively simply: normally it is just a case of having the more specialised object generate particular properties; the base object can do the rendering, which is often the complicated part.

The Velocity Task

As outlined above, the <jwVelocity> Ant task is a task that converts an input ‘script’ into output text, using the current model object as its context for substitution values. It is only usable in projects, from the build.xml for a model object.

The parameters may include:

template—the name of the template file (the ‘script’). The format may be either:
a simple, relative filename (normally of the form X.vm). This file is searched for along the chain of models, as described in the Finding Files section.
‘object/scriptname’, where ‘object’ is used as the name of the object directory to use instead of the current model object, as described in Using Files From Other Objects

file—the output file. This will normally be expressed using properties in the environment to locate the file. For example, the EJB jar's task to write the ejb-jar.xml file is:

<jwVelocity template=“ejbJarXml.vm”
file=“${genDir}/META-INF/ejb-
jar.xml” />

The logic for writing out the resulting file checks the contents of the existing output file. If this exists and has the same contents what has been generated, the file is left unchanged. The program may produce an informational log, for example:

Velocity script page.vm did not change status of [file]

If the output is 0-length—the whole script is bracketed with a false-valued ‘#if’—then the resulting file will be deleted. The technique of using Velocity scripts bracketed with ‘#ifs is the preferred way to express conditional generation of files, because it ensures that if the condition changes, the file is correctly deleted. See Null Scripts below for further discussion.

overwriteFile—true/false indicating whether to overwrite an output file if it already exists. The default is true, so normally the file is overwritten. This is used to handle implementation classes, which are generated the first time but not then overwritten. Accordingly, overwriteFile is set to ‘false’ for these classes.

property—this produces a ‘snippet’ of code that is attached to the extra properties hashtable of the model object. (Even if the ‘object/scriptname’ format for the template is used, this still gets attached to the current model object.) The name of the property should be a standard variable name like ‘snippet’ (e.g. ‘property=“snippet”).

A snippet stays around after the build job has been completed, because it is attached to the current model object, which stays in place for the life of the build. This means it can be used by higher level objects. For example, here is some Velocity script from a constructor:

```
#foreach( $param in ${parameterList} )
  #foreach( $constraint in ${param.constraintList} )
          $constraint.snippet
  #end
#end
```

This loops through each constraint for each parameter on the constructor and pulls out any snippets of constraint code.

One reason for using snippets is they are easier to manage than the other alternatives, which are in-line code (which is viable if there will only ever be one reference to the snippet) and macros. In theory, you would think that macros would just as easy to work with, but it turns out that snippets are more modular and are easier to understand in the overall structure. Snippets have an important role in building systems using patterns as described in the next chapter.

mergeByUID—mergeByUID is false, by default: with this setting, the output file is overwritten in its entirety. When mergeByUID is true, the output file is a merge of the existing file and the newly-generated file. This feature is relevant to user-coded program files, where the code is hand-written by a developer but the class definition and the method signatures will be driven by the specification (in XML, or the UML model). These must be merged to keep the file in step. The merge is done by UID—methods are recognised by UID, enclosed in a comment (/*UID: . . . */), preceding the method signature. This setting only makes sense, and is only relevant to, output files rather than properties.

traceStyle—traceStyle affects how parse tracing will be generated while a particular script is being processed, when ‘traceParse’ is in effect. (#parse tracing follows the course of Velocity ‘includes’ to process a script; see later in this page for details.) The output from trace parsing is normally determined by the file extension:
‘code’ files—ending in ‘.java’, ‘cs’, ‘.h’ and ‘.cpp’—have traces added as Java/C comments. Similarly, snippets have trace lines added as Java/C comments, on the assumption that most snippets end up in code.
‘xml’ files—ending in ‘.xml’, ‘.xmi’, ‘sp’ (for jsp and asp) and ‘.aspx’—have traces added as XML comments
Other files have no tracing.

To change the default settings, use traceStyle. The three values are ‘code’, ‘xml’ and ‘none’. This only affects comments generated automatically by the traceParse processing of the JeeWiz engine. You may want to have appropriate comments in your scripts, or generate them as part of the script processing. This is viable and reasonable . . . and completely independent of the traceStyle feature described here.

As a convenience, if a snippet ends with a line-feed (which is common), the line-feed is removed before storage. This is done because otherwise you have to take special measures to avoid a spare line creeping into the renderings.

Normally only one output is produced—either ‘file or ‘property’ is specified. However, you can produce both outputs by specifying both ‘file and ‘property’ if that makes sense.

Configuration Properties

Configuration properties are preferably provided to determine the nature of the transformation process. They do this by transmitting configuration values into variables in patterns and templates. These properties are provided by the system to allow sensible architecture and builds to be created out-of-the-box, but they can be changed by architects. Application programmers will normally use configuration properties without needing to know their details or to alter them.

Properties are typically used to define local variations for:
the location of the (input) specification and the destination for the generated files. These values must of course be separate from the model or the templates—it wouldn't make sense to have a system that could only build to one directory.
naming standards of all sorts—file names, directory names, class name and JNDI names.

Properties can be defined in two ways:
in Ant, via the <property> task
in property files.

The syntax of property files is based on Java property files, but is preferably extended. Java property files have ‘property=value’ lines, where the value is a literal. This may be extended by allowing the values to refer to previously-defined values. For example, if the source files for a session are put in a directory below its parent's source directory, the property line could be: src=$ {src}/$ {session.name}

This facility gives a very easy way of telling JeeWiz how to create the system using company standards. Values in the specification give per-object values—the name of a bean, or whether a method is to be reflected on the remote interface. Definitions in properties can define new values in a general way. One company might want all session EJBs to have a ‘SessionEJB_’ appended, which can be implemented by a property such as

BeanName=SessionEJB_${name}

Another company might want a ‘BeanImpl’ suffix, which would be done by a property

BeanName=${name}BeanImpl

Properties different from templates may be useful in allowing templates to be written in a more general way: they would refer to $BeanName. The actual value of the bean name can change without affecting the templates.

Properties can be defined in a variety of files:
for a complete system
for a particular build if it is a subset of the complete system
for a particular type of component
for the assembly of a specific component.
   Controls

As described above, ‘language controls’ may be used by the templates to determine and generate language-specific code to be inserted into the generated code.

However, the language control is simply one example of a ‘control’, which may be defined as an object that is designed to produce text at generate-time. Controls are similar in concept to JSP tags or ASP.NET controls, but they are preferably designed produce their output at generate-time rather than run-time. Other controls which may be provided include data-type controls and UI controls. Controls allow very detailed variations in generated code to be declared in one place and used throughout the renderings. This is advantageous for extensibility and ease of maintenance of the system, as described in more detail below.

Part of the difficulty in automating real programming tasks is the variation required at a very fine level of detail. By way of example, the following is a small snippet of generated code:

public void setLastName( String LastName )

throws ValidationException

```
  {
    if( LastName != null )
    {
      getLogger( ).trace( “-> Set( LastName ) = ” + LastName );
      LastName =
      JeeWizUtils.normaliseXMLSchemaString( LastName );
      getLogger( ).trace( “After filter expression, set( LastName ) = ” +
LastName );
      if( LastName.length( ) < 1 )
      {
        throw new ValidationException(
        “LastName length = “ + LastName.length( ) + ”, minimum
        allowed = 1”);
      }
      _vo.setLastName( LastName );
```

The code incorporates knowledge about:
how tracing is to be done
the nature of the value being processed
whether or not it needs transformation to an internal format
the user's standards for handling exceptions.

This knowledge is mixed in a very detailed way in the code. If this knowledge was to be written directly into the meta-program the result is complex and effectively impossible to reuse in other environments.

To simplify meta-programs and support re-use, controls may be provided, which are generate-time objects that encapsulate the detailed knowledge of the technology.

The technique may advantageously be used at generate time and the controls may advantageously be attached to or associated with the meta-models. This may allow the appropriate variant of a control (for C# or Java for example) to be automatically loaded at generate-time.

A wide variety of controls may be provided, for example:
language controls, generating Java or C#
logging controls, to generate the correct code for logging and tracing
datatype controls, handling internal/external conversions and formatting for datatypes
database controls, to generate the correct SQL code for interfacing to database
user interface controls, which handle the mapping of a datatype into a visible representation.

The controls may be implemented in Java. However, a more sophisticated framework for controls may be provided, which has lower-level details of controls implemented in Java but higher-level features implemented in the Velocity scripting languages. The mechanism to do this may be by tagging methods in a control as ‘overridable by Velocity’: if there is a Velocity script available (using the standard lookup procedures) then it will be called; otherwise the Java implementation will be used. This may make it easier to write complex controls, and also easier for architects to override features: again, the meta-model-based overriding may be used to allow features to be overridden. In other words, the controls may provide the best of both worlds: the rigour and speed of Java; and the flexibility and development speed of Velocity script.

More Details of an Implementation of Controls

The ‘Controls’ aspect of the system will now be described in more detail, including the creation of controls, which may be used to help build patterns and templates cleanly, by encapsulating detailed renderings in the controls.

Controls have similarities to JSP tag libraries or .NET controls. However, controls preferably operate at generate time—when the system is being run.

In writing templates (and, to a lesser extent, patterns) you often have to deal with the properties of the object you are rendering. For example, to initialise a variable to a ‘nothing’ value you will have to say:

$type $name = null;

for an object reference or, for a boolean:

$type $name = false;

The controls may enable a user to generate the variability here—‘null’ or ‘false’, or ‘0’ for integers—without resorting to the Velocity #if statement.

$type $name = $jwc.nullValue;

The above example is fairly trivial, but this becomes much more important when we want to render data to screens, where complex HTML needs to be generated.

As well as dealing with the complexity of the scripts, controls allow you to extend or modify the behaviour of scripts without touching the scripts themselves. Controls are much smaller and simpler than the scripts that use them so it makes sense to modify controls rather than the underlying scripts. Similarly, in situations that the original scripts did not cater for, you can extend their functionality by adding new controls.

Controls may be defined in meta-models. Meta-models are loaded dynamically for each build, as defined by the configuration—.NET/C# for one build of a model, J2EE/Java for another build. Dynamic loading allows the same template or pattern to be varied in two ways:
1. Different meta-models can be read in. The pattern may reference a ‘TextBox’ control: this will produce different results depending on whether .NET or J2EE is being used, because a different control will be read in.
2. ‘standard’ controls (e.g. the standard .NET TextBox control) can be overridden by a control defined in a company-specific meta-model. For complex renderings, it is easier and more future-proof to override a control than to change a standard pattern or template.

As implied above, the first approach in implementing a rendering is to write ‘#if’ statements. This requires no superstructure and is quick.

The next approach, to factor standard sequences in the rendering, is to create a Velocity #macro( ). This approach is like a generate-time subroutine—it factors out the common sequences, adding variability where necessary via parameters. This approach supports easy overriding: the override is just put in the VM_global_library.vm file in the higher level meta-model. This means that the standard functionality of scripts can be easily overridden by local teams.

However, macros are not convenient when
there is state involved—we want to reference some external object, but macros are stateless.
there are multiple outputs required—we will need to build a range of macros, not just one or two
there may be additions or changes in the future—we must plan for easy expansion, which is not possible with macros, because the names are fixed.

Any of these situations indicate that the controls described herein are a better approach, despite the extra investment in structure required. Controls are preferably able to:
hold state—they are individual instances of Java classes
produce any number of outputs—‘outputs’ are implemented just like JavaBean properties, as methods on Java classes
added to or changed using overriding techniques. New controls can be added by architects and referenced in models; existing controls can have particular outputs changed by overriding the Java method.

The process of defining controls according to one embodiment will now be described in more detail. Although the controls are defined as part of a complete meta-model, controls are different from meta-model objects:
Meta-model objects are defined in meta-models to define what can be used by modellers (business analysts) in defining a model or specification.
Controls are solely for the use of architects to define the rendering of models; they cannot be referenced in a model (specification). Controls (and related types) are a very small extension of Java objects.

In other words, there is a distinction between controls and meta-model objects: they are defined, built and used quite differently. Nevertheless, they gain all the benefits of meta-model overriding. Controls are defined in their own meta-model environment. The key objects in this meta-model may include:
jar—this is the jar that will be produced.
jwcontrol-type—this adds a way of categorizing and checking controls
jwcontrol—individual control definitions.

Here is an example aggregated definition showing the interaction of these concepts:

| | |
|---|---|
| <jar | package=“uk.co.nte.jw.components.- |
| | object” |
| | name=“jwcontrols.jar” |
| | > |
| <jwcontrol-type | name=“DataTypeControlType” |
| | lookup-name=“datatype”> |
| <interface | name=“IDataTypeControl”> |
| <method | name=“getNullValue” |
| return-type=“String”/> | |
| </interface> | |
| </jwcontrol-type> | |
| <jwcontrol | base=“int” |
| | type=“datatype” |
| | > |
| | public String getNullValue( ) |
| | { |
| | return “0”; |
| | } |
| </jwcontrol> | |
| <jwcontrol | base=“Date” |
| | type=“datatype” |
| | > |
| | public String getNullValue( ) |
| | { |
| | return “null”; |
| | } |
| </jwcontrol> | |
| </jar> | |

The key characteristics of this example are:
The controls are packaged in a jar. By convention, this jar is called ‘jwcontrols.jar’, but any unique name ending in ‘.jar’ will do. The jar is place in the meta-models control (e.g. jeewiz/resources/object/control) directory, alongside the components.jar. To save duplication of packages, the package is by default the same as the meta-model package.
Controls are typed, by jwcontrol-type elements. The control types can be looked up by their class (DataTypeControlType) or given a shorter lookup name. In this case, the lookup name is defined as ‘datatype’. This is used from jwcontrols when the controls are built, and in the Velocity script at generate time when controls are found. Other types of controls might be languages (C# or Java) or UI controls.
Control types define an embedded interface that all controls of that type must adhere to. This interface must be given a name; by convention it is ‘IcontroltypenameControl’—e.g. IDataTypeControl.
Individual controls are defined by jwcontrol elements. They must be typed, using the name of one of the jwcontrol-type elements—either the class or the lookup-name if there is one. They should also define implementations of the methods required by the control type's embedded interface.
The ‘base’ property shown on the jwcontrol's above allows you to specify a base name (like int) and leave the rest to the rendering.

For jwcontrols, the base is used as the lookup name but it sets the name of the generated class to the base+‘Control’.

For jwcontrol-types, the base sets the lookup name, the interface name to IbaseControl and the generated class name to IbaseControlType. For example, a control type whose base is set to ‘ui’ has a lookup name of ‘ui’, an interface of ‘IuiControl’ for its controls, and the generated class name of ‘uiControlType’.

The primary purpose of the controls is to output text that can be inserted into Velocity rendering (template or pattern output). This may be done by defining properties via public ‘get’ methods on an individual control that return a string—the string will be inserted into the rendering.

The ‘get’ methods are defined as usual for methods, either by defining <method> tags inside the class or by inserting text—as XML character data—containing the Java definition of the method into the <jwcontrol> specification. This text is simply inserted into the body of the control class.

For example, here is the method to extract the value of a textbox control in .NET, embedded as text in the <jwcontrol> meta-model object:

```
<jwcontrol . . .>
    public String getValueText( )
    {
        return type +“.Parse(” + id + “.Text)”;
    }
<jwcontrol>
```

When the system processes a model, an instance of the control will be created as described below and the template/pattern writer may use the ‘valueText’ property. This will result in a call to the getValueText( ) method. The method returns an expression for getting the value text, which in put in the generated code.

The previous section covered the text inclusion feature of controls. Additional features of controls may include:
Names. Controls have class names and lookup names. By default they are the same, but the lookup name can be specified separately in the ‘lookup-name’ or via the base feature. For example, the concept of a textbox on an HTML form will be represented by control whose lookup name is ‘TextBox’ but whose class name is TextBoxControl.
Type. Every control must define a type. This is the type of the control as defined in a jwcontrol-type, not the Java type. For example, two common examples of control types: datatype controls and ui controls. An architect can define other types of controls in meta-models as described later.
   By convention, we use a simple name, like DataType, for the name of the control type. Individual control names have ‘Control’ on the end of them, such as ‘DateControl’.
Inheritance. Controls can extend from each other using the ‘extends’ property. The ‘extends’ property must refer to a control of the same type, defined in this meta-model or a meta-model available at generate time.
Bases for controls. Controls can be defined alongside jwclass's, so controls can extend a base class.
Lookup by name or attribute. Say we have a ‘Calendar’ UI control implemented as a control. This will be advertised by name automatically, so a template writer can get the ‘Calendar’ control. Alternatively, it can be advertised as suitable for handling Date datatypes. This information is made available—at design time—as one of the valid options for rendering dates.
Overriding. While controls must have unique names within their type in one meta-model, names can be re-used in higher-level meta-models. For example, the Java and C# meta-models define a datatype control called date. This has very basic properties. This is overridden by the date control in J2EE and .NET levels. In J2EE, the ‘date’ control has specialised properties for rendering to Struts.

Overriding may be done by name within the type of the control. Note that a control in a ‘higher’ meta-model can inherit from a control it overrides. For example, the Date control in J2EE extends and overrides the date control in the base.

One embodiment of the architecture of controls will now be discussed in more detail.

The name and type properties are both required in a jwcontrol. Case is significant in the name of the control. By convention, put ‘Control’ on the end, e.g. ‘DateControl’.

You can also define
A lookup name. This is how the control will be looked up. It is normally easier to look up something like ‘Date’ than DateControl.
A base name. This will (a) set the lookup name to the same as the base name, and (b) create the class name by adding a ‘Control’ suffix.

In other words, a base of ‘Date’ will create the class DateControl, which can be accessed at runtime as ‘$jwControlManager.datatype.Date’.

Note that normal class naming conventions are not applied. In other words, as base of ‘int’ will create an ‘intControl’ looked up as ‘int’; a base of ‘Int’ will create an ‘IntControl’ looked up as ‘Int’. (However, due to the file system ignoring case, you won't be able to create an ‘int’ and ‘Int’ control in the same meta-model.)

Do not define a constructor for the control class: the system generates and uses a no-argument public constructor. The property methods should be public and return a String value which will be inserted into the rendered text by Velocity. Any other facility of the Java object model's jwclass can be used.

Code in controls is rendered—you can use Velocity $ variables and they will be converted to the value by Velocity.

Because the control meta-models are based on the Java object meta-model, Java controls (via $jwControlManager) and variables such as $lang for the language will be meaningful.

Another way to get reusability is via Java inheritance: make a derived control inherit from a base control. If the base control is in a lower meta-model, you must take care if the lower meta-model itself is variable. For example, if you build a control for the Java meta-model and inherit from it in the business object controls, you will also need to provide a control with the same interface for C# if you want to support both languages. The controls must be typed. A control type is also defined in the meta-model, using the <jwcontrol-type> tag. The name of the control type is the name that the individual controls use in their ‘type’ property.

You can also define the same extensions as for controls:
A lookup name. This is how the control will be looked up.
A base name. This is the same as for controls, but the suffix ‘ControlType’ is added.

In other words, a base of ‘Datatype’ will create the class DatatypeControl, which can be accessed at runtime as ‘$jwControlManager.Datatype.Date’

The ‘base’ in control types also gives a default for the name of the embedded interface—it will be IbaseControl.

Control types have all the normal properties of other model objects: you can extend them, add properties and methods, and so on.

In addition, a control type must define an interface. This is done in-line, as a nested ‘interface’ element, which defines required methods for a control—and any relevant constants. The interface name may be omitted if a base is defined; the default is the ‘IbaseControl’,

The system adds this interface onto each individual control's class in the ‘implements’ clause. This therefore requires each individual control to implement the interface defined by the control type.

| | |
|---|---|
| <jwcontrol-type | name=“datatype” |
| | > |

```
  <description>
The datatype control type.
The name of the interface is omitted,  so it defaults to
IDataTypeControl.
Note that the interface defines the getNullValue( ) method.
The return-type of getNullValue( ) is omitted because it defaults
to ‘String’ - which is what control properties should return.
  </description>
  <interface>
```

| | |
|---|---|
| <method | name=“getNullValue” /> |

</interface>
</jwcontrol-type>

A ‘control manager’ may be provided to give access to the controls. This may be referenced in Velocity scripts as ‘$jwControlManager’. The first step in referencing a control is to know its type. The control manager maps from type names to individual control type managers. The syntax to reference the control type manager is:
‘$jwControlManager.datatype’ if the type name is a constant (which it usually will be)
‘$jwControlManager.get($controlTypeName)’ if the type name is in a variable.

To access an individual control using the control name, the same approach is used:
‘$jwControlManager.datatype.Date’ if the control name is a constant—this gets the Date control
‘$jwControlManager.datatype.get($controlName)’ if the control name is in a variable.

This is the most likely scenario for use of the control type name and control name.

When an individual control is accessed, a new control object is created, cloned from a prototypical object. This is important, because in some cases state is set into a control. If the access is done after state is set it will lost. In other words, don't do this:

$jwControlManager.datatype.get($controlName).setState( $s ) . . .
$jwControlManager.datatype.get($controlName).someProperty

Instead, save the accessed control in a local variable:

#set( $jwcontrol = $jwControlManager.datatype.get($controlName) )
$jwcontrol.setState( $s ) ...
$jwcontrol.someProperty

The controls may further be provided with ‘abilities’. This is a declaration of the capability to perform a function, much like implementing an interface in Java, declares an ability to perform the contract of the interface. For example, in the UI realm, UI controls declare their ability to handle data types:
textbox controls can handle strings, all the numbers and dates if implemented
radio buttons can handle choices and booleans
calendar controls can only handle dates.

Abilities are standard string lists, so they can be specified as comma-separated strings or as nested elements in XML:

| <jwcontrol | name=“textbox” |
|---|---|
| | type=“ui” |
| | > |
| <ability>string</ability> | |
| <ability>numeric</ability> | |
| <ability>default</ability> | |
| </jwcontrol> | |
| <jwcontrol | name=“calendar” |
| | type=“ui” |
| | ability=“date” |
| | > |
| </jwcontrol> | |

The meaning of the ‘ability’ is defined by the control's type. For a given datatype, there is only one dimension to ‘abilities’: you can't qualify an ability with the type of ability being declared.

The process of building controls according to one embodiment may include the following steps:
1. Some of the infrastructure for controls is in the engine, so the first project to build is the engine—jeewiz/engine/build.xml.
2. Next, build the jcontrol meta-model via jeewiz/resources/jwcontrol/build.xml. This is a small extension of the object meta-model.
3. Then build your stack of meta-models: base, object, bizobject etc. There is some circularity here: object depends on jwcontrol, which depends on object. It is rarely a problem in practice: if necessary, delete resources/object/jwcontrols.jar before rebuilding the stack.
   Layout of the Model and Generated Code

When a complex model of a system is generated, and when code is generated from that model, it may be important to ensure that the model or code is set out in a way that is easily comprehensible, to enable sections of the model or code to be identified and understood. Hence embodiments of the system described herein preferably include means to govern the layout of the model or code.

Using a scripting language like Velocity may provide the advantage that literal text and substitution instructions can be intermixed. For example “class ${className}” is a Velocity snippet that has literal text (“class”) followed by a substitution (“${className}”). A problem may arise with the layout of complex renderings, where there are multi-level Velocity processing directives (#if . . . #end, #foreach . . . #end) which may be interspersed with multiple levels of generated code. If these are interspersed, it may become difficult to distinguish the Velocity logic from the generated logic. In a manually-written program, the solution to this is to use whitespace; unfortunately a naive use of whitespace leads to unattractive and unnatural-looking code which can be difficult to read or interpret.

According to one embodiment, a series of features may be provided to support easy layout of generated code. One feature may comprise the optional ability to ignore leading tabs; this may be used to indent both Velocity directives and generated-code to show the flow of control. A further feature, described in more detail below, may be the ability to direct indentation (i.e. indent more, indent less) of the following output. This may make it possible to conditionally indent the generated text: for example, if a conditional is output, it can have the “indent more” marker attached and the following generated lines will be indented. These features may be allied with others (like begin/end brackets) so that the same renderings can be used to produce code that conforms to users' layout preferences: even in the same team, different members can produce generated code with a different layout.

In addition a ‘traceParse’ command may be provided which places comments in the output, whose style depends on the format of the output, telling which template rendered the output. There may be multiple files (included via the #parse mechanism) that go into a rendering—this feature preferably logs them all, at the start and end of their generated output.

To govern the layout of code a variable may be defined for how to start a ‘block’ and what indentation level to use.

Indentation in Generated Text

Indentation in the text generated by Velocity scripts may be important, particularly for produced code like Java source files. This indentation is normally determined by the Velocity script, which can be laid out in an acceptable format. But when inserts are used, multi-line inserts can potentially disrupt the generated layout. For example, when there is a method whose implementation is present in the specification, the specifier does not know the indentation of the generated scripts—and nor should he or she.

To solve this problem, embodiments of the present system may provide an ‘indent’ facility. This is triggered at the start by a special character (binary 1). This is followed by the indentation text to be added to the current indent. Normally the indent string is a number of spaces, but it can be any string—for example, it is also used to lay out Javadoc comments with ‘*’ as the indent string. The indentation text is terminated by a second special character (binary 2). This causes the system engine to add the additional indent on every line following until the matching end character (binary 3).

There are macros in the base model (see jeewiz\resources\base\control\system.properties) under the following names:

indentStartHeader=\u0001
indentStartBody=\u0002
indentEndBody=\u0003

The standard indentation pair is $i/$u—in other words, $i starts an indentated block and $u marks the last line. If these are the first things in the line, they affect the current line, otherwise the next line. These are sometimes used for laying out XML and HTML text, as in:

<tr>$i
...
$u</tr>

This indents the line after the ‘<tr>’ and unindents on the ‘</tr>’ line. The standard brace indentation pair (for Java/C block start, end and indent) are named ‘$b’ and ‘$e’.

Trouble-Shooting Velocity Scripts

If problems are encountered during the development of Velocity scripts, the following issues may be considered and/or tools used to overcome the problem:
1. Look at the Velocity log file ‘velocity.log’ in the project directory (the one above the specification). Any [warn] or [error] logs here can indicate problems.
2. Don't be afraid of putting debug comments into the script. It is normally quicker to do this than to puzzle it out. Sometimes it is awkward to use this technique because comments are difficult to add or are thrown away. This particularly applies to patterns, where the XML comments are thrown away. In this case you can use the $this.log(“ . . . ”) feature. Every model object supports the ‘log’ method, which writes a string to the console rather than to the generated text. This is non-invasive: it does not alter the generated text.
3. Another debugging aid allows you to trace the “#parse” calls in one Velocity script. To use this, say “$this.traceParse( )” at the start of the routine you want to trace. This will add a comment and indentation for every included ‘#parse’ called.
4. Many problems are due the automatic conversions that Velocity does, such as turning $object.prop into Java's object.getProp( ). If in doubt, use ${object.getClass( )} to tell you precisely what class you are dealing with.
5. Use the formal syntax—‘${x}’—rather than the informal ‘$x’.
6. If you need to construct a string involving substitution and the double-quote character, you will need to use a variable like $q: #set($q=″″). You can then use substitution to put the double-quote character into a string: “${q}${x}${q}” will surround the value of $x with double-quotes.
7. If the problem is with the wrong files being included, use the traceParse mechanism, which will add comments into the generated files to inform you where an inclusion came from. You can set this for the whole build by putting ‘traceParse=true’ in your ‘.jwp’ file. Alternatively, you can set it for a single file by adding ‘$this.traceParse( )’ into the script you want to debug.

8. If all else fails, get a dump of the XML produced and run in verbose mode:

ant “−Dpass=−v” “−Dpass2=−Ddump=aggregate.xml”
>redirectOutput.txt

The Framework

The system is preferably provided with a framework, which may be used to integrate and control the operation of the features described above. This may allow the user to implement the system without having to program these features explicitly. For example, if an entity pattern creates another object, such as a derivative object (e.g. an interface for some services provided by the entity) or an object in another tier (e.g. a data view), the effect of this may be to fire more patterns, do more validation and eventually create code of configuration via templates. The whole process, and its meaning in terms of the nature of the objects created, may start out with the creation of a single file using a specific name. Aspects of one embodiment of the framework will now be described in more detail.

The Rendering Process

The framework may use the names of files, the location of these files, and the existence of various methods, to invoke engine features such as those set out below:
Lookup may be based on the rendering inheritance scheme described earlier. In the present embodiment, it applies to all files with the ‘well-known’ names described below, and to templates mentioned in the assembly process. The lookup scheme enables the system to override templates from a higher-level meta-model without changing the lower-level meta-model or disturbing other parts of the rendering.
Pattern files: ‘normal’ patterns are called “includeSpec.vm”. The existence of this file fires the main pattern phase: its output is an XML document, which is incorporated as additional specification. Two further types of patterns may be provided: (1) the “preIncludeSpec.vm”, which is fired first (in a top-down pass), and is used to patch up the current object. For example, using preIncludeSpec.vm for an entity, we add primary key fields if they do not exist, because databases require that a table has a primary key (2) the “extraIncludeSpec.vm”, which is fired subsequently in a bottom-up pass, and is used to fix up relationships between model objects. A particular use of this may be to create new architectural tiers in the ‘wrong’ direction: normally we create new architectural tiers from a tier on which the new tier depends: the logical dependency is from new to old. If we want to create a pattern to create an object on which the current object depends, this may be done in the extraIncludeSpec.
Multi-phase patterns can be constructed by using a ‘next-pattern’ property on the current object.
Related to the concept of patterns, there is an involved (13-step) process may be implemented for firing patterns interleaved with model-driven validation, Java-level initialisation/validation and reordering children, orchestrated by the system. In a preferred embodiment, the developer has to know how to use this feature, but he does not have to program it. The correct use of the steps in this process reduces development time, and allows point overriding of lower-level patterns/validation etc.
Reordering. One of the 13 steps described in the previous point may comprise the reordering of children. This is necessary so that dependent objects are processed after the objects they depend on. This feature requires experience of building multi-tier patterns. In preferred embodiments, the reordering does not have to be explicitly programmed: it is triggered by tagging a meta-model object by its relative position within its parent.
template.properties—this feature may be used to implement the second dimension of lookup.
component.properties—this feature may implement naming conventions
system.properties—this may provide default top-level properties for a meta-model. These can be used in templates and patterns, and overridden by the users main control file (e.g. buildjwp).
model.properties—this may define the properties of a meta-model, and particularly the next lower meta-model in the stack. The next lower level can also be defined by a configuration property, which means that meta-models can be inserted by changing the configuration property.
   Tool Integration

Another aspect of the present embodiment of the framework is the integration between the main components: the Java version of the model, Velocity and Ant when run as part of the assembly process. This integration makes it possible for Velocity and Ant to read values from the complete specification (i.e. the whole tree of objects) as well as the configuration properties (system.properties, component.properties and buildjwp/build.properties) using the same syntax as for simple Velocity value-referencing. Special features ($parent, $children) may be added to make it straightforward to navigate the specification tree. For example, a preferred technique for creating files in Ant assembly processes is always to use a variable name defined in the component properties; this may allow users to change the operation of the Ant file (and hence the naming conventions used in the build properties) simply by overriding the component.properties in a higher-level meta-model. It may also be possible to save values in the Java objects representing the specification from Velocity (but not from Ant). This feature may make multi-stage processing simpler: work lists can be constructed at one stage (in patterns or early-stage templates) and then used later (in later patterns or templates).

Search for Values

By providing in Velocity a reference to the current object ($this), the system may provide a feature to restrict value references to the ‘current’ Java object in the specification ($this.prop), or to access generally-available values ($prop).

Generally-available values may be searched for on the current Java object, then up the tree of objects, and then out into the configuration properties set in the stack of meta-models (system.properties) and the user-configurable files (buildjwp, build.properties). This may provide the facility for overriding, either in higher-level meta-models or in the configuration for the particular build. However, there is one particular technique that depends on the combination of the hierarchical search feature and the fact that generally-available properties can be stored per object too. This is the ability to define containers, for example if node A provides a ‘$containerDirectory’ directory string to its children; its child node C, uses the provided ‘$containerDirectory’ value to set some of its own properties, and then resets the ‘$containerDirectory’ value, typically to a subdirectory of node A's original container directory. This is a recursive structure (any number of layers are possible) and may allow lower objects to build their own components without knowledge of how they are going to be used. We can use this structure in the J2EE rendering to build applications based on a passed-in ‘$buildContainerDir’, which then resets the value for use by the contained Jars. This technique means that the applications may be further contained as part of larger builds which can use the same technique, without disturbing the application or Jar builds.

Properties in model objects do not normally display a similar upward-searching capability. However, a special feature may be provided in the meta-model-building system to allow this—the ‘delegated’ property, which is described above. When this is turned on, the value, which is present in the Java model object, will search up the tree of specification objects for the first value that is set; typically this will pick up a default set by meta-model builder in the system.properties or overridden by the current generation's configuration in buildjwp. However, the value can be set on a particular object and then becomes the definition for that node and its children. An advantage of this may be that the behaviour of particular subtrees can be easily changed. For example, logging in .NET's user interface domain is different from the logging in the server domain. This can be easily accommodated by the meta-model builder setting a delegated property in the user interface ‘assembly’ object.

Simple Input Conversions

Before building an object tree, it is often useful to change the input XML in simple ways. These changes apply to patterns too.

To change names, (buildjwp, build.properties, system.properties) the ‘convert(oldname)=newname’ syntax can be used in the configuration files. This changes occurrences of ‘oldname’ to ‘newname’. This may be used in two ways. First, equivalent objects in different tiers (e.g. data-view/entity) can be swapped: if the incoming specification is defined in terms of the objects in one tier, it can be converted into the objects of the other tier. Second, equivalent objects from one meta-model can be changed into objects from another. For example, the Java meta-model has the concept of a ‘Jar’, for which ‘Assembly’ is the corresponding C# term. Using ‘convert’, we can convert a Java specification into C# and vice versa. This approach may be significantly easier to manage than building a separate transformation stage.

As a further feature, if the ‘newname’ in the convert feature is ‘-’, nodes of this name (i.e. whose XML tag is the oldname) will be skipped and children of this node will become children of the ignored node's parent, that is nodes may be ignored. If the ‘newname’ is ‘*’, nodes of this name and all children will be ignored. Some transforms, like UML to the present system, have significant amounts of information that can be ignored (e.g. the graphics information, or redundant layers that are simply self-descriptions that can be deduced and so are omitted in the preferred format). This makes processing faster and allows the system to accept larger input models.

Undefined Elements and Attributes

As discussed above, meta-models can describe and constrain input XML documents. This definition describes what is expected and valid values and combinations in the expected input. The system can be run in ‘strict’ mode that limits any input to what is expected; any elements or attributes that are not defined in the meta-model(s) cause an error.

Alternatively, the system may not be run in strict mode, which specifically allows elements or attributes not defined in the meta-models. This approach may allow new variants of input specifications to be read by an old rendering. It may also allow documentation sequences to be carried, holding unconstrained XML to be read in and then written out (using a feature to dump the Java objects as XML).

Unexpected elements have no Java model object class associated with them; instead, there is a catch-all Java class, ExtraBuildComponent, that is used to represent them. This automatically adopts the ‘top’ of the unexpected element's tag, puts attributes into an overflow area for attributes so they can be referenced from Velocity in exactly the same way as predefined attributes, and constructs lists for nested elements so they can be traversed in the same way as predefined elements.

Unexpected attributes are put into the same overflow area as mentioned in the previous paragraph, so attributes can referenced from Velocity in the same way as predefined elements. This same area may be available for used by Velocity to store extra values into, including snippets of code generated in one template or pattern but used later.

Reuse of the Framework for Controls

The controls advantageously re-use a lot of the framework features to achieve their power, for example:
they may be defined in their own meta-model
the generation of the Java objects may be done using specific renderings, which may allow slightly different generation based on the type of object being generated (data-type controls are generated slightly differently than UI controls)
component.properties can be used to set values into the control: these can reference configuration or model values, which may allow a user to configure controls to generate different code at run-time

The combination of these features, re-using existing ideas and implementation features, may advantageously give controls (and the framework overall) expressive power.

Validation

As set out above, the system model may be validated at a number of points in the system generation. Preferably, the model is validated at two points. First stage validation may be performed on the specification that is received to ensure that naming and model-generation patterns will work properly based on the properties as read in, such as required fields being present or that required references to other objects are valid. A second stage of validation may be used after application of the patterns to ensure that the templates will work, so they may provide an initial check on the operation of the patterns.

The validation steps may produce error messages in the event of a failure but, in addition, may also include one or more of the following features:
The validation expression, which may be implemented for example in Java.
Identification of the node in error; this may be produced automatically in the generated code to enable the developer to determine the source of any problem quickly.
Extra fields or expressions that can be used to qualify the error message.
Set-up code—complex validations using cross-model references to other code may require a set-up method to be called to initialise the object's references.
   Further Aspects and Features of Patterns

A further feature that may be implemented in conjunction with the present system is the ability to write patterns. This may enable a system designer to create on-the-fly additions to the specification. That way, it may be possible to convert a basic object into a number of other objects, or to embellish its specification.

The description below describes in more detail the mechanics of the pattern features and how you use them to build patterns.

To understand why patterns are useful, consider an embodiment of a pattern, which may be described as a ‘singleton’. The singleton has a ‘getInstance’ method that gets the singleton instance of the class, and a static instance variable holding the single instance once allocated. The singleton will also have other business methods or methods. In other words, a singleton is basically a class, but with some added bits. Without using patterns, it is possible to add these on using a special-purpose template at the rendering stage, as illustrated below:

```
class $name
{
  static private $name instance = null;
  private $name( )  { } // prevent others using
  public $name getThe${name}( )
  {
    if( instance == null )
      synchronized {
        if( instance == null )
          instance = new $name( );
    }
    return instance;
  }
  //  render other methods.
}
```

This is a direct implementation of the singleton pattern. However, the big problem is that we now need to render all the other members in the same pattern. This would require duplicating all the existing code in the rendering of ‘jwclass’. Furthermore, we have a restricted implementation of the ‘getThe . . . ( )’ method: what if we wanted to log or trace this method, in line with prevailing standards?

A preferred approach would be to add the extra bits in at the specification stage. In other words, what we would add looks like:

| <field name=“instance” | |
|---|---|
| | type=“$name” |
| | default=“null” |
| | static=“true” |
| | access=“private” |
| | /> |
| <constructor access=“private” | |
| | implement-in-base=“true” |
| | /> |
| <method | name=“getThe${name}” |
| | return-type=“$name” |
| | access=“public” |
| | implement-in-base=“true” |
| | > |
| | if( instance == null ) |
| | synchronized { |
| | if( instance == null ) |
| | instance = new $name(); |
| | } |
| | return instance; |
| </method> | |

By adding on at the specification level, we can use all the facilities of the standard rendering. Creating a pattern becomes a fairly simple process of creating some extra XML to describe the additional specification. It is separate from the basic rendering patterns and from the templates that will create the eventual build products (e.g. Java or C# class).

This matches how patterns and components are described: they describe derivative objects, fields and methods and their characteristics, but little or nothing about the rendering in a particular environment. The pattern may be used to generate more specification; the rendering into the environment is then added on.

In the present embodiment, there are three ways to signal that a pattern should be used.

The most common technique is to create an ‘includeSpec.vm’ file. This defines a default pattern to be applied to all objects of a class. It is therefore used to convert a specification object into something richer. The fact that a pattern is being applied is not visible in the specification itself: it is implied by the existence of an appropriate includeSpec.vm file.

Any object can also have patterns specified in the specification. These are specified as a comma-separated list (or as a list of nested ‘<pattern>’ items). This approach is used when we want to embellish a fundamental rendering, without disturbing existing patterns. For example, this is how we would specify the singleton pattern. It can then be applied to normal classes, business objects etc.

Sometimes, within a pattern, it is convenient to express the pattern in stages. For example, in the J2EE system for entity EJBs, we create a boilerplate ejbCreate method that takes a value object. But then, the ejbCreate methods are handled specially in the entity EJB patterns. So it makes sense to use two stages to the pattern: first, define the ejbCreate; then, do the pattern that will further process this.

This is done using the ‘next-pattern’ attribute on the current object. The first-stage pattern sets the “next-pattern” attribute. The system then recognises this immediately after processing the previous pattern or includeSpec.vm, and runs the next pattern. This is a ‘one-shot’ attribute: it is reset before the next pattern is run. However, the next-pattern attribute can be set in a next-pattern too, so in theory any number of stages can be added on to a first pattern.

In the general case, there can be many pattern attributes values in the specification, which could invoke their own ‘next-pattern’, followed by the includeSpec.vm, which may also have ‘next-pattern’s. Regardless of how a pattern file is recognised, the generic term ‘pattern’ may be used for these files that will add onto the specification.

It is preferably possible to create hierarchies of patterns (which is not possible with templates because they are always the last step in the process). For example:
Simple classes are represented as model objects and are typically rendered with a template (they are ‘level 0’ say—they do not create further specification objects).
Pattern components create one object based on another, or add in attributes to the current object. For example, creating a single proxy class from a business object would be a pattern component. These can be thought of as ‘level 1’—the most basic part of patterns.
Patterns to do something useful typically involve creation of multiple components. For example, the business object's pattern may involve creating factories and interfaces as well as a proxy class. So these are ‘level 2’—we are aggregating the level 1 pattern components.
Because patterns typically create other specification objects, there will normally be a cascade of patterns firing as a result of one pattern. While these will often result in ‘smaller’ objects (e.g. entities create interfaces), it is also possible for patterns to create ‘big’ objects in adjacent tiers—for example, an entity can create its corresponding data-view automatically. This sort of ‘level 3’ pattern is called a ‘mega-pattern’: it can effectively create whole tiers from adjacent tiers.

It turns out that mega-patterns would be impractical to write as templates, but are remarkably straightforward as patterns.

In the present embodiment, patterns are rendered via Velocity scripts. If a pattern or next-pattern does not have an extension (e.g. ‘singleton’) the ‘.vm’ extension is added (so ‘singleton.vm’ is rendered).

Patterns are rendered in the context of the current specification object, so all the names that may be used in a normal Velocity script are available. This particularly includes any names set by the component.properties mechanism. For example, in a business object class, ProxyClassName is defined in component.properties, so you can (and should) use $ProxyClassName wherever you need to refer to the proxy class name.

Patterns are searched for in the same way as other Velocity scripts. The first file with the right name is used: in the present embodiment, there is no addition of pattern files (like there is for component.properties for example). The fact that pattern files are searched for means that you can use the pattern on sub-classes of the intended object type. For example, the singleton pattern would be defined for a class (e.g. a ‘jwclass’) because that is the most fundamental specification object it applies to. However, it could equally well be used by a derivative of jwclass like business-object. This is what you would expect: if a pattern is relevant to a class, it is relevant to its subclasses.

The format of the XML to be included, i.e. the output of the pattern script, is a standard XML document. In the present embodiment, the root element can have one of two (case-sensitive) tag names:

this—the contents of this document should be merged in starting at the current specification object. This would be appropriate in the singleton example, where we added a field and a method into a singleton class. The implementation shown would be nested within a ‘<this>’ tag.

parent—the contents of this document should be merged in starting at the parent of the current specification object. (Obviously, this cannot be used on the top-level node). You must use <parent> to create peers of the current object. For example, if a class like an entity is to create interfaces and other classes as part of the pattern, then you must specify ‘<parent>’ for the root node and then add the peer objects as nested elements below the parent.

There is one special element name if the root node is the parent, namely ‘this’. When this element tag is used directly below ‘parent’, this does not create a new model object instance for this node; instead, it locates to the current specification object. You can then set attributes and create nested elements for the current specification object. This feature is optional—it is quite possible to leave the current specification object ‘this’ unchanged but just add peer specification objects.

Occasionally, the position where the new object(s) are to be inserted is somewhere other than the parent or the current object. In that case, you must use the ‘this’ style—not ‘parent’—but this is used purely as a place holder. To specify the actual object to be used, use something like

$this.setPatternRootElement( $metaModelObject )

This identifies the meta-model object to use as a parent. It is a one-shot (the value goes away after the pattern has been processed. For example, to put a class in the first jar or assembly object in the application, you could say

$this.setPatternRootElement( $theApplication.jarList.get (0) )

You can put attributes onto the root element. When ‘this’ is the root node, the attributes will be set on the current node, overriding any default or value explicitly set in the previous specification. This could be useful in some situations. In particular, you invoke the next pattern via ‘<this next-pattern=“pattern2”>’.

When ‘parent’ is the root node, the attributes will also be set. This is a side-effect of the implementation: it is not a recommended practice.

If you have any included code in the includeSpec.vm, the convention about tab processing will apply to this code too. In other words, use tabs to lay out the includeSpec.vm so the code is visible; they will be removed when the includeSpec.vm template is processed.

The system implements many patterns in its standard distribution. Some of these patterns, for example the singleton pattern, may be separately usable, and more patterns may be added to the business object and J2EE layers. However, the J2EE implementation incorporates many patterns in its design. These may be implemented using a range of techniques, but mostly through the user-modifiable templates for J2EE system generation, which are targeted at J2EE, with its container-managed persistence and relationships.

The Data Access Layer

In the J2EE model's standard set of templates, at least the following two types of entity may be supported:

EJB entities, or Entity EJBs. These support EJB2.0, CMP (Container-Managed Persistence) and CMR (Container-Managed Relationships) out of the box.

JDO (Java Data Objects) Entities. These entities have very different characteristics in terms of how they are created and destroyed, persisted into a database and interfaced to the persistence manager.

The system preferably provides a Data Access layer for accessing these entities regardless of the technology employed. The design of the entities, the implementation of any business code in the entities and the implementation of the business logic in session beans is preferably designed to be independent of the technology (EJB or JDO) employed. This means that you can specify an ‘entity’ at the design level, and leave till build time the decision about the actual type of entity object to be used.

The Data Access layer is described in more detail below, including how design-level ‘entities’ turn into implementation-level entity EJBs or JDO objects. Facilities may be added or removed from this standard implementation. This is possible by adapting the templates as required.

An underlying assumption of the data access layer is that the entities are only available locally. The only support available remotely is the remote interface of the Entity EJB; in some embodiments, similar support may be provided for remoting JDO objects.

The Sun Core J2EE patterns include the Data Access Object (DAO) pattern. The Sun pattern could be used either by a session bean or servlet accessing data from a data source, or within an entity EJB's implementation (if its persistence is bean-managed).

The Data Access layer abstracts the properties of the entity EJB, JDO or a local data access object implementation. In other words, the Data Access layer is higher than the entity EJB. The problem the Data Access layer is solving is that there are many different data access APIs, so we provide a single access layer that can be used by business developers but automatically generated for the appropriate implementation technology.

In other words, the Data Access layer uses the DAO pattern in one particular way. We use the method names from the DAO pattern where applicable. The system may also allow people to generate native EJB/JDO implementations so they can fit in with existing code.

To describe how the implementation-independent Data Access layer works we can use the following Customer example as a starting point. Here we have the UML version:

<<entity>> Customer
+ customerNumber : String
+ customerName : String
+ postalCode : String
+ Customer( Customer )
+ <<query>> findByName( name : String )
+ addContactLog( contactDetails : String )

which in XML is:

| | |
|---|---|
| <entity | name=“Customer”> |
| <attribute | name=“customerNumber” |
| | key=“true”/> |
| <attribute | name=“customerName”/> |
| <attribute | name=“postalCode”/> |
| <creator | access=“public”> |
| <parameter | name=“customer” |
| | type=“Customer” |
| | object-passing-style=“value”/> |
| </creator> | |
| <query | name=“findByName” |
| | returns=“Many” |
| | allow-duplicates=“false”> |
| <parameter | name=“name”/> |
| </query> | |
| <business-method | name=“addContactLog”> |
| <parameter | name=“contactDetails”/> |
| </business-method> | |
| </entity> | |

The standard J2EE templates create an implementation-dependent set of objects described below—we're also using the standard naming conventions, which can easily be changed as described herein, for example via ‘component.properties’.

First, the entity is represented by an interface of the same name as the entity:

| interface Customer | |
|---|---|
| { | |
| String | getCustomerName( ); |
| void | setCustomerName( String ); |
| String | getCustomerNumber( ); |
| void | setCustomerNumber( String ); |
| String | getPostalCode( ); |
| void | setPostalCode( String ); |
| void | update( ); |
| void | delete( ); |
| void | addContactLog( String contactDetails ); |
| } | |

This is the usable interface of the entity, for use by session beans. The attributes have turned into getters and setters. We have added ‘update’ and ‘delete’, which update or delete a persisted object. The creator (constructor) has vanished!—it will appear on the factory class. The query has turned into the ‘find’ method, again on the factory class. And finally, the business method is essentially unchanged.

There is a data extract of this, the ‘Value Object’, which is from a recognised pattern, also known as the Data Transfer Object or Replicate Object. This just holds data with getters and setters:

```
class CustomerValue
{
  private String customerName;
  public String getCustomerName( )
  {
    return customerName;
  }
  void setCustomerName( String )
  {
    this.customerName = customerName;
  }
  // and similar for customerNumber and postalCode
}
```

The ‘Identity’ class is the class that defines the identity of the entity. An entity always has to have an identity. In this case, the identity is defined by the ‘key’ property on the customerNumber attribute. We therefore have an identity class containing just the one field:

```
public class CustomerIdentity implements java.io.Serializable
{
  public String customerNumber;
  public String getCustomerNumber( )
  {
    return customerNumber;
  }
  void setCustomerNumber( String )
  {
    this.customerNumber = customerNumber;
  }
  // and other boilerplate classes
}
```

If the class has an automatically-generated key (from an ‘auto-key attribute’), the primary key class will be Integer (or possibly Long, depending on the application server's implementation of the automatic key feature).

The value object is created by ‘new’: it is a simple data carrier. The main object (defined by the entity's main interface—‘Customer’ above) is created by a factory object. The factory object is generated specifically for each type of entity—it isn't a generic factory object.

```
public class CustomerFactory
{
  public Customer create( CustomerValue c );
  public Customer findByPrimaryKey( CustomerIdentity c );
// boilerplate
```

| | |
|---|---|
| public void | delete( CustomerIdentity c ); // ‘deleteByPrimaryKey’ |
| public void | insert( Collection customerValues ); |
| public void | delete( Collection customers ); |
| public void | update( Collection customers ); |
| Customer | findByName( String name ); // from a query |
| } | |

Whereas a factory normally just has the connotation of creating appropriate class instances, the factory in the data access layer also has the connotation of persistence. For example, take the ‘create’ method. This takes a customer value—the transient information—and persists it to the database; the ‘create’ is to create the persistent object out of the transient object. For an EJB entity, this method calls the auto-generated ‘create’ method on the entity EJB; for JDO, this creates a Customer implementation object and passes it to the persistence manager. Similarly, the insert of a collection takes a collection of value (CustomerValue) objects and returns a collection of persisted objects implementing the ‘Customer’ interface.

Finally, we come to the two classes that have significant code in them. First, there is the base class for the object. This is autogenerated, and includes all the defaults, infrastructure, constraints, and anything else that is created by templates using the specification. The base class implements the entity's interface—this is constant whether the implementation is for EJB, JDO or a home-defined entity style. However, the content of this class will change depending on the technology being used: this class will look different between the JDO and EJB variants. Here an outline is the EJB version:

| public abstract class CustomerBase implements EntityBean | |
|---|---|
| { | |
| abstract public String | getCustomerName( ); |
| abstract public void | setCustomerName( String ); |
| // and for customerNumber and postalCode | |
| public CustomerIdentity ejbCreate( CustomerValue customer ) | |
| | throws CreateException |
| { | |
| // tracing and validation code omitted | |
| createImpl( customer ); | |
| return void; | // as per EJB spec |
| } | |

abstract protected void createImpl( CustomerValue customer )

throws CreateException;

// and all the other methods required by EJB spec
}

All the classes described so far are regenerated from templates every build. The final class is the implementation class (with the ‘Impl’ suffix), which is generated once by the system and then becomes the responsibility of the application programmer. This provides implementations of all the business methods.

```
abstract public class CustomerImpl extends CustomerBase
{
  protected void createImpl( CustomerValue customer )
  {
    setCustomerName ( customer.getCustomerName( ) );
    setCustomerNumber ( customer.getCustomerNumber( ) );
    setPostalCode( customer.getPostalCode( ) );
  }
}
```

To re-emphasise, in the present implementation, the following are independent of the data access technology:
the implementation class
the name of the base class
the interface, Value, Factory, and Identity (if present) classes.

The contents of the base class and any other classes it uses are specific to the data-access technology. This means that the data access layer can be used on a different data-access technology (switched from EJBs to JDO or your access layer) simply by regenerating the classes with different templates.

Because the various types of entities may have different properties, they are implemented in the present embodiment as different specification objects. The standard ones are called ‘ejb-entity’ and ‘jdo-entity’. Using the meta-modelling capability in the enterprise product, a user could define their own variant by extending the base entity specification.

This is all very well if you know you a particular type of bean is implemented as an EJB or JDO entity. But what if you are modelling and do not want to fix the type of entity until build time—you just want to model an ‘entity’, and leave the definition of the exact type till run-time. The ‘convert’ feature may be provided to support this.

To convert entities to specific types at build time, put a line in a start-of-day properties file (i.e. the jwp file, build.properties or system.properties) of the form ‘convert(tag-in-file)=tag-for-object-creation’. This says, convert the specification element ‘tag-in-file’ to the actual role ‘tag-for-object-creation’. For example, to get ejb-entities, we would say:

convert(entity)=ejb−entity

whereas to get jdo-entities we would say:

convert(entity)=jdo−entity

As with all start-of-day properties, the first-encountered value is used. The default for the J2EE model, as defined in j2ee system.properties, is ejb-entity. The convert( ) lines are processed in the same way as other lines: if more than one ‘convert’ line is present, the first one encountered is used.

The entity type is also relevant to the session objects because in JDO (and possibly in local entity layer variants) the generated session objects are responsible for managing the persistence manager and transaction aspects. This may be done for each business method (one that is exposed as part of the service interface of the session bean) in a way that is consistent with the “transaction” attribute for the method or the bean overall. Only ‘Required’ and ‘Supports’ are supported for JDO. The ‘Required’ value ensures that a JDO persistence manager and transaction are present: if they already exist for this thread, they are left alone, but otherwise a new set is created and committed by this method. The ‘Supports’ means that no persistence management or transaction logic is included in the session bean's method. ‘Required’ is the default (as for EJB) and is suitable both for ‘outer’ session bean methods (ones that are called directly by clients) and ‘inner’ methods (ones that are called by other session bean methods). Using ‘Required’ is recommended because it also guarantees that the same method can be called in both scenarios.

To trigger JDO persistence/transaction creation, there is a property called “service-container-type” on the session object. The default for this is ‘ejb’, in which we assume that the EJB container will be configured by values on the session object to manage persistence and transaction. To get the JDO session management capability, the “service-container-type” is set to ‘jdo’.

Component.properties

More details of the component.properties file, from which each component can get property values, will now be described. This file resides in the component model object's directory below the template directory. For example, in one embodiment, the application's component.properties defined in the J2EE model may be in a directory such as:

jeewiz/resources/j2ee/application/control/component.properties

Rules which may be used for component.properties may include:
1. The syntax is one property ‘name=value’, or #comment, per line—standard Java properties file syntax.
2. Substitution is allowed using ${x}, where ‘x’ is a known property or getter. Note that the ‘{ }’ braces are required after the $.
3. If the right-hand side, after the ‘=’, consists solely of a substitution like ‘${x}’ or ‘${x.y}, then the property becomes a reference to the object ‘x’; otherwise, the property is a string value. In particular, this means you can say:
   theApplication=${this}

and ‘theApplication’ will be a reference to the current object rather than just its ‘toString( )’ value. You can then get or set properties on these objects using normal substitution in Velocity or Ant. Getting properties is simple: just say, e.g., ‘${theApplication.name}’. In Velocity, to set a property that does not have a Java getter, say e.g.

#set ( $x=$theApplication.put ( “hasAutoTestMethods”, “true” )
)

The ‘$x=’ is just a dummy to satisfy the syntax of the set command. The ‘put’ method is gives access to the HashMap that is available on each object for extra properties.
4. One level of object reference is also allowed, as in $object.property. This will look up the property on the object.
5. Declaration order is observed. This means that references to properties set in previous lines of the same properties file are specifically allowed and will be evaluated as expected. This is noteworthy because properties in Ant files are evaluated in random order, which can lead to unexpected results. Because order is observed, you can set a property based on some calculation, and then later on use that value in another property-setting calculation. For example, the system.properties file for the J2EE model uses sequences like:
   specDir=${assemblyDir}
   source=${specDir}/scr
However; you cannot specify the same property twice in the same file and get two calculations done: only the last value for any property is used.
6. When substitutions are done, the current model object has been instantiated, its values have been set from the XML specification and the ‘$this’ and ‘$parent’ properties have been set. This means for example you could use ‘${name}’ to pick out the current object's name, or ‘${parent.name}’ to pick out the parent's name. This facility also applies to property-like methods on component model objects; these are methods that begin with ‘get’, take no parameters and are public. For example, fields, methods and classes have a public ‘getStaticText( )’. This returns “static” if the object is static or “ ” if not. This is used in component.properties via ‘${staticText}’ to create declaration snippets. The case of the first letter is not significant when accessing such properties, so ‘${StaticText}’ has the same effect as ‘${staticText}’. We follow the Java Beans convention, that the letter after ‘get’ in the method is capitalised—getStaticText( ) rather than getstaticText( )—but the property's first character is lower case—staticText rather than StaticText. However, this is a convention and either case for the first letter is allowed. The remainder of a property name is case-sensitive: ${statictext} won't find the ‘getStaticText( )’ method because the ‘t’ is the wrong case.
7. The values are always set on the current object, even though substitution values may come from a parent object. This means that it is possible to re-use names without conflict, although it is not recommended. For example, you can say the following:
   scr=${src}/#{name}
This sets our source location ${src} to one directory down from the parent's ${src}.
8. The values are put into a hash table attached to the component model object.
9. You cannot set a property value defined in Java on the component model object—or any name that has a public ‘setPropertyName(x)’ style method matching the property name. For example, you cannot say “name= . . . ” because all component model objects have a ‘name’ property—i.e. a public setName(string) method. This rule avoids the possible problems arising from setting a value in component.properties which will be hidden in normal use—because the component model object JavaBeans style properties take precedence over these extra properties.

10. The component.properties that are set is the aggregate of all component.properties files in all models for the current run. For example, say you are doing a JBoss run and building a method. Then the aggregate component.properties file will look for, and use if present, the files in the following order:

jeewiz/resources/jboss3/control/method/component.properties
jeewiz/resources/j2ee/control/method/component.properties
jeewiz/resources/bizobject/control/method/component.properties
jeewiz/resources/object/control/method/component.properties

This search path will be enlarged if a diversion is used. For example, say we have a business-method and the bizobject/business-method has a diversion to the method object. Then the stack of aggregated component.properties files would be

jeewiz/resources/jboss3/control/business-method/component.properties
jeewiz/resources/j2ee/control/business-method/component.properties
jeewiz/resources/bizobject/control/business-method/component.properties
jeewiz/resources/object/control/business-method/component.properties
jeewiz/resources/jboss3/control/method/component.properties
jeewiz/resources/j2ee/control/method/component.properties
jeewiz/resources/bizobject/control/method/component.properties
jeewiz/resources/object/control/method/component.properties

Note that the order these files are loaded is from the outside inwards (most specialised first). Normally (with the ‘name=value’ syntax), values are not be overwritten, which means that the most specialised version takes precedence. This means you can override a property setting on a component-by-component basis in your own overriding model. See Order of Reading Top-Level Property Files for the similar approach taken in handling the top-level property files.
If a lower-precedence model really wants to insist on getting a particular value, it can use the ‘name==value’ (‘==’ instead of just ‘=’), following the same convention as for loading system.properties.

The recommended way of using component.properties is to define here all substitution values, based on values in the environment, that you might want to use in building the object—in Ant build jobs or Velocity scripts. The Velocity scripts then use these values: it is easier to change all these properties in one place than searching all of the Ant and Velocity scripts. Experience shows that using the same property name in different component model objects gets confusing, so this is not recommended.

The ‘convert( )’ feature will now be described in more detail. It is sometimes important to design using generic names but build using specific names. This means you can put stereotypes of a general form in the model, but then create specific types as you read them into the system. The ‘convert’ feature may be provided to allow this to be done.

To convert a general object to more specific type at build time, put a line in a start-of-day properties file (i.e. the jwp file, build.properties or system.properties) of the form
convert(generic-tag)=specific-tag

This says, convert the specification element ‘generic-tag’ to the actual role ‘specific-tag’. For example,
convert(generic)=specific

As with all start-of-day properties, the first-encountered value is used.

The convert( ) lines are processed in the same way as other lines: if more than one ‘convert’ line is present, the first one encountered is used. This means that you can override the default in a particular build, for example by putting a ‘convert( )’ line in your ‘build.jwp’ file. If you want to fix a particular specific type, to stop it being changed by the ‘convert( )’ feature, all you do is use the specific tag in the specification.

Sample of Generated Code

By way of further illustration, a sample of generated code is provided below, which forms part of a system generated by the techniques described herein. The code has been marked up to indicate the origin of the code.

public void addBand( BandInfo bandinfo ) throws CreateException )

{

final String QMethodName = QclassName + “.addBand( ): ”;
if( DEBUG ) Trace( QMethodName + “ >>>>> Entry” + “, parameters:

bandinfo=” + bandinfo );

try
{

serviceMethodEntry( _QMethodName ); // log of a service method entry
if( ! ( bandinfo != null ) )
}

String errmsg = “Required parameter is missing : constraint violated

by: bandinfo”;

throw new ProcessingErrorException( errmsg );

}
String serviceCallResult = “Failure”;
try
{

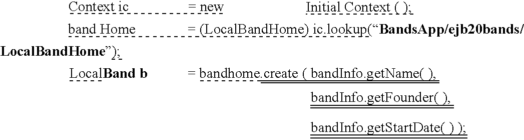

serviceCallResult = “Success”;

}
finally {}
serviceMethodExit(_QMethodName, serviceCallResult );

}
finally
{

if( DEBUG ) Trace( _QMethodName + “<<<<Exit” );

}

}

Bold sections of code were generated by the design, via the standard Framework of the system.
Underlined sections of code were generated by the business logic housing, via the standard Framework of the system.
Italic sections of code were generated by the service method housing, from a user extension.
Double underlined sections of code were generated by the business logic.
Dashed underlined sections of code were generated by the platform.

1. A code generation system for generating program code for implementing a software system specified by specification data, comprising:
an input component adapted to receive the specification data;
a processing component adapted to generate further specification data in dependence on the received specification data; and
a code generator adapted to generate the program code from the specification data and the further specification data.

2. A system according to claim 1, wherein the input component is adapted to generate a system model of the software system from the specification data, the code generator being adapted to generate the program code from the system model.

3. A system according to claim 2, wherein the processing component is adapted to output the further specification data, and the input component is adapted to receive the further specification data output by the processing component, and to modify the system model in dependence on the further specification data.

4. A system according to claim 2, wherein the system is adapted to store a plurality of patterns each defining specification data representing elements which may be added to the system model, and wherein the processing component is adapted to generate the further specification data by processing at least one of the stored patterns.

5. A system according to claim 4, wherein the input component is adapted to generate the system model in the form of an object hierarchy, with objects in the object hierarchy representing elements of the system model specified in the specification data, the processing component being adapted to process the objects in the object hierarchy and, for a given object, select a stored pattern associated with the object and process the pattern to generate further specification data relating to the object.

6. A system according to claim 5, wherein the system is adapted to process a pattern specifying one or more elements which are to be added to the system model and to add objects representing those elements to the object hierarchy.

7. A system according to claim 5, wherein the system is adapted to store a plurality of patterns associated with a given object type or class, the processing component being adapted to process an object of the given object type or class by processing each of the plurality of patterns associated with the given object type or class in a pre-determined order.

8. A system according to claim 7, wherein the system is adapted to perform a validation step on objects of the system model, the processing component being adapted to process a first pattern associated with a given object before validation of the object and to process a second pattern associated with the object after validation of the object.

9. A system according to claim 4, adapted to receive the specification data representing a specification of the software system, apply a plurality of patterns to the specification to produce an enhanced specification, and to generate the program code from the enhanced specification.

10. A code generation system for generating program code for implementing a software system specified by specification data, comprising:
a meta-model processor adapted to receive a meta-model specification defining types of elements which may be specified in the specification data and to generate a meta-model representing said types of elements in dependence on the meta-model specification;
a specification processor adapted to process the specification data in dependence on the meta-model and to generate a system model of the software system from the specification data in accordance with the meta-model; and
a code generator adapted to generate the program code from the system model.

11. A system according to claim 10, wherein the meta-model specification defines a class hierarchy of object classes which may be used in generating the system model, and wherein the specification processor is adapted to generate the system model in the form of a plurality of objects in accordance with the defined class hierarchy.

12. A system according to claim 11, wherein the meta-model processor is adapted to receive a plurality of meta-model specifications each defining a portion of a complete class hierarchy to be used in generating the system model, at least some of the plurality of meta-model specifications being interrelated by way of class inheritance relationships between classes defined in them, the meta-model processor further being adapted to construct the complete class hierarchy from the plurality of interrelated meta-model specifications.

13. A system according to claim 10, further comprising a plurality of stored meta-model specifications, and input means for receiving a selection of one or more of the plurality of stored meta-model specifications to be used by the system.

14. A system according to claim 13, wherein the meta-model used in the generation of the system model has a plurality of layers each having distinct modelling functions, each layer being represented by at least one stored meta-model specification; and wherein the stored meta-model specifications comprise, for at least one such layer, a plurality of alternative meta-model specifications which are usable interchangeably in specifying that layer of the complete meta-model which is to be used by the system.

15. A system according to claim 14, wherein the interchangeably usable meta-model specifications define classes having equivalent modelling functions or representing equivalent modelling concepts with non-equivalent class implementations.

16. A system according to claim 10, wherein the system is adapted to store first and second meta-model specifications relating respectively to first and second target programming languages, and to generate the program code in the first target programming language if the system is operated using the first meta-model specification and to generate the program code in the second target programming language if the system is operated using the second meta-model specification.

17. A code generation system for generating program code for implementing a software system specified by specification data, the system comprising:
an input component for receiving specification data for the software system;
storage for storing a plurality of templates, wherein the templates define sections of program code;
storage for storing a plurality of code generation controls, wherein the controls each comprise generate-time executable code routines external to the templates and the specification data and wherein at least some of the templates include references to controls;
a code generation component for applying selected templates to elements of the specification data to generate corresponding sections of generated program code based on the templates;
a processing component for executing controls selected based on the references in the templates and incorporating the output from the controls into the program code.

18. A system according to claim 17 further comprising:
storage for storing a plurality of patterns, wherein the patterns each define specification data representing elements that may be added to a model of the specification data, wherein the plurality of controls are external to the patterns and wherein at least some of the patterns include references to controls;
a pattern processor for selectively applying patterns to the specification data to generate further specification data;
a processing component for executing controls selected based on the references in the patterns and incorporating the output of the controls into the model of the specification data.

19. A system according to claim 17, wherein the specification data is represented as a system model comprising a plurality of objects, the objects being based on a selected class hierarchy, wherein the control executed is selected based on the selected class hierarchy.

20. A system according to claim 19 wherein the class hierarchy has multiple independently selectable layers and wherein the control is selected based on the selected layers.

21. A system according to claim 17, wherein the program code is generated in a specified language and wherein the control is selected based on the specified language.

22. A system according to claim 17, wherein the control generates a section of program code for incorporation into the program code of the software system.

23. A system according to claim 17, wherein the program code is generated in a specified language and wherein at least one control comprises a language control to generate a section of program code in the specified language.

24. A code generation system for generating program code for implementing a software system specified by specification data, comprising:
an input component for receiving the specification data, the specification data defining elements of the software system and specifying, for each element, an element type; and
an input component for receiving substitution instructions specifying for given element types used in the specification data, replacement element types to be used in generating the program code;
and wherein the system is adapted to generate, for a given element defined in the specification data, program code in dependence on the element type specified for the given element or, in preference thereto, in dependence on a replacement element type specified for that element type in such a substitution instruction.

25. A system according to claim 24, adapted to generate a system model of the software system from the specification data, the system model comprising a plurality of objects each representing respective elements defined in the specification data, each object having an object type or class selected in dependence on the element type specified for the corresponding element in the specification data or, in preference thereto, in dependence on a replacement element type specified for that element type in such a substitution instruction; the system being further adapted to generate the program code from the system model.

26. A system according to claim 1, wherein the system is adapted to generate program code which is directly executable on a processor or in a virtual machine, preferably a Java virtual machine.

27. A system according to claim 1, wherein the system is adapted to generate source code.

28. A method of translating data in an input format representing a model of a software system into an output format, comprising:
storing a plurality of patterns defining model enhancements;
storing a plurality of output templates defining transformations of model components into the output format;
receiving model data in the input format at a model processor, the model data defining the model, and generating a representation of the model from the model data;
selecting one or more patterns from the stored patterns in dependence on the model representation and processing the model enhancements defined in the selected patterns at a pattern processor to produce an enhanced model representation;
selecting one or more output templates from the stored output templates in dependence on the enhanced model representation, and processing the selected output templates at a template processor to produce data in the output format representing the enhanced model.

29. A method according to claim 28 comprising, at the pattern processor, outputting data in the input format representing the model enhancements defined by the selected patterns, and, at the model processor, receiving the data output by the pattern processor, and modifying the model representation in dependence on the data.

30. A method according to claim 28 wherein the model data defines a hierarchical structure of model components, the patterns define additional components which may be added to the model representation, the method comprising selecting patterns in dependence on the model components.

31. A method of enhancing a model, the model comprising a hierarchy of model components, the method comprising:
storing a plurality of patterns each defining one or more model components that may be added to the model;
receiving specification data at a specification processor, the specification data specifying the hierarchy of model components, and generating the model from the specification data;
processing the model components at a pattern processor and, in dependence on a given model component, selecting a pattern associated with the given component, and outputting further specification data specifying the additional model components defined in the pattern.

32. A method according to claim 31 comprising, at the specification processor, receiving the further specification data and adding the additional model components specified in the further specification data to the model.

33. A method of generating output data based on templates, the templates including data and template processing commands, the template processing commands being expressed in a template language, the method comprising:
processing a template in a processing context comprising one or more objects to generate output data for the template, the template including a method invocation command referencing one of the objects and a template method; and
in response to the method invocation command, accessing the referenced template method, the method being expressed using the template language, and executing the template method in relation to the referenced object.

34. A method according to claim 33, further comprising incorporating the output of the template method into the output data generated for the template.

35. A method according to claim 33, comprising, in response to a return command in the template method, ending execution of the method and discarding output generated by the template prior to the return command.

36. A method according to claim 35, wherein the return command specifies a return value or expression which evaluates to a return value, the method comprising substituting the return value in the template at the point at which the template method was invoked, and continuing processing of the template using the substituted return value.

37. A method according to claim 33, further comprising generating code for a software system based on specification data by a process including: generating a model of the software system based on the specification data, the model comprising a plurality of objects representing elements of the software system; processing, for a given object, a template to generate code for the element of the software system which the given object represents; and wherein the processing context for the template comprises one or more of the plurality of objects, preferably at least the given object.
